(19) United States
(12) Patent Application Publication
(10) Pub. No.: US 2011/0242654 A1
(43) Pub. Date: Oct. 6, 2011

(54) Hardcoat layer-forming composition, optical film, production method of optical film, polarizing plate and image display device

(75) Inventors: Miho Asahi, Kanagawa (JP); Kenichi Fukuda, Kanagawa (JP); Jun Watanabe, Kanagawa (JP)

(73) Assignee: FUJIFILM Corporation, Tokyo (JP)

(21) Appl. No.: 13/064,560

(22) Filed: Mar. 31, 2011

(30) Foreign Application Priority Data
Mar. 31, 2010 (JP) P2010-084425
Mar. 29, 2011 (JP) P2011-072394

(51) Int. Cl. G02B 5/30; C08L 27/12; B32B 27/28; G02B 1/11; C08F 2/50

(52) U.S. Cl. 359/488.01; 522/79; 428/421; 359/601; 427/508

(57) ABSTRACT

A hardcoat layer-forming composition is provided and contains the following (a), (b), (c) and (d): (a) a leveling agent composed of a fluorine-containing polymer having a specific structure, (b) a carbonic acid ester solvent, (c) a compound having an unsaturated double bond, and (d) a photopolymerization initiator.

### CROSS-REFERENCE TO RELATED APPLICATIONS

The present application claims priority from Japanese Patent Application No. 2010-084425 filed on Mar. 31, 2010 and Japanese Patent Application No. 2011-072394 filed on Mar. 29, 2011, the entire contents of which are incorporated herein by reference.

### BACKGROUND OF THE INVENTION

1. Field of the Invention

The present invention relates to a hardcoat layer-forming composition, an optical film, a production method of the optical film, a polarizing plate, and an image display device.

2. Description of the Related Art

In an image display device such as cathode ray tube display device (CRT), plasma display panel (PDP), electroluminescence display (ELD), vacuum fluorescent display (VFD), field emission display (FED) and liquid crystal display device (LCD), a hardcoat film having a hardcoat layer on a transparent substrate is preferably provided to prevent scratching of the display surface.

Recently, a combination of a display and a touch panel is widespread as materials of digital signage, mobile terminal and barrier-free personal computer. It is demanded to achieve a higher level of scratch protection performance because of increased opportunities for direct contacts with the display surface and moving the display surface.

Also, in the case of a high-definition and high-quality image display device such as recent LCD, in addition to preventing scratches on the display surface, an antireflection layer or an optical film having an antireflection layer is provided on the hardcoat layer so as to prevent reduction in contrast due to reflection of outside light on the display surface or eliminate disturbing reflection of an image.

The hardcoat layer can be obtained by coating a hardcoat layer-forming composition on a transparent substrate and curing the composition, but if the leveling property is low when coating the hardcoat layer-forming composition, this causes a problem of surface unevenness of the hardcoat layer.

In the case of adding a leveling agent to the hardcoat layer-forming composition so as to solve this problem, when the leveling agent is unsuccessful in superficial distribution, a large amount of a leveling agent is distributed also inside the hardcoat layer, and a sufficiently high effect of improving the surface state may not be obtained.

Furthermore, in the case where an antireflection layer or another layer such as antireflection layer is stacked on the hardcoat layer, a part of the leveling agent may remain in the hardcoat layer/another layer interface to impair the adherence.

It is known that the adherence between the hardcoat layer and the transparent substrate is deteriorated due to the leveling agent largely-distributed in the hardcoat layer. Thus, improvement of the adherence between the hardcoat layer and transparent substrate is demanded.

Patent Document 1: JP-A-2004-163610 discloses a composition containing a polymer having a repeating unit derived from a fluoroaliphatic group-containing monomer.

### SUMMARY OF THE INVENTION

Patent Document 1 discloses that the adherence between hardcoat layer comprising the polymer having the repeating unit derived from the fluoroaliphatic group-containing monomer and an antireflection layer laminated above the hardcoat layer is improved. However, the level of the adhesion is lower than that recently required. Achiving a further improved surface state and a good adhesiveness of the hardcoat layer and the antireflection layer is required. It is also demanded to achieve the good surface state and the good adhesiveness of the hardcoat layer and the transparent substrate.

An object of the present invention is to provide a hardcoat layer-forming composition more excellent in view of surface unevenness compared with the related arts.

Another object of the present invention is to provide an optical film excellent in the adherence between a transparent substrate and a hardcoat layer and the adherence between a hardcoat layer and another layer provided on the hardcoat layer.

Still another object of the present invention is to provide a production method of the optical film, a polarizing plate using the optical film as a polarizing plate protective film, and an image display device having the optical film or polarizing plate.

The above-described objects can be attained by the following techniques.

1. A hardcoat layer-forming composition containing the following (a), (b), (c) and (d):

(a) at least any one leveling agent selected from the following fluorine-containing polymer (1) and fluorine-containing polymer (2):

fluorine-containing polymer (1):

a polymer containing a polymerization unit derived from a fluoroaliphatic group-containing monomer represented by the following formula (1) in a ratio of more than 50 mass % based on all polymerization units:

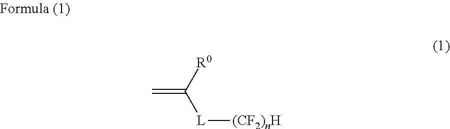

(wherein R⁰ represents a hydrogen atom, a halogen atom or a methyl group, L represents a divalent linking group, and n represents an integer of 1 to 18); fluorine-containing polymer (2):

a polymer containing a polymerization unit derived from a fluoroaliphatic group-containing monomer represented by the following formula 2) and a polymerization unit derived from at least any one selected from a poly(oxyalkylene) acrylate and a poly(oxyalkylene) methacrylate:

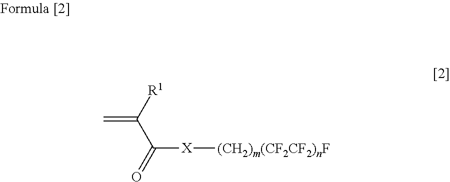

(wherein R¹ represents a hydrogen atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4),

(b) a carbonic acid ester solvent,

(c) a compound having an unsaturated double bond, and

(d) a photopolymerization initiator.

2. The hardcoat layer-forming composition as described in 1 above,

wherein the (a) leveling agent is the fluorine-containing polymer (1).

3. The hardcoat layer-forming composition as described in 1 or 2 above,

wherein the content of the (b) carbonic acid ester solvent is 10 mass % or more based on the entire solvent.

4. The hardcoat layer-forming composition as described in any one of 1 to 3, which further contains (e) a silica fine particle.

5. A hardcoat film having a hardcoat layer formed of the hardcoat layer-forming composition described in any one of 1 to 4 on a transparent substrate.

6. An optical film having a hardcoat layer formed of the hardcoat layer-forming composition described in any one of 1 to 4 on a transparent substrate and further having an antireflection layer on the hardcoat layer.

7. The optical film as described in 6 above, wherein the transparent substrate is a cellulose acylate film.

8. An optical film having a hardcoat layer and an antireflection layer on a cellulose acylate film substrate above, wherein a region allowing the substrate component and the hardcoat layer component to be mixed is present in the interface of the cellulose acylate film substrate with the hardcoat layer, the antireflection layer contains a leveling agent that is the following fluorine-containing polymer (1), and the leveling agent is not present in the interface between the hardcoat layer and the antireflection layer:

fluorine-containing polymer (1):

a polymer containing a polymerization unit derived from a fluoroaliphatic group-containing monomer represented by the following formula [1] in a ratio of more than 50 mass % based on all polymerization units:

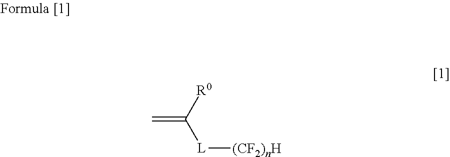

(wherein R⁰ represents a hydrogen atom, a halogen atom or a methyl group, L represents a divalent linking group, and n represents an integer of 1 to 18).

9. A polarizing plate using the optical film described in any one of 6 to 8 as a polarizing plate protective film.

10. An image display device having the optical film described in any one of 6 to 8 or the polarizing plate described in 9.

11. A method for producing an optical film having a hardcoat layer and an antireflection layer on a cellulose acylate film substrate, comprising coating and curing the hardcoat layer-forming composition described in any one of 1 to 4 above on the cellulose acylate film substrate to form a hardcoat layer, and further coating and curing a curable composition containing the following (f), (g) and (h) on the hardcoat layer to form an antireflection film:

(f) a compound having an unsaturated double bond,

(g) a hollow silica fine particle, and

(h) a photopolymerization initiator.

According to the present invention, a hardcoat layer-forming composition excellent in view of surface unevenness can be provided. Also, an optical film excellent in the adherence between a transparent substrate and a hardcoat layer and the adherence between a hardcoat layer and another layer formed on the hardcoat layer can be provided.

Furthermore, a production method of the optical film, a polarizing plate using the optical film as a polarizing plate protective film, and an image display device having the optical film or polarizing plate can be provided.

### DETAILED DESCRIPTION OF THE INVENTION

The mode for carrying out the present invention is described in detail below, but the present invention is not limited thereto. Incidentally, the expression “from (numerical value 1) to (numerical value 2)” as used in the present invention for indicating a physical value, a characteristic value or the like means “(numerical value 1) or more and (numerical value 2) or less”. Also, in the present invention, the term “(meth)acrylate” means “at least either acrylate or methacrylate”. The same applies to “(meth)acrylic acid”, “(meth)acryloyl” and the like.

Furthermore, in the present invention, the terms “a repeating unit corresponding to a monomer” and “a repeating unit derived from a monomer” means that a component obtained after the polymerization of a monomer becomes a repeating unit.

The hardcoat layer-forming composition of the present invention contains the following (a), (b), (c) and (d):

(a) at least any one leveling agent selected from the following fluorine-containing polymer (1) and fluorine-containing polymer (2):

fluorine-containing polymer (1):

a polymer containing a polymerization unit derived from a fluoroaliphatic group-containing monomer represented by the following formula [1] in a ratio of more than 50 mass % based on all polymerization units:

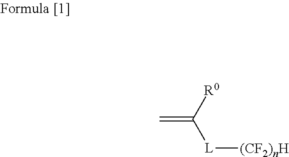

(wherein R⁰ represents a hydrogen atom, a halogen atom or a methyl group, L represents a divalent linking group, and n represents an integer of 1 to 18);
fluorine-containing polymer (2):

a polymer containing a polymerization unit derived from a fluoroaliphatic group-containing monomer represented by the following formula [2] and a polymerization unit derived from at least any one selected from a poly(oxyalkylene) acrylate and a poly(oxyalkylene) methacrylate:

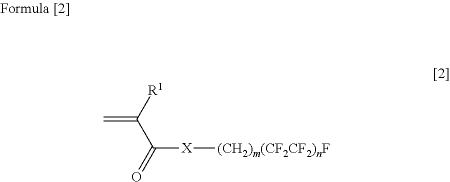

(wherein R¹ represents a hydrogen atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4),

(b) a carbonic acid ester solvent,

(c) a compound having an unsaturated double bond, and

(d) a photopolymerization initiator.

[(a) Leveling Agent]

The (a) leveling agent contained in the hardcoat layer-forming composition of the present invention is described below.

The (a) leveling agent is at least any one selected from the fluorine-containing polymer (1) and the fluorine-containing polymer (2).

The fluorine-containing polymer (1) is a polymer containing a polymerization unit derived from a fluoroaliphatic group-containing monomer represented by the following formula [1] in a ratio of more than 50 mass % based on all polymerization units:

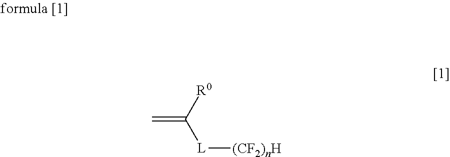

(wherein R⁰ represents a hydrogen atom, a halogen atom or a methyl group, L represents a divalent linking group, and n represents an integer of 1 to 18).

In the fluorine-containing polymer (1), the content of the repeating unit derived from a fluoroaliphatic group-containing monomer represented by formula [1] exceeds 50 mass % based on all polymerization units constituting the fluorine-containing polymer (1) and is preferably 70 mass % or more, more preferably 80 mass % or more.

In formula [1], R⁰ represents a hydrogen atom, a halogen atom or a methyl group and is preferably a hydrogen atom or a methyl group.

n represents an integer of 1 to 18 and is preferably an integer of 4 to 12, more preferably from 6 to 8, and most preferably 8.

In the fluorine-containing polymer (1), two or more kinds of polymerization units derived from a fluoroaliphatic group-containing monomer represented by formula [1] may be contained as the constituent unit.

In the fluorine-containing polymer (1), formula [1] is preferably the following formula [1-2]:

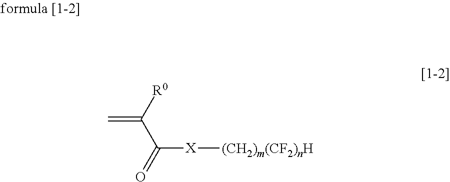

(wherein R⁰ represents a hydrogen atom, a halogen atom or a methyl group, X represents an oxygen atom, a sulfur atom or —N(R₂)—, m represents an integer of 1 to 6, n represents an integer of 1 to 18, and R₂ represents a hydrogen atom or an alkyl group having a carbon number of 1 to 8, which may have a substituent).

In formula [1-2], R⁰ represents a hydrogen atom, a halogen atom or a methyl group and is preferably a hydrogen atom or a methyl group.

X represents an oxygen atom, a sulfur atom or —N(R₂)— and is preferably an oxygen atom or —N(R²)—, more preferably an oxygen atom. R₂ represents a hydrogen atom or an alkyl group having a carbon number of 1 to 8, which may have a substituent, and examples of the substituent include a phenyl group, a benzyl group and ether oxygen. R² is preferably a hydrogen atom or an alkyl group having a carbon number of 1 to 4, which may have a substituent, and more preferably a hydrogen atom or a methyl group.

m represents an integer of 1 to 6 and is preferably an integer of 1 to 3, more preferably 1.

n represents an integer of 1 to 18 and is preferably an integer of 4 to 12, more preferably from 6 to 8, and most preferably 8.

In the fluorine-containing polymer (1), two or more kinds of polymerization units derived from a fluoroaliphatic group-containing monomer represented by formula [2] may be contained as the constituent unit.

Specific examples of the fluoroaliphatic group-containing monomer represented by formula [1] are illustrated below, but the present invention is not limited thereto.

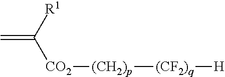

| | R¹ | p | q |
|---|---|---|---|
| F-1 | H | 1 | 4 |
| F-2 | CH₃ | 1 | 4 |
| F-3 | F | 1 | 4 |
| F-4 | H | 2 | 4 |
| F-5 | CH₃ | 3 | 4 |
| F-6 | H | 1 | 6 |
| F-7 | CH₃ | 1 | 6 |
| F-8 | F | 1 | 6 |
| F-9 | H | 2 | 6 |
| F-10 | CH₃ | 2 | 6 |
| F-11 | H | 3 | 6 |
| F-12 | H | 1 | 8 |
| F-13 | CH₃ | 1 | 8 |
| F-14 | F | 1 | 8 |
| F-15 | CH₃ | 2 | 8 |
| F-16 | H | 3 | 8 |
| F-17 | CH₃ | 3 | 8 |
| F-18 | H | 1 | 10 |
| F-19 | CH₃ | 1 | 10 |
| F-20 | F | 1 | 10 |
| F-21 | H | 2 | 10 |
| F-22 | H | 2 | 10 |

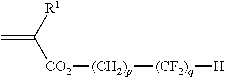

| | R¹ | p | q |
|---|---|---|---|
| F-23 | H | 1 | 12 |
| F-24 | CH₃ | 1 | 12 |
| F-25 | F | 1 | 12 |
| F-26 | H | 2 | 12 |
| F-27 | H | 3 | 12 |
| F-28 | H | 1 | 14 |
| F-29 | CH₃ | 1 | 14 |
| F-30 | F | 1 | 14 |
| F-31 | H | 2 | 14 |
| F-32 | CH₃ | 2 | 14 |
| F-33 | H | 1 | 16 |
| F-34 | CH₃ | 1 | 16 |
| F-35 | F | 1 | 16 |
| F-36 | CH₃ | 2 | 16 |
| F-37 | H | 3 | 16 |
| F-38 | H | 1 | 18 |
| F-39 | CH₃ | 1 | 18 |
| F-40 | F | 1 | 18 |
| F-41 | H | 3 | 18 |
| F-42 | CH₃ | 3 | 18 |

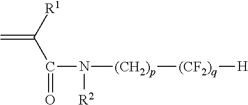

| | R¹ | R² | p | q |
|---|---|---|---|---|
| F-43 | H | H | 1 | 4 |
| F-44 | CH₃ | H | 1 | 4 |
| F-45 | H | CH₃ | 1 | 4 |
| F-46 | H | H | 2 | 4 |
| F-47 | H | H | 1 | 6 |
| F-48 | CH₃ | H | 1 | 6 |
| F-49 | H | CH₃ | 1 | 6 |
| F-50 | H | C₂H₅ | 1 | 6 |
| F-51 | CH₃ | H | 1 | 6 |
| F-52 | F | H | 2 | 6 |
| F-53 | H | H | 1 | 8 |
| F-54 | CH₃ | H | 1 | 8 |
| F-55 | H | CH₃ | 1 | 8 |
| F-56 | H | C₄H₉ (n) | 1 | 8 |
| F-57 | CH₃ | C₂H₅ | 1 | 8 |
| F-58 | H | CH₂Ph | 1 | 8 |
| F-59 | H | H | 2 | 8 |
| F-60 | CH₃ | H | 3 | 8 |
| F-61 | H | H | 1 | 10 |
| F-62 | CH₃ | CH₃ | 1 | 10 |
| F-63 | H | H | 1 | 12 |
| F-64 | CH₃ | H | 1 | 12 |
| F-65 | H | H | 1 | 18 |
| F-66 | H | CH₃ | 1 | 18 |

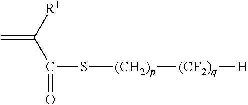

| | R¹ | p | q |
|---|---|---|---|
| F-67 | H | 1 | 4 |
| F-68 | CH₃ | 1 | 4 |
| F-69 | H | 2 | 4 |
| F-70 | H | 1 | 6 |
| F-71 | CH₃ | 1 | 6 |
| F-72 | CH₃ | 2 | 6 |
| F-73 | H | 1 | 8 |
| F-74 | CH₃ | 1 | 8 |
| F-75 | F | 1 | 8 |
| F-76 | H | 2 | 8 |
| F-77 | CH₃ | 3 | 8 |
| F-78 | H | 1 | 10 |
| F-79 | CH₃ | 1 | 10 |
| F-80 | H | 1 | 12 |
| F-81 | CH₃ | 1 | 12 |
| F-82 | H | 1 | 16 |
| F-83 | CH₃ | 2 | 16 |
| F-84 | H | 1 | 18 |
| F-85 | CH₃ | 1 | 18 |

The fluorine-containing polymer (1) may be composed of only a polymerization unit derived from the monomer represented by formula [1] or may be a copolymer with another kind of a monomer copolymerizable with the monomer represented by formula [1]. As for the another kind of copolymerizable monomer, those described in J. Brandrup, Polymer Handbook, 2nd ed., Chapter 2, pp. 1-483, Wiley Interscience (1975) may be used.

Examples thereof include a compound having one addition-polymerizable unsaturated bond selected from acrylic acid, methacrylic acid, acrylic acid esters, methacrylic acid esters, acrylamides, methacrylamides, allyl compounds, vinyl ethers and vinyl esters.

Specific examples of the another kind of monomer include the following monomers:

acrylic acid esters:

methyl acrylate, ethyl acrylate, propyl acrylate, chloroethyl acrylate, 2-hydroxyethyl acrylate, trimethylolpropane monoacrylate, benzyl acrylate, methoxybenzyl acrylate, furfuryl acrylate and tetrahydrofurfuryl acrylate,

methacrylic acid esters:

methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate and tetrahydrofurfuryl methacrylate,

acrylamides:

acrylamide, an N-alkylacrylamide (the alkyl group is an alkyl group having a carbon number of 1 to 3, such as methyl group, ethyl group and propyl group), an N,N-dialkylacrylamide

(the alkyl group is an alkyl group having a carbon number of 1 to 6), N-hydroxyethyl-N-methylacrylamide and N-2-acetamidoethyl-N-acetylacrylamide,

methacrylamides:

methacrylamide, an N-alkylmethacrylamide (the alkyl group is an alkyl group having a carbon number of 1 to 3, such as methyl group, ethyl group and propyl group), an N,N-dialkylmethacrylamide (the alkyl group is an alkyl group having a carbon number of 1 to 6), N-hydroxyethyl-N-methylmethacrylamide and N-2-acetamidoethyl-N-acetylmethacrylamide,

allyl compounds:

allyl esters (e.g., allyl acetate, allyl caproate, allyl caprylate, allyl laurate, allyl palmitate, allyl stearate, allyl benzoate, allyl acetoacetate, allyl lactate) and allyloxyethanol,

vinyl ethers:

an alkyl vinyl ether (e.g., hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether and tetrahydrofurfuryl vinyl ether,

vinyl esters:

vinyl butyrate, vinyl isobutyrate, vinyl trimethylacetate, vinyl diethylacetate, vinyl valerate, vinyl caproate, vinyl chloroacetate, vinyl dichloroacetate, vinyl methoxyacetate, vinyl butoxyacetate, vinyl lactate, vinyl-(3-phenyl butyrate and vinyl cyclohexyl carboxylate,

dialkyl itaconates:

dimethyl itaconate, diethyl itaconate and dibutyl itaconate, fumaric acid dialkyl esters or monoalkyl esters:

dibutyl fumarate, and

others:

crotonic acid, itaconic acid, acrylonitrile, methacrylonitrile, maleylonitrile and styrene.

Among these, the another kind of monomer is preferably a monomer represented by the following formula [3]:

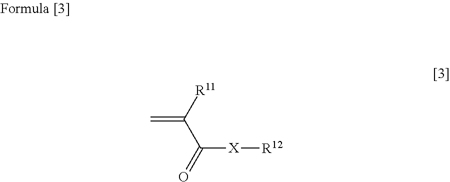

(wherein R¹¹ represents a hydrogen atom, a halogen atom or a methyl group, X represents an oxygen atom, a sulfur atom or —N(R¹³)—, R¹² represents a linear, branched or cyclic alkyl group having a carbon number of 1 to 20, which may have a substituent, a poly(alkyleneoxy) group-containing alkyl group, or an aromatic group which may have a substituent, and R¹³ represents a hydrogen atom or an alkyl group having a carbon number of 1 to 8).

In formula [3], R¹¹ represents a hydrogen atom, a halogen atom or a methyl group and is preferably a hydrogen atom or a methyl group.

X represents an oxygen atom, a sulfur atom or —N(R¹³)— and is preferably an oxygen atom or —N(R¹³)—, more preferably an oxygen atom. R¹³ represents a hydrogen atom or an alkyl group having a carbon number of 1 to 8 and is preferably a hydrogen atom or an alkyl group having a carbon number of 1 to 4, more preferably a hydrogen atom or a methyl group.

R¹² represents a linear, branched or cyclic alkyl group having a carbon number of 1 to 20, which may have a substituent, a polyoxyalkylene group, a polyoxyalkylene group-containing alkyl group, or an aromatic group (e.g., phenyl, naphthyl) which may have a substituent. Examples of the substituent include an alkyl group, a hydroxyl group and an amino group. R¹² is preferably a linear, branched or cyclic alkyl group having a carbon number of 1 to 12 or an aromatic group having a total carbon number of 6 to 18, more preferably a linear, branched or cyclic alkyl group having a carbon number of 1 to 8, still more preferably a polyoxyalkylene group or a polyoxyalkylene group-containing alkyl group.

The a poly(alkyleneoxy) group is described below.

The poly(alkyleneoxy) group can be represented by (OR)ₓ or (OR)ₓ—H, where R is preferably an alkylene group having from 2 to 4 carbon atoms, such as —CH₂CH₂—, —CH₂CH₂CH₂—, —CH(CH₃)CH₂— and —CH(CH₃)CH(CH₃)—.

The oxyalkylene units in the poly(oxyalkylene) group may be the same as in poly(oxypropylene), may be two or more different kinds of oxyalkylene units which are irregularly distributed, may be a linear or branched oxypropylene or oxyethylene unit, or may be present as a block of linear or branched oxypropylene units or a block of oxyethylene units.

The poly(oxyalkylene) chain may contain units connected through one or more linking groups (for example, —CONH-Ph-NHCO— and —S—; Ph represents a phenylene group). In the case where the linking group is trivalent or higher valent, a branched oxyalkylene unit is obtained.

Also, in the case where a copolymer containing a polymerization unit having a poly(oxyalkylene) group is used in the present invention, the molecular weight of the poly(oxyalkylene) group is suitably from 250 to 3,000.

The poly(oxyalkylene) acrylate or methacrylate can be produced by reacting a hydroxy poly(oxyalkylene) material commercially available, for example, under the trade name of “Pluronic” (produced by Asahi Denka Co., Ltd.), “ADEKA POLYETHER” (produced by Asahi Denka Co., Ltd.), “Carbowax” (produced by Glyco Products Co.), “Toriton” (produced by Rohm and Haas Co.) or P.E.G (produced by Dai-Ichi Kogyo Seiyaku Co., Ltd.), with an acrylic acid, a methacrylic acid, an acryl chloride, a methacryl chloride, an acrylic anhydride or the like according to a known method. Also, a poly(oxyalkylene) diacrylate or the like produced by a known method may be used.

Specific examples of the monomer represented by formula [3] include specific examples illustrated above of the alkyl acid esters, methacrylic acid esters, acrylamides and acrylic acid esters, and specific examples illustrated below of the monomer containing a poly(alkyleneoxy) group, but the present invention is not limited thereto. The poly(alkyleneoxy) is often a mixture of those differing in the polymerization degree X, and also in the compounds illustrated below as specific examples, the polymerization degree is indicated by an integer close to the average of polymerization degrees.

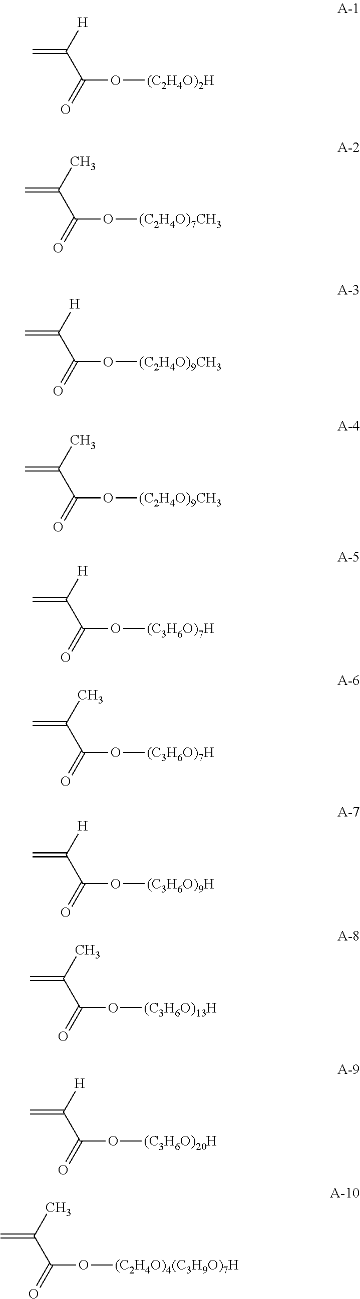

The amount of the polymerization unit derived from a fluoroaliphatic group-containing monomer represented by formula [1], constituting the fluorine-containing polymer (1) for use in the present invention, is preferably more than 50 mass %, more preferably from 70 to 100 mass %, still more preferably from 80 to 100 mass %, based on all polymerization units constituting the fluorine-containing polymer (1).

The amount of the polymerization unit derived from a monomer represented by formula [3] which is preferably used in the present invention is preferably less than 50 mass %, more preferably from 0 to 30 mass %, still more preferably from 0 to 20 mass %, based on all polymerization units constituting the fluorine-containing polymer (1).

A higher fluorine atom content (mass % of fluorine atom based on the entire mass of polymer) of the fluorine-containing polymer (1) for use in the present invention is more effective in preventing the coating unevenness, and the fluorine atom content is preferably 0.3 mass % or more, more preferably 0.4 mass % or more, still more preferably 0.5 mass % or more.

The mass average molecular weight of the fluorine-containing polymer (1) for use in the present invention is preferably from 2,000 to 80,000, more preferably from 4,000 to 40,000, and most preferably from 6,000 to 25,000. When the mass average molecular weight of the fluorine-containing polymer (1) is not less than the lower limit above, superficial distribution of the leveling agent is enhanced and therefore, the effect of improving the surface unevenness or the scratch resistance is increased, and when it is not more than the upper limit above, the hydrophobicity of the leveling agent can be set to an appropriately low level and therefore, a repelling problem is hardly caused or when an antireflection layer is formed on the hardcoat layer, the leveling agent is liable to be swiftly extracted by the antireflection layer.

Here, the mass average molecular weight and the molecular weight are a molecular weight determined in terms of polystyrene by a GPC analyzer using a column of TSKgeI GMHxL, TSKgeI G4000HxL or TSKgeI G2000HxL (all trade names, manufactured by Tosoh Corporation) with solvent THF and differential refractometer detection.

The fluorine-containing polymer (1) can be produced by a conventionally known method. For example, the polymer can be produced by polymerizing the above-described monomer such as fluoroaliphatic group-containing (meth)acrylate and polyoxyalkylene group-containing (meth)acrylate in an organic solvent with the addition of a general-purpose radical polymerization initiator. Depending on the case, another addition-polymerizable unsaturated compound is added and thereafter, the polymer can be produced by the same method as above. For example, a dropping polymerization method of effecting the polymerization while adding dropwise the monomer and the initiator in a reaction vessel according to the polymerizability of each monomer is also effective for obtaining a polymer having a uniform composition.

Specific structural examples of the fluorine-containing polymer (1) are illustrated below, but the present invention is not limited thereto. In the formulae, the numeral indicates the mass ratio of respective monomer components, and Mw indicates the mass average molecular weight.

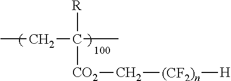

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |
| P-15 | CH₃ | 8 | 10000 |
| P-16 | CH₃ | 8 | 27000 |
| P-17 | H | 10 | 5000 |
| P-18 | H | 10 | 11000 |
| P-19 | CH₃ | 10 | 4500 |
| P-20 | CH₃ | 10 | 12000 |
| P-21 | H | 12 | 5000 |
| P-22 | H | 12 | 10000 |
| P-23 | CH₃ | 12 | 5500 |
| P-24 | CH₃ | 12 | 12000 |

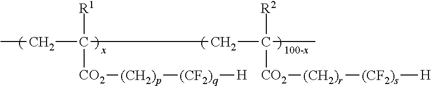

| | x | R¹ | p | q | R² | r | s | Mw |
|---|---|---|---|---|---|---|---|---|
| P-25 | 50 | H | 1 | 4 | CH₃ | 1 | 4 | 10000 |
| P-26 | 40 | H | 1 | 4 | H | 1 | 6 | 14000 |
| P-27 | 60 | H | 1 | 4 | CH₃ | 1 | 6 | 21000 |
| P-28 | 10 | H | 1 | 4 | H | 1 | 8 | 11000 |
| P-29 | 40 | H | 1 | 4 | H | 1 | 8 | 16000 |
| P-30 | 20 | H | 1 | 4 | CH₃ | 1 | 8 | 8000 |
| P-31 | 10 | CH₃ | 1 | 4 | CH₃ | 1 | 8 | 7000 |
| P-32 | 50 | H | 1 | 6 | CH₃ | 1 | 6 | 12000 |
| P-33 | 50 | H | 1 | 6 | CH₃ | 1 | 6 | 22000 |
| P-34 | 30 | H | 1 | 6 | CH₃ | 1 | 6 | 5000 |
| P-35 | 40 | CH₃ | 1 | 6 | H | 3 | 6 | 3000 |
| P-36 | 10 | H | 1 | 6 | H | 1 | 8 | 7000 |
| P-37 | 30 | H | 1 | 6 | H | 1 | 8 | 17000 |
| P-38 | 50 | H | 1 | 6 | H | 1 | 8 | 16000 |
| P-39 | 50 | CH₃ | 1 | 6 | H | 3 | 8 | 19000 |
| P-40 | 50 | H | 1 | 8 | CH₃ | 1 | 8 | 5000 |
| P-41 | 80 | H | 1 | 8 | CH₃ | 1 | 8 | 10000 |
| P-42 | 50 | CH₃ | 1 | 8 | H | 3 | 8 | 14000 |
| P-43 | 90 | H | 1 | 8 | CH₃ | 3 | 8 | 9000 |
| P-44 | 70 | H | 1 | 8 | H | 1 | 10 | 7000 |
| P-45 | 90 | H | 1 | 8 | H | 3 | 10 | 12000 |
| P-46 | 50 | H | 1 | 8 | H | 1 | 12 | 10000 |
| P-47 | 70 | H | 1 | 8 | CH₃ | 3 | 12 | 8000 |

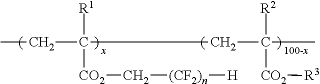

| | x | R¹ | n | R² | R³ | Mw |
|---|---|---|---|---|---|---|
| P-48 | 80 | H | 4 | CH₃ | CH₃ | 11000 |
| P-49 | 90 | H | 4 | H | C₄H₉(n) | 7000 |
| P-50 | 95 | H | 4 | H | C₆H₁₃(n) | 5000 |
| P-51 | 90 | CH₃ | 4 | H | CH₂CH(C₂H₅)C₄H₉ (n) | 15000 |
| P-52 | 70 | H | 6 | CH₃ | C₂H₅ | 18000 |
| P-53 | 90 | H | 6 | CH₃ | 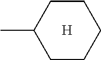 | 12000 |
| P-54 | 80 | H | 6 | H | C₄H₉(sec) | 9000 |
| P-55 | 90 | H | 6 | H | C₁₂H₂₅ (n) | 21000 |
| P-56 | 60 | CH₃ | 6 | H | CH₃ | 15000 |
| P-57 | 60 | H | 8 | H | CH₃ | 10000 |
| P-58 | 70 | H | 8 | H | C₂H₅ | 24000 |
| P-59 | 70 | H | 8 | H | C₄H₉(n) | 5000 |
| P-60 | 50 | H | 8 | H | C₄H₉(n) | 16000 |
| P-61 | 80 | H | 8 | CH₃ | C₄H₉(iso) | 13000 |
| P-62 | 80 | H | 8 | CH₃ | C₄H₉(t) | 9000 |
| P-63 | 60 | H | 8 | H | 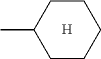 | 7000 |
| P-64 | 80 | H | 8 | H | CH₂CH(C₂H₅)C₄H₉ (n) | 8000 |
| P-65 | 90 | H | 8 | H | C₁₂H₂₅ (n) | 6000 |
| P-66 | 80 | CH₃ | 8 | CH₃ | C₄H₉(sec) | 18000 |
| P-67 | 70 | CH₃ | 8 | CH₃ | CH₃ | 22000 |
| P-68 | 70 | H | 10 | CH₃ | H | 17000 |
| P-69 | 90 | H | 10 | H | H | 9000 |

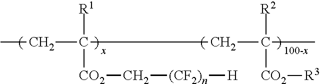

| | x | R¹ | n | R² | R³ | Mw |
|---|---|---|---|---|---|---|
| P-70 | 95 | H | 4 | CH₃ | —(CH₂CH₂O)₂—H | 18000 |
| P-71 | 80 | H | 4 | H | —(CH₂CH₂O)₂—CH₃ | 16000 |
| P-72 | 80 | H | 4 | H | —(C₃H₆O)₇—H | 24000 |
| P-73 | 70 | CH₃ | 4 | H | —(C₃H₆O)₁₃—H | 18000 |
| P-74 | 90 | H | 6 | H | —(CH₂CH₂O)₂—H | 21000 |
| P-75 | 90 | H | 6 | CH₃ | —(CH₂CH₂O)₈—H | 9000 |
| P-76 | 80 | H | 6 | H | —(CH₂CH₂O)₂—C₄H₉(n) | 12000 |
| P-77 | 80 | H | 6 | H | —(C₃H₆O)₇—H | 34000 |
| P-78 | 75 | F | 6 | H | —(C₃H₆O)₁₃—H | 11000 |
| P-79 | 85 | CH₃ | 6 | CH₃ | —(C₃H₆O)₂₀—H | 18000 |
| P-80 | 95 | CH₃ | 6 | CH₃ | —CH₂CH₂OH | 27000 |
| P-81 | 80 | H | 8 | CH₃ | —(CH₂CH₂O)₈—H | 12000 |
| P-82 | 95 | H | 8 | H | —(CH₂CH₂O)₉—CH₃ | 20000 |
| P-83 | 90 | H | 8 | H | —(C₃H₆O)₇—H | 8000 |
| P-84 | 95 | H | 8 | H | —(C₃H₆O)₂₀—H | 15000 |
| P-85 | 90 | F | 8 | H | —(C₃H₆O)₁₃—H | 12000 |
| P-86 | 80 | H | 8 | CH₃ | —(CH₂CH₂O)₂—H | 20000 |
| P-87 | 95 | CH₃ | 8 | H | —(CH₂CH₂O)₉—CH₃ | 17000 |
| P-88 | 90 | CH₃ | 8 | H | —(C₃H₆O)₇—H | 34000 |
| P-89 | 80 | H | 10 | H | —(CH₂CH₂O)₃—H | 19000 |
| P-90 | 90 | H | 10 | H | —(C₃H₆O)₇—H | 8000 |
| P-91 | 80 | H | 12 | H | —(CH₂CH₂O)₇—CH₃ | 7000 |
| P-92 | 95 | CH₃ | 12 | H | —(C₃H₆O)₇—H | 10000 |

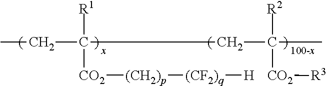

| | x | R¹ | p | q | R² | R³ | Mw |
|---|---|---|---|---|---|---|---|
| P-93 | 80 | H | 2 | 4 | H | C₄H₉(n) | 18000 |
| P-94 | 90 | H | 2 | 4 | H | —(CH₂CH₂O)₉—CH₃ | 16000 |
| P-95 | 90 | CH₃ | 2 | 4 | F | C₆H₁₃(n) | 24000 |
| P-96 | 80 | CH₃ | 1 | 6 | F | C₄H₉(n) | 18000 |
| P-97 | 95 | H | 2 | 6 | H | —(C₃H₆O)₇—H | 21000 |
| P-98 | 90 | CH₃ | 3 | 6 | H | —CH₂CH₂OH | 9000 |
| P-99 | 75 | H | 1 | 8 | F | CH₃ | 12000 |
| P-100 | 80 | H | 2 | 8 | H | CH₂CH(C₂H₅)C₄H₉(n) | 34000 |
| P-101 | 90 | CH₃ | 2 | 8 | H | —(C₃H₆O)₇—H | 11000 |
| P-102 | 80 | H | 3 | 8 | CH₃ | CH₃ | 18000 |
| P-103 | 90 | H | 1 | 10 | F | C₄H₉(n) | 27000 |
| P-104 | 95 | H | 2 | 10 | H | —(CH₂CH₂O)₉—CH₃ | 12000 |
| P-105 | 85 | CH₃ | 2 | 10 | CH₃ | C₄H₉(n) | 20000 |
| P-106 | 80 | H | 1 | 12 | H | C₆H₁₃(n) | 8000 |
| P-107 | 90 | H | 1 | 12 | H | —(C₃H₅O)₁₃—H | 15000 |
| P-108 | 60 | CH₃ | 3 | 12 | CH₃ | C₂H₅ | 12000 |
| P-109 | 60 | H | 1 | 16 | H | CH₂CH(C₂H₅)C₄H₉(n) | 20000 |
| P-110 | 80 | CH₃ | 1 | 16 | H | —(CH₂CH₂O)₂—C₄H₉(n) | 17000 |
| P-111 | 90 | H | 1 | 18 | H | —CH₂CH₂OH | 34000 |
| P-112 | 60 | H | 3 | 18 | CH₃ | CH₃ | 19000 |

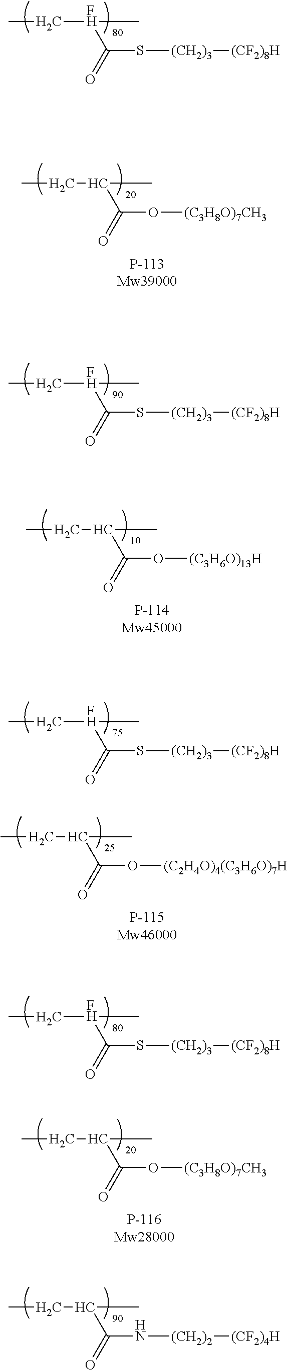

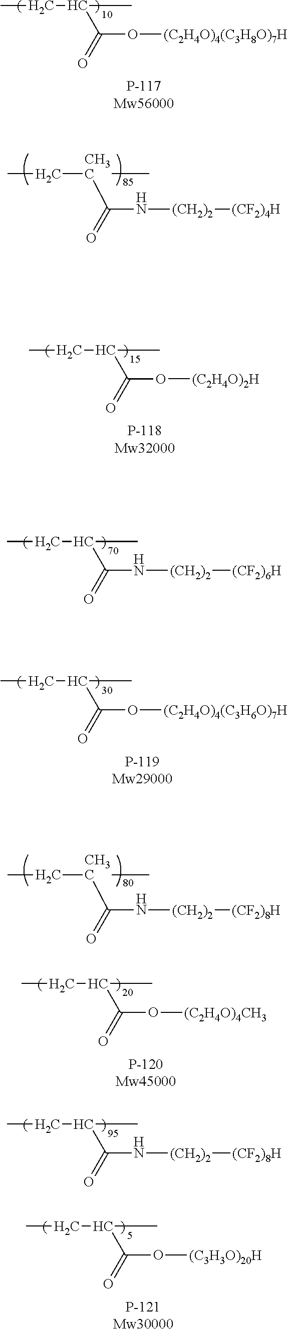

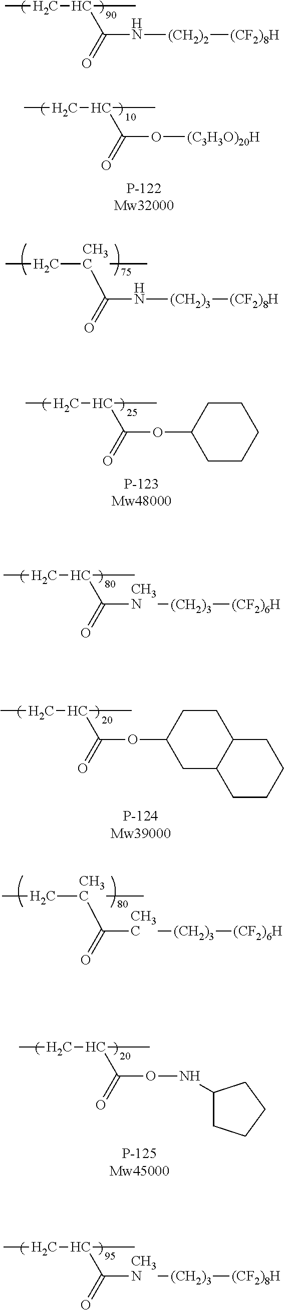

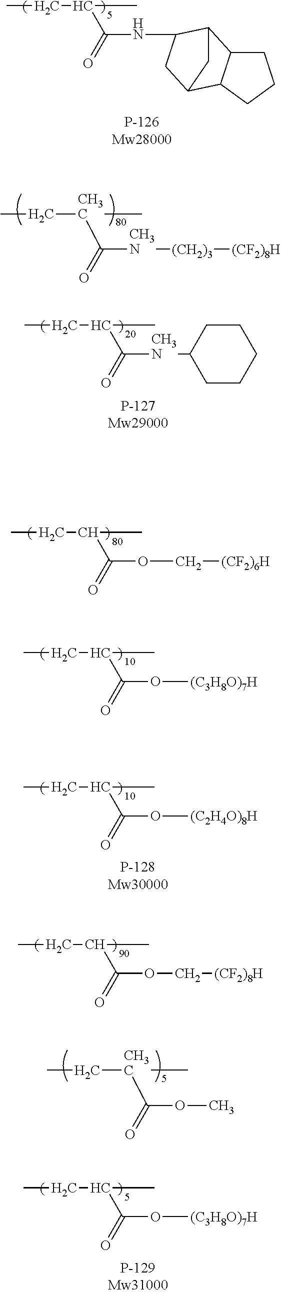

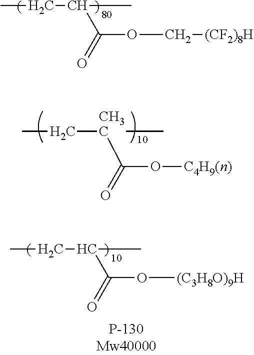

The fluorine-containing polymer (2) is described below.

The fluorine-containing polymer (2) is a polymer containing a polymerization unit derived from a fluoroaliphatic group-containing monomer represented by the following formula [2] and a polymerization unit derived from at least any one selected from a poly(oxyalkylene) acrylate and a poly(oxyalkylene) methacrylate:

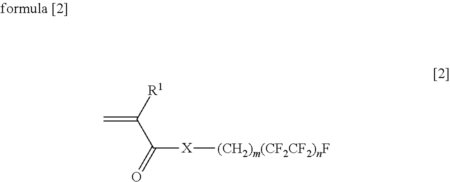

(wherein R¹ represents a hydrogen atom or a methyl group, X represents an oxygen atom, a sulfur atom or —N(R²)—, m represents an integer of 1 to 6, n represents an integer of 1 to 3, and R² represents a hydrogen atom or an alkyl group having a carbon number of 1 to 4).

One fluoroaliphatic group in the fluorine-containing polymer (2) is preferably derived from a fluoroaliphatic compound produced by a telomerization process (sometimes referred to as a telomer process) or an oligomerization process (sometimes referred to as an oligomer process). The method for producing such a fluoroaliphatic compound is described, for example, in Nobuo Ishikawa (supervisor), Fusso-kagobutsu no Gousei to Kinou (Synthesis and Function of Fluorine Compounds), pp. 117-118, CMC Publishing Co., Ltd. (1987), and “Chemistry of Organic Fluorine Compounds II” of Monograph 187, edited by Milos Hudlicky and Attila E. Pavlath, pp. 747-752, American Chemical Society (1995). The telomerization process is a method of performing radical polymerization of a fluorine-containing vinyl compound such as tetrafluoroethylene by using an alkyl halide having a large chain transfer constant, such as iodide, for the telogen to synthesize a telomer (one example is shown in Scheme-1).

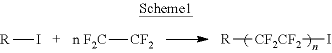

The obtained iodine-terminated telomer is usually subjected to an appropriate terminal chemical modification, for example, as in “Scheme 2” and led to a fluoroaliphatic compound. This compound is, if desired, further converted into a desired monomer structure and used for the production of a fluoroaliphatic group-containing polymer.

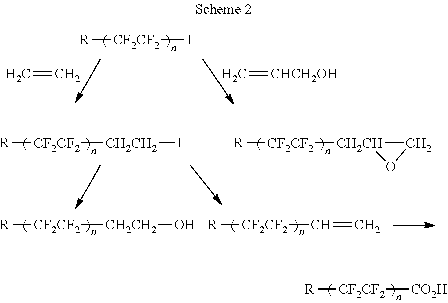

In formula [2] of the fluorine-containing polymer (2), R¹ represents a hydrogen atom or a methyl group, and X represents an oxygen atom, a sulfur atom or —N(R²)—, wherein R² represents a hydrogen atom or an alkyl group having a carbon number of 1 to 4, specifically, a methyl group, an ethyl group, a propyl group or a butyl group, and is preferably a hydrogen atom or a methyl group. X is more preferably an oxygen atom.

In formula [2], m is preferably an integer of 1 to 6, more preferably 2.

In formula [2], n is from 1 to 3, preferably 2 to 3, and a mixture of polymers where n is from 1 to 3 may also be used.

Specific monomer examples of the fluoroaliphatic group-containing monomer represented by formula [2] are illustrated below, but the present invention is not limited thereto.

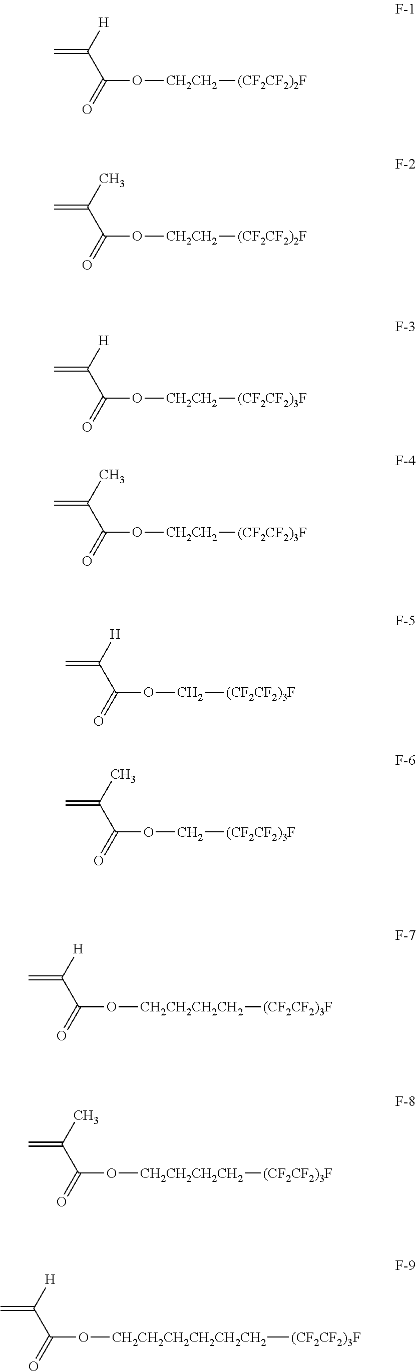

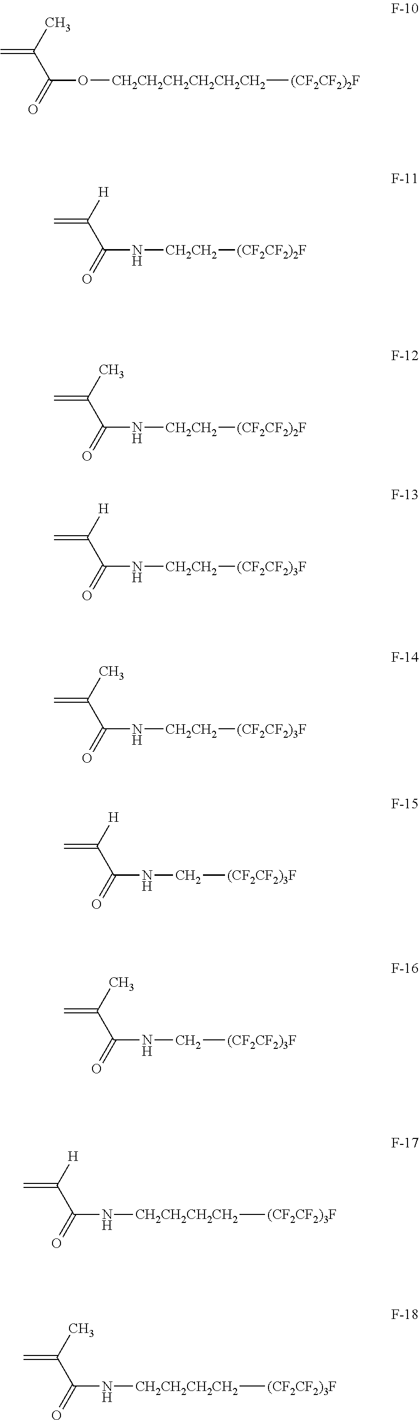

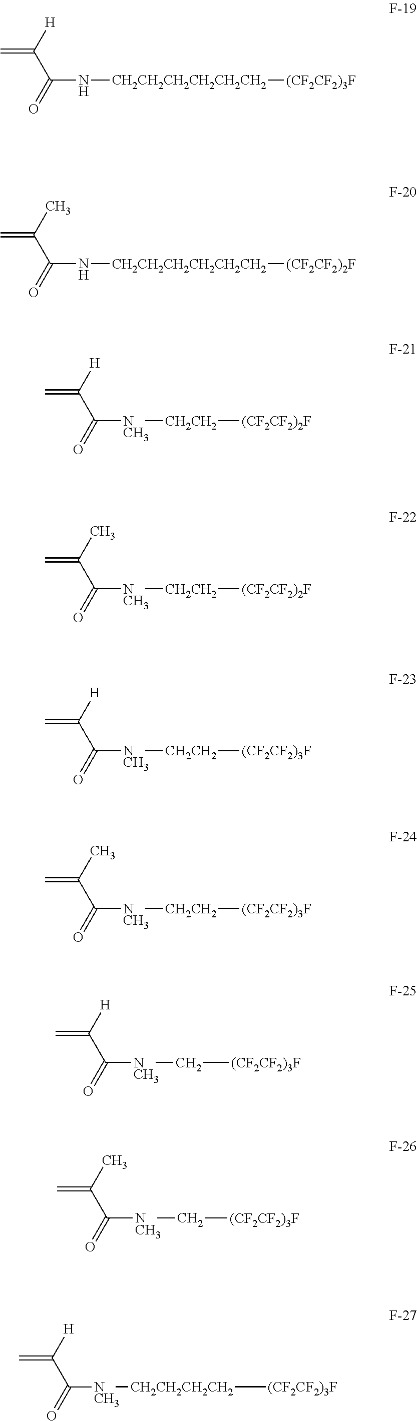

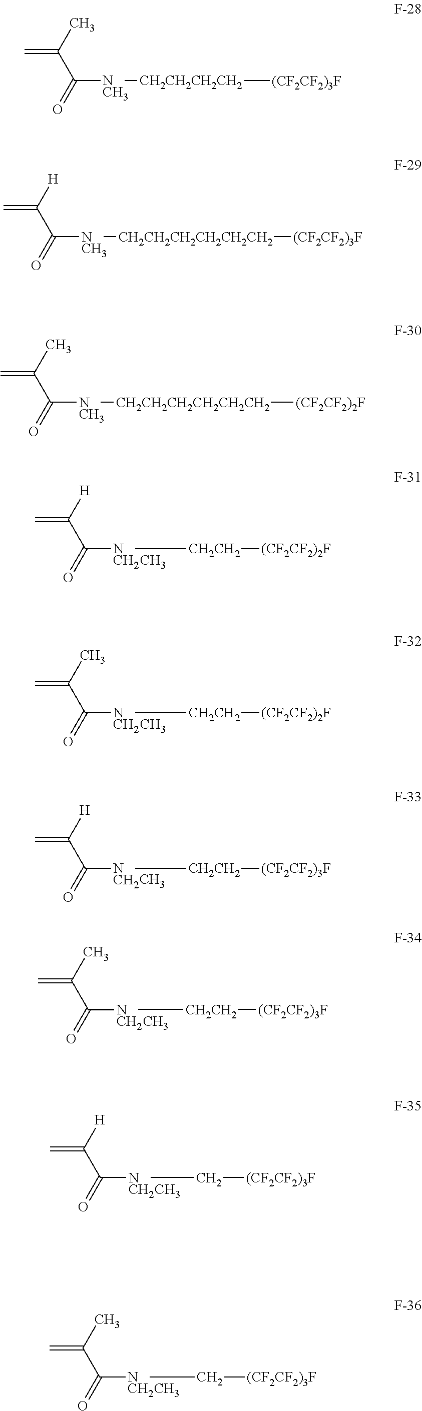

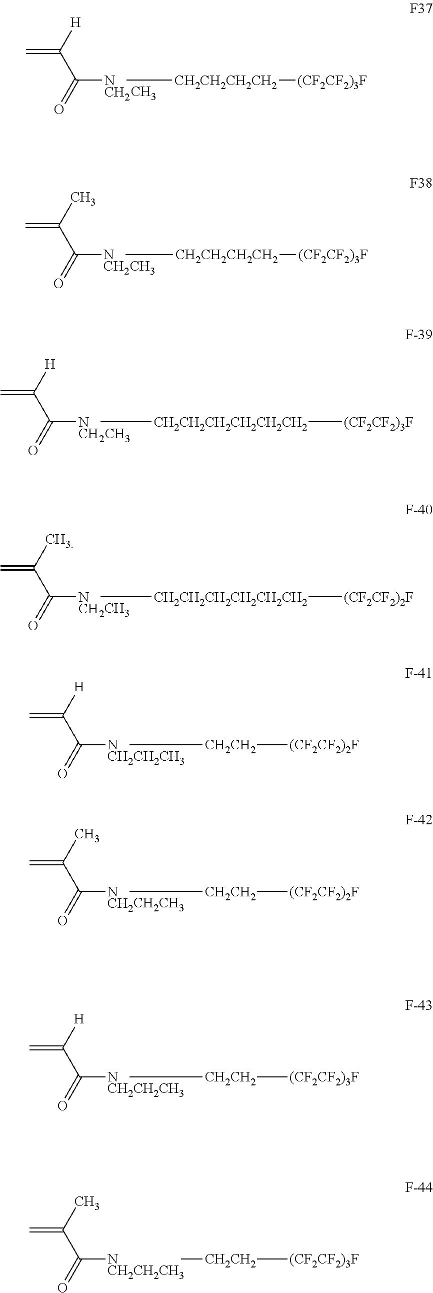

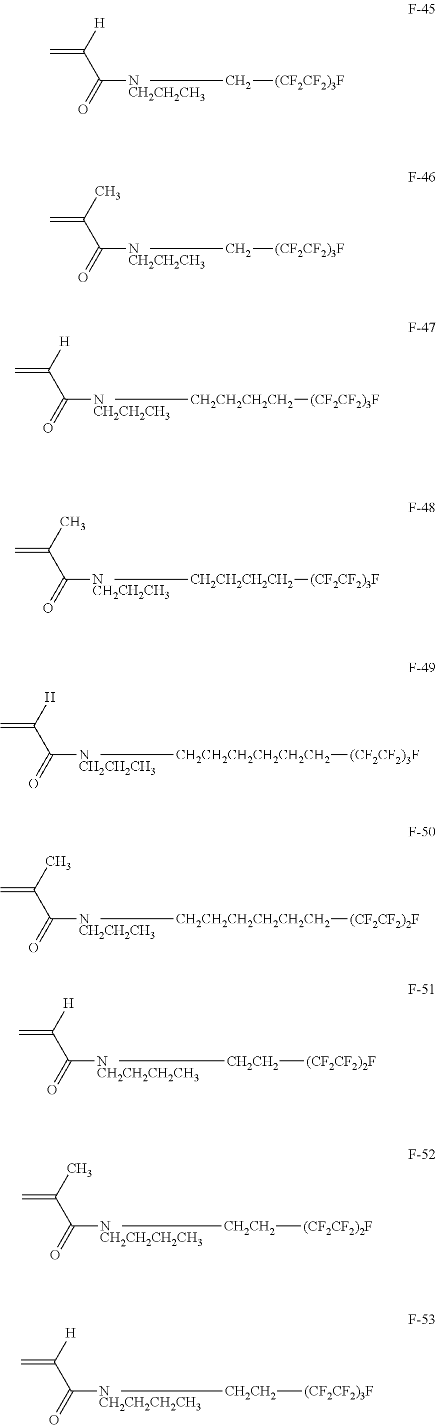

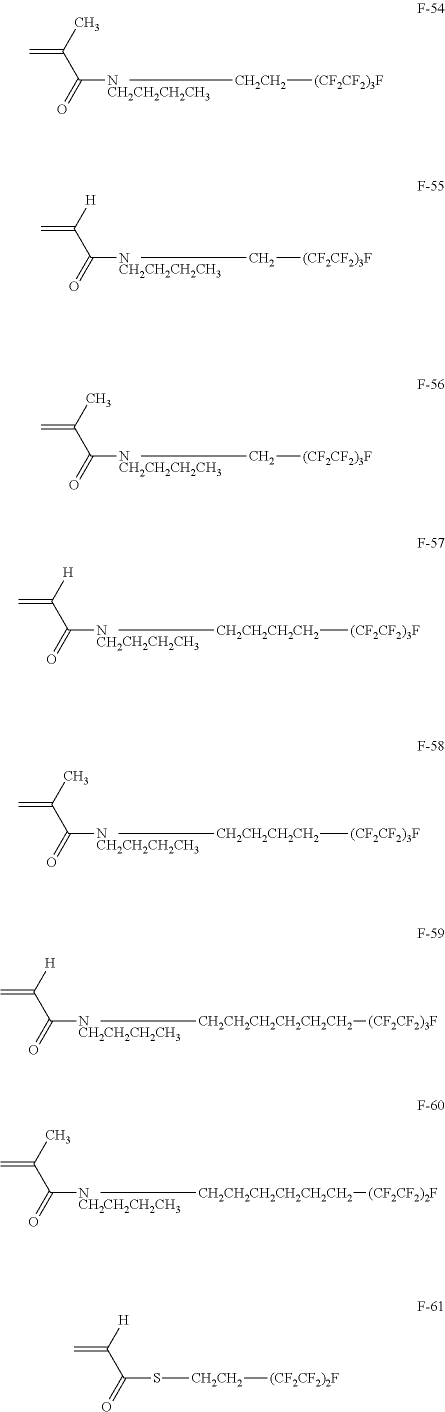

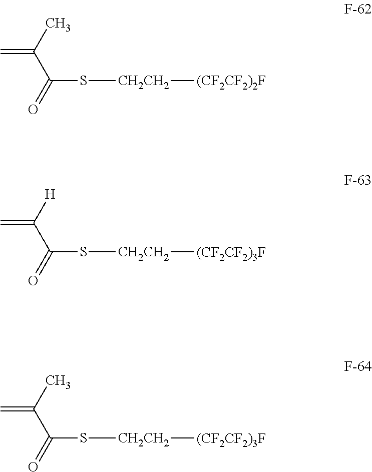

The poly(oxyalkylene) acrylate and poly(oxyalkylene) methacrylate in the fluorine-containing polymer (2) are described below.

The polyoxyalkylene can be represented by (OR)ₓ, wherein R is preferably an alkylene group having from 2 to 4 carbon atoms, such as —CH₂CH₂—, —CH₂CH₂CH₂, —CH(CH₃)CH₂— and —CH(CH₃)CH(CH₃)—.

The oxyalkylene units in the poly(oxyalkylene) group may be the same as in poly(oxypropylene), may be two or more different kinds of oxyalkylene units which are irregularly distributed, may be a linear or branched oxypropylene or oxyethylene unit, or may be present as a block of linear or branched oxypropylene units or a block of oxyethylene units.

The poly(oxyalkylene) chain may contain units connected through one or more linking bonds (for example, —CONH-Ph-NHCO— and —S—; Ph represents a phenylene group). In the case where the linking bond is trivalent or higher valent, this provides means for obtaining a branched oxyalkylene unit. Also, in the case of using this copolymer in the present invention, the molecular weight of the poly(oxyalkylene) group is suitably from 250 to 3,000.

The poly(oxyalkylene) acrylate or methacrylate can be produced by reacting a hydroxy poly(oxyalkylene) material commercially available, for example, under the trade name of “Pluronic” (produced by Asahi Denka Co., Ltd.), “ADEKA POLYETHER” (produced by Asahi Denka Co., Ltd.), “Carbowax” (produced by Glyco Products Co.), “Toriton” (produced by Rohm and Haas Co.) or P.E.G (produced by Dai-Ichi Kogyo Seiyaku Co., Ltd.), with an acrylic acid, a methacrylic acid, an acryl chloride, a methacryl chloride, an acrylic anhydride or the like according to a known method. Also, a poly(oxyalkylene) diacrylate or the like produced by a known method may be used.

A particularly preferred embodiment of the fluorine-containing polymer (2) is a polymer obtained by copolymerizing three or more kinds of monomers, that is, a monomer represented by formula [2], a polyoxyethylene (meth)acrylate and a polyoxyalkylene (meth)acrylate. Here, the polyoxyalkylene (meth)acrylate is a monomer different from the polyoxyethylene (meth)acrylate.

A ternary copolymer of a polyoxyethylene (meth)acrylate, a polyoxypropylene (meth)acrylate and a monomer represented by formula [2] is more preferred.

The copolymerization ratio of polyoxyethylene (meth)acrylate is preferably from 0.5 to 20 mol %, more preferably from 1 to 10 mol %, based on all monomers.

The fluorine-containing polymer (2) may contain a polymerization unit derived from a monomer represented by the following formula [4]:

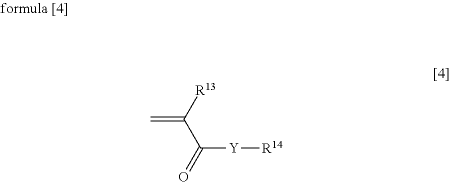

(wherein R¹³ represents a hydrogen atom or a methyl group, Y represents a divalent linking group, and R¹⁴ represents a linear, branched or cyclic alkyl group having a carbon number of 4 to 20, which may have a substituent).

Y is preferably an oxygen atom, a sulfur atom, —N(R¹⁵)— or the like. R¹⁵ is preferably a hydrogen atom or an alkyl group having a carbon number of 1 to 4, such as methyl group, ethyl group, propyl group and butyl group. R¹⁵ is more preferably a hydrogen atom or a methyl group. Y is more preferably a hydrogen atom, —N(H)— or —N(CH₃)—.

Examples of the substituent of the alkyl group of R¹⁴ include, but are not limited to, a hydroxyl group, an alkylcarbonyl group, an arylcarbonyl group, a carboxyl group, an alkyl ether group, an aryl ether group, a halogen atom such as fluorine atom, chlorine atom and bromine atom, a nitro group, a cyano group and an amino group. As for the linear, branched or cyclic alkyl group having a carbon number of 4 to 20, there may be suitably used a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, an eicosanyl group, each of which may be linear or branched, a monocyclic cycloalkyl group such as cyclohexyl group and cycloheptyl group, and a polycyclic cycloalkyl group such as bicycloheptyl group, bicyclodecyl group, tricycloundecyl group, tetracyclododecyl group, adamantyl group, norbornyl group and tetracyclodecyl group.

Specific examples of the monomer represented by formula [4] include, but are not limited to, the monomers illustrated below.

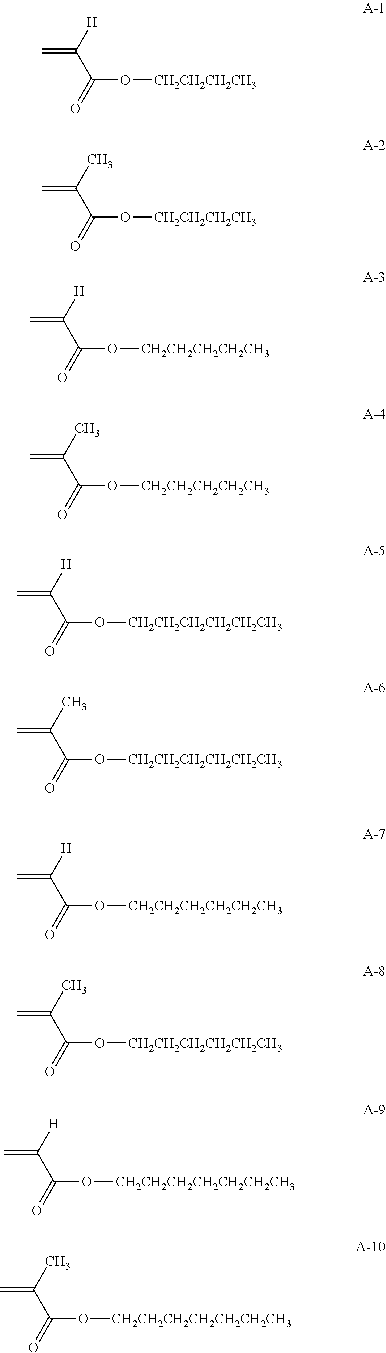

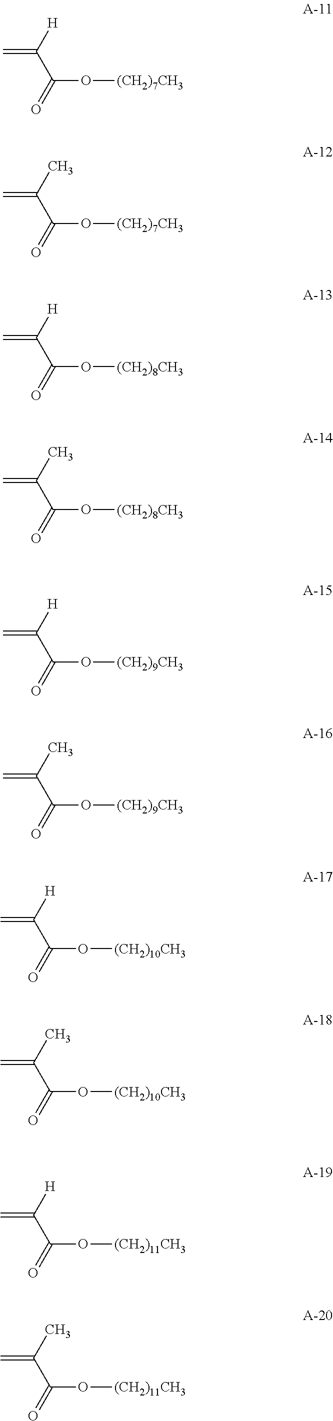

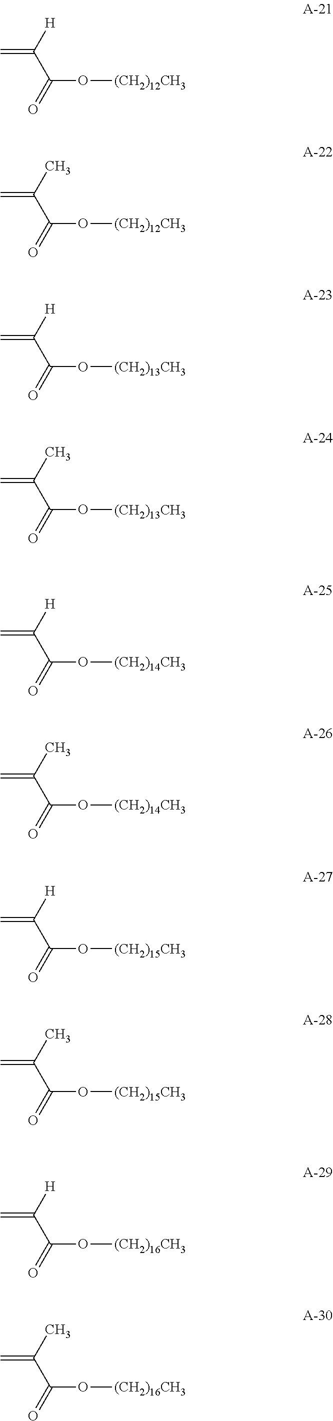

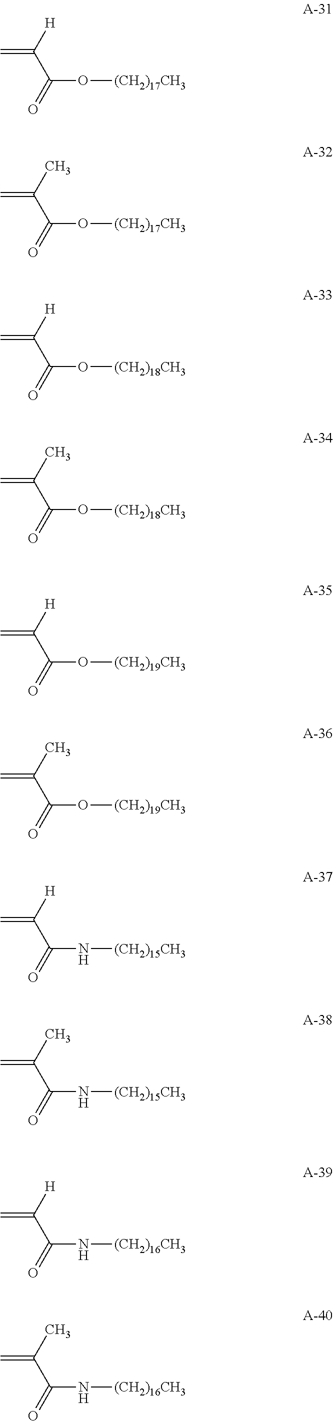

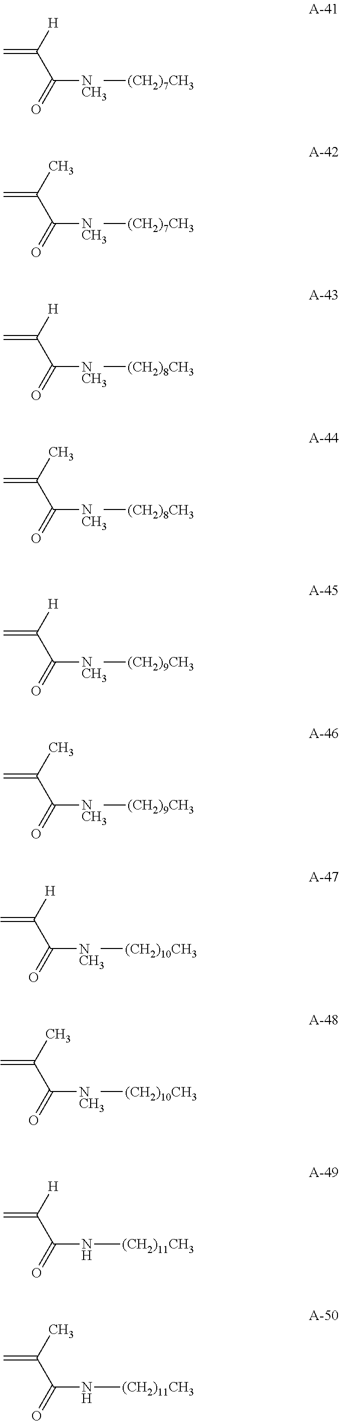

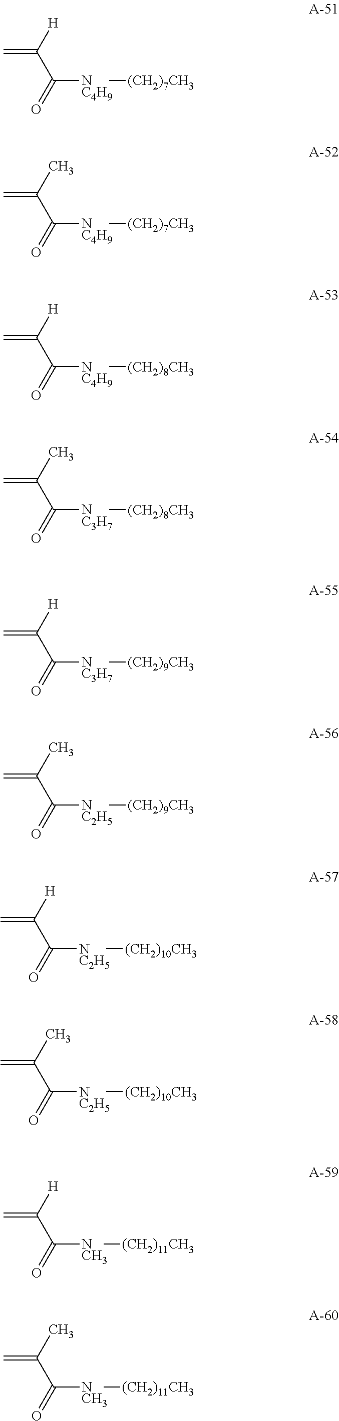

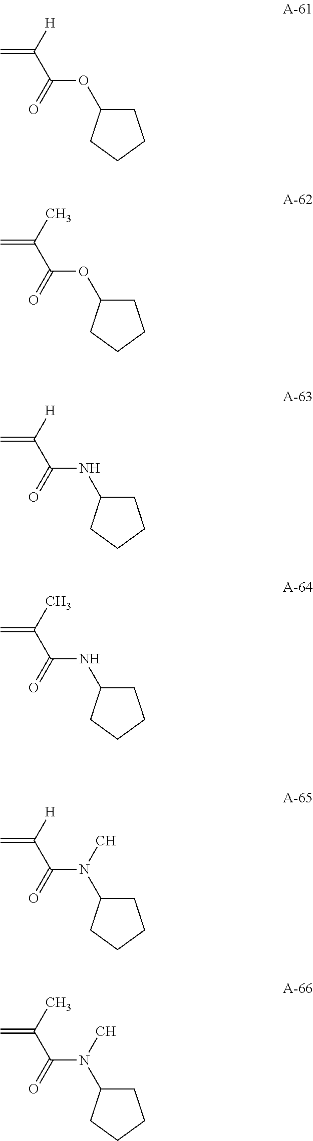

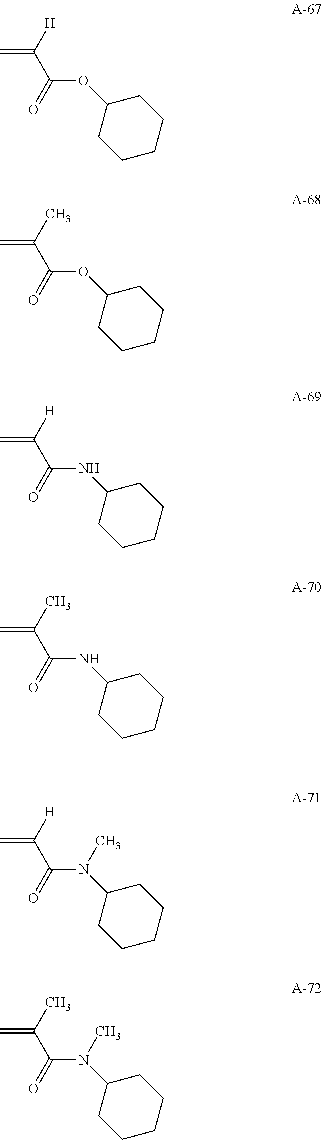

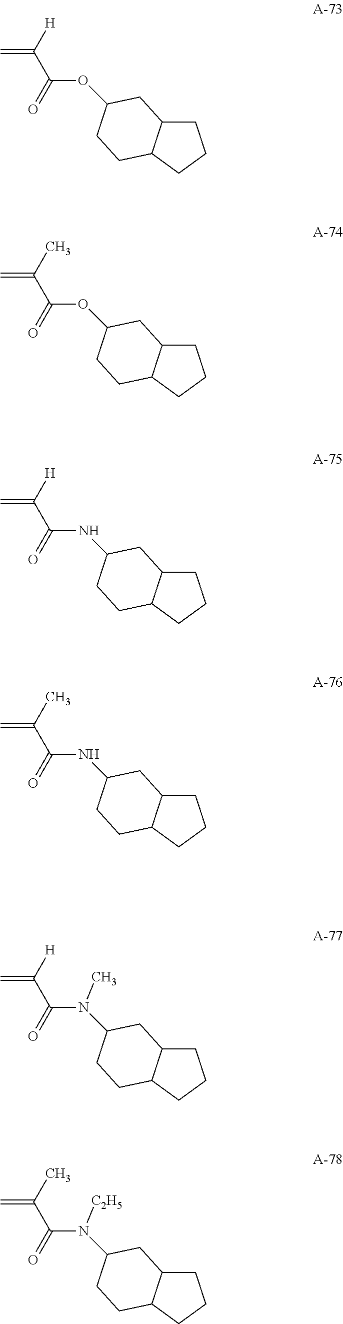

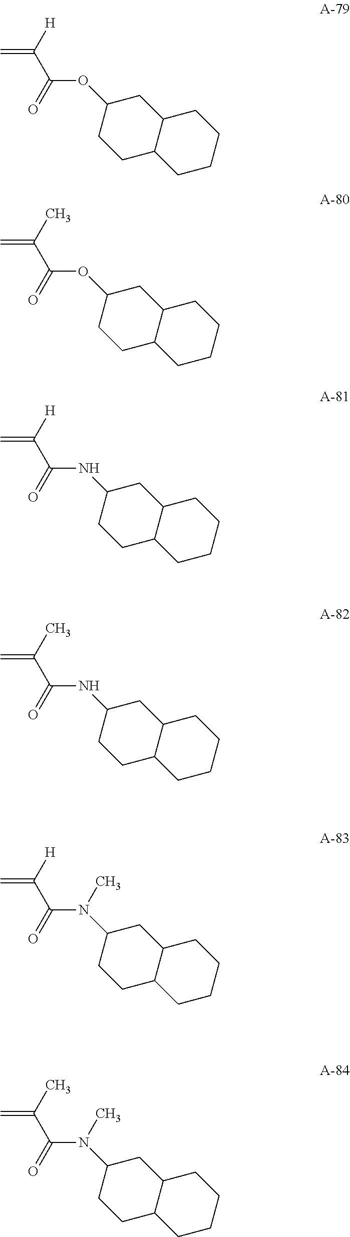

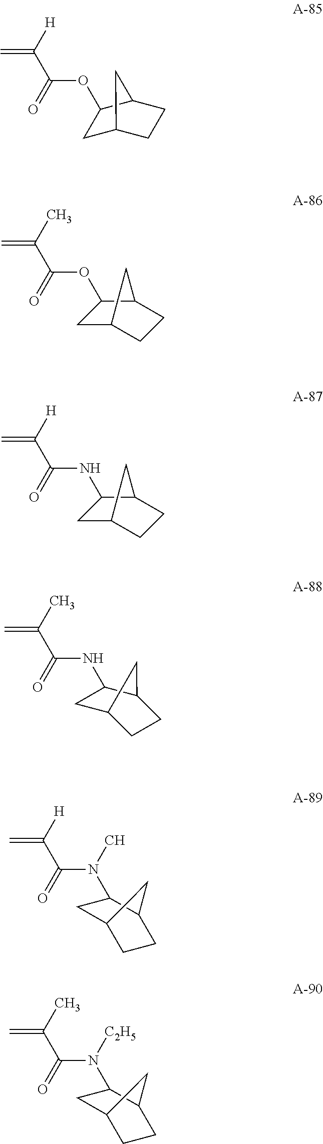

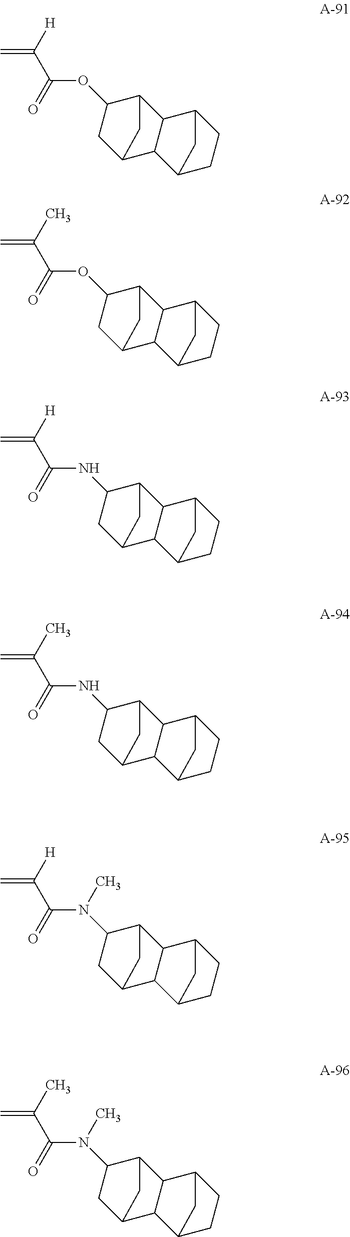

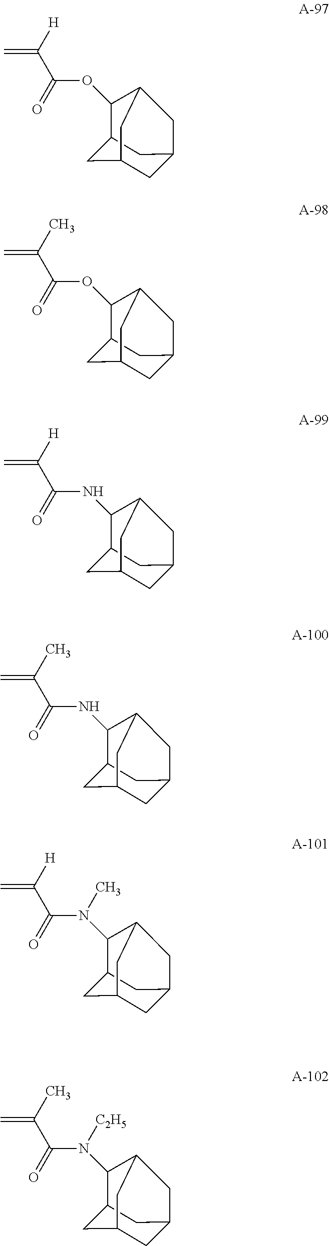

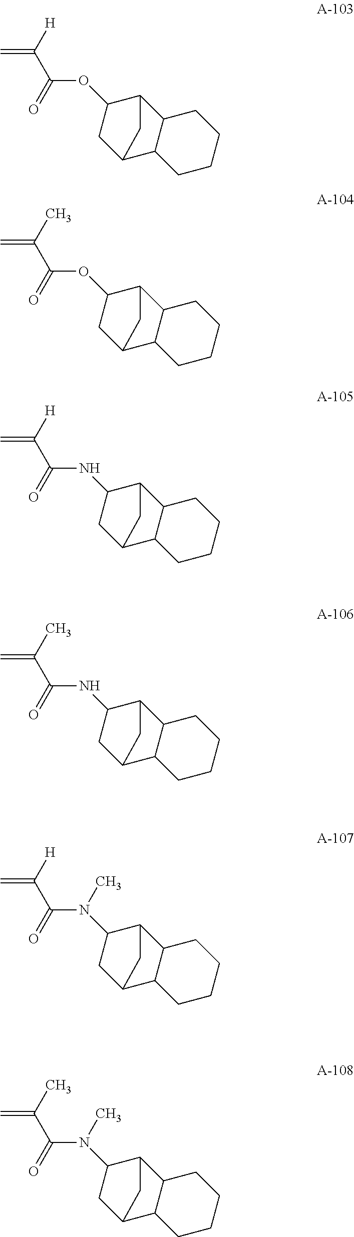

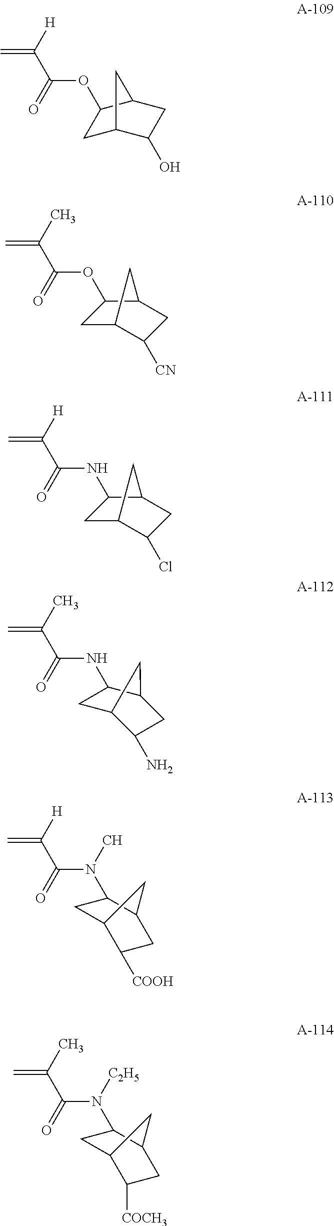

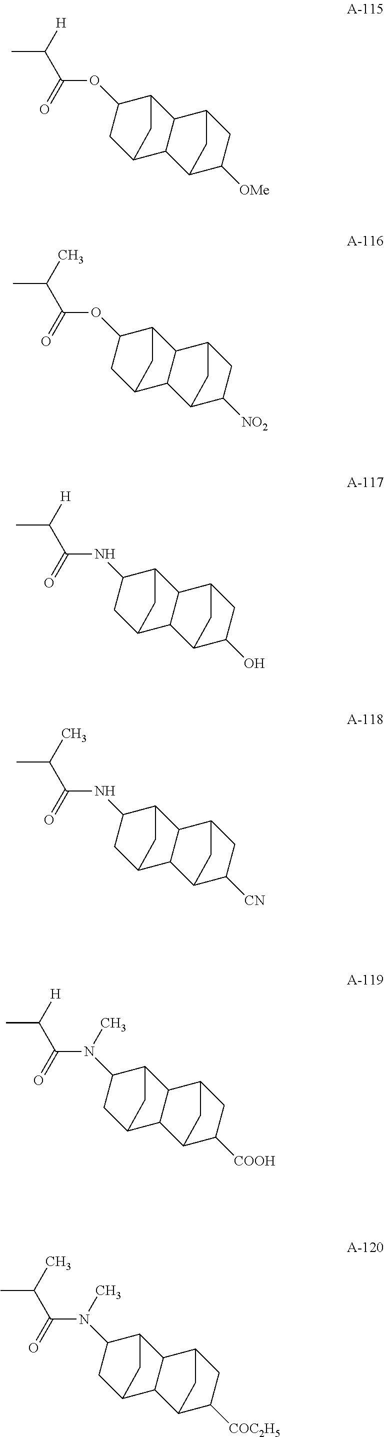

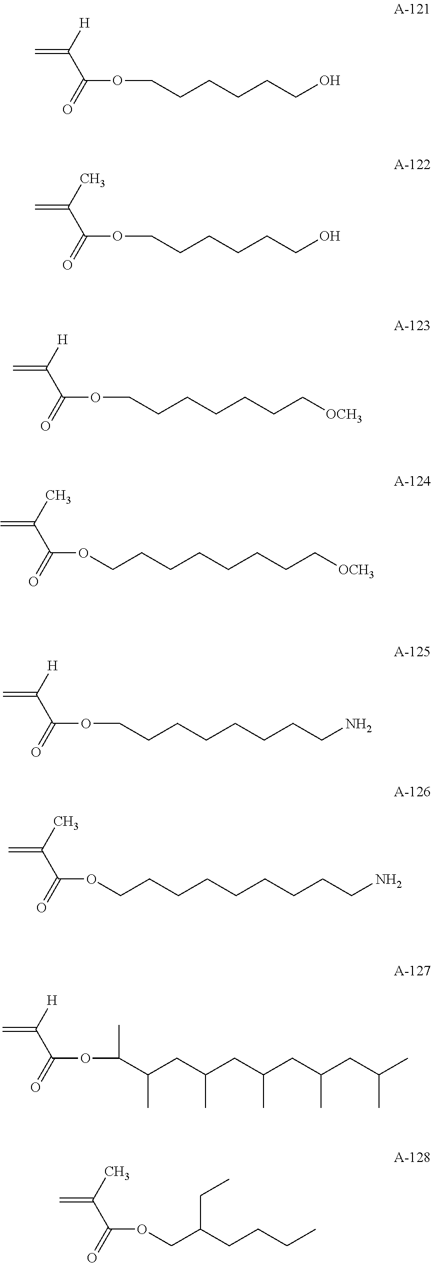

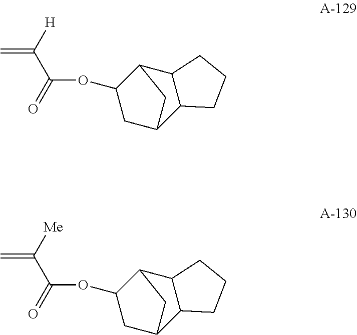

The fluorine-containing polymer (2) contains repeating units derived from a monomer represented by formula [2], a poly(oxyalkylene)acrylate and/or a poly(oxyalkylene)methacrylate and, if desired, a monomer represented by formula [4], and in addition, another monomer copolymerizable therewith can be reacted.

The copolymerization ratio of this copolymerizable monomer is preferably 20 mol % or less, more preferably 10 mol % or less, based on all monomers.

As for such a monomer, those described in J: Brandrup, Polymer Handbook, 2nd ed., Chapter 2, pp. 1-483, Wiley Interscience (1975) may be used. Examples thereof include compounds having one addition-polymerizable unsaturated bond selected from acrylic acid, methacrylic acid, acrylic acid esters, methacrylic acid esters, acrylamides, methacrylamides, allyl compounds, vinyl ethers and vinyl esters.

Specific examples of the copolymerizable monomer include the following monomers:

acrylic acid esters:

methyl acrylate, ethyl acrylate, propyl acrylate, chloroethyl acrylate, 2-hydroxyethyl acrylate, trimethylolpropane monoacrylate, benzyl acrylate, methoxybenzyl acrylate, furfuryl acrylate and tetrahydrofurfuryl acrylate,

methacrylic acid esters:

methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate and tetrahydrofurfuryl methacrylate,

acrylamides:

acrylamide, an N-alkylacrylamide (the alkyl group is an alkyl group having a carbon number of 1 to 3, such as methyl group, ethyl group and propyl group), an N,N-dialkylacrylamide (the alkyl group is an alkyl group having a carbon number of 1 to 3), N-hydroxyethyl-N-methylacrylamide and N-2-acetamidoethyl-N-acetylacrylamide,

methacrylamides:

methacrylamide, an N-alkylmethacrylamide (the alkyl group is an alkyl group having a carbon number of 1 to 3, such as methyl group, ethyl group and propyl group), an N,N-dialkylmethacrylamide (the alkyl group is an alkyl group having a carbon number of 1 to 3), N-hydroxyethyl-N-methylmethacrylamide and N-2-acetamidoethyl-N-acetylmethacrylamide,

allyl compounds:

allyl esters (e.g., allyl acetate, allyl caproate, allyl caprylate, allyl laurate, allyl palmitate, allyl stearate, allyl benzoate, allyl acetoacetate, allyl lactate) and allyloxyethanol,

vinyl ethers:

an alkyl vinyl ether (e.g., hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether and tetrahydrofurfuryl vinyl ether,

vinyl esters:

vinyl butyrate, vinyl isobutyrate, vinyl trimethylacetate, vinyl diethylacetate, vinyl valerate, vinyl caproate, vinyl chloroacetate, vinyl dichloroacetate, vinyl methoxyacetate, vinyl butoxyacetate, vinyl lactate, vinyl-p-phenyl butyrate and vinyl cyclohexyl carboxylate,

dialkyl itaconates:

dimethyl itaconate, diethyl itaconate and dibutyl itaconate,

fumaric acid dialkyl esters or monoalkyl esters:

dibutyl fumarate, and

others:

crotonic acid, itaconic acid, acrylonitrile, methacrylonitrile, maleylonitrile and styrene.

The amount of the fluoroaliphatic group-containing monomer represented by formula [2] used in the fluorine-containing polymer (2) is preferably from 5 to 90 mass %, more preferably from 8 to 80 mass %, still more preferably from 10 to 70 mass %, based on all monomers used for the fluorine-containing polymer (2).

The amount of the poly(oxyalkylene) acrylate and/or poly(oxyalkylene) methacrylate is preferably from 10 to 80 mass %, more preferably from 20 to 75 mass %, still more preferably from 30 to 70 mass %, based on all monomers used for the fluorine-containing polymer (2).

The amount of the monomer represented by formula [4] in the fluorine-containing polymer (2) is preferably from 0 to 40 mass %, more preferably from 1 to 30 mass %, still more preferably from 2 to 20 mass %, based on all monomers used for the fluorine-containing polymer (2).

The mass average molecular weight of the fluorine-containing polymer (2) is preferably from 2,000 to 80,000, more preferably from 4,000 to 40,000, and most preferably from 6,000 to 25,000. When the mass average molecular weight of the fluorine-containing polymer (2) is not less than the lower limit above, superficial distribution of the leveling agent is enhanced and therefore, the effect of improving the surface unevenness or the scratch resistance is increased, and when it is not more than the upper limit above, the hydrophobicity of the leveling agent can be set to an appropriately low level and therefore, a repelling problem is hardly caused or when an antireflection layer is formed on the hardcoat layer, the leveling agent is liable to be swiftly extracted by the antireflection layer.

The fluorine-containing polymer (2) can be produced by a conventionally known method. For example, the polymer can be produced by polymerizing the above-described monomer such as fluoroaliphatic group-containing (meth)acrylate and polyoxyalkylene group-containing (meth)acrylate in an organic solvent with the addition of a general-purpose radical polymerization initiator. Depending on the case, another addition-polymerizable unsaturated compound is added and thereafter, the polymer can be produced by the same method as above. For example, a dropping polymerization method of effecting the polymerization while adding dropwise the monomer and the initiator in a reaction vessel according to the polymerizability of each monomer is also effective for obtaining a polymer having a uniform composition.

Specific structural examples of the fluorine-containing polymer (2) are illustrated below, but the present invention is not limited thereto. In the formulae, the numeral indicates the molar ratio of respective monomer components, and Mw indicates the mass average molecular weight.

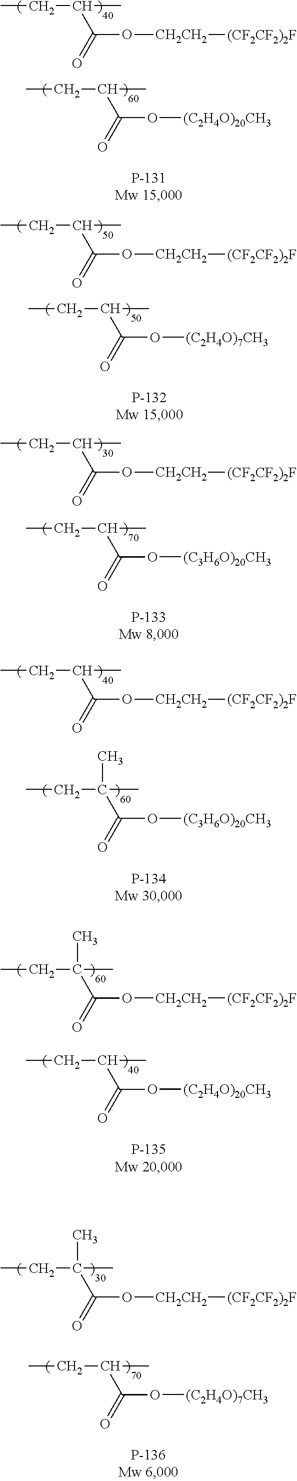

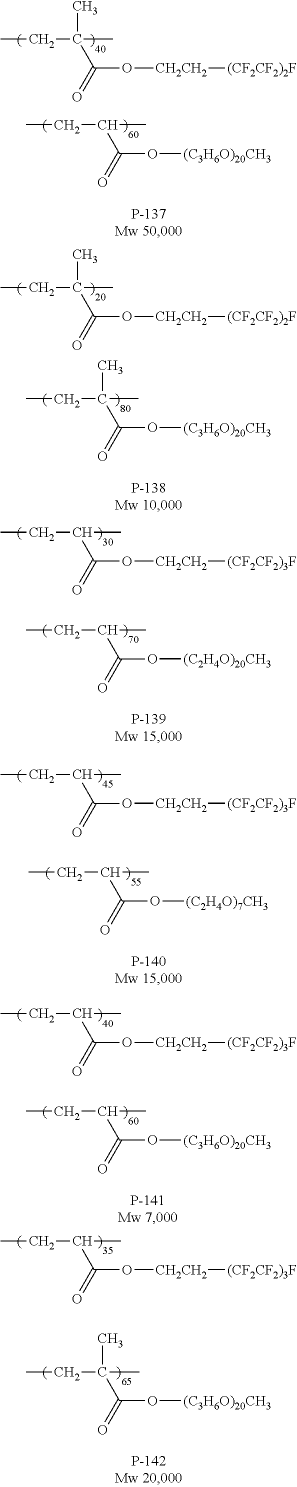

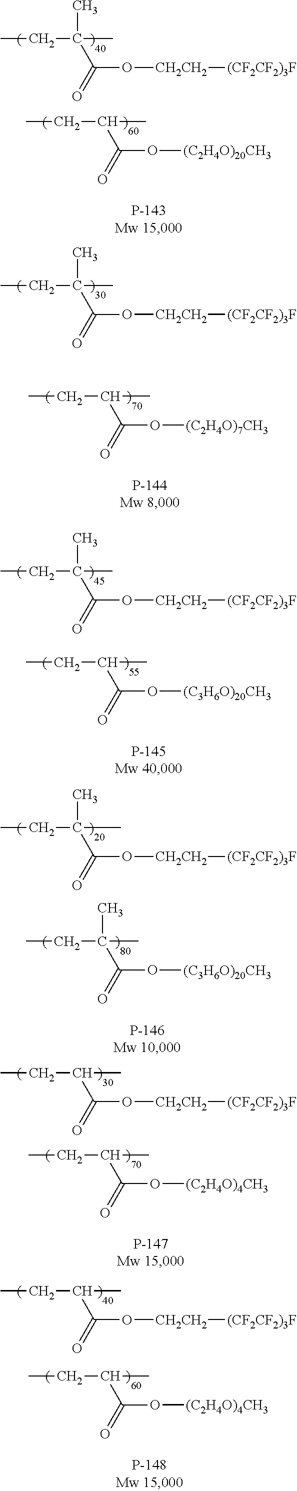

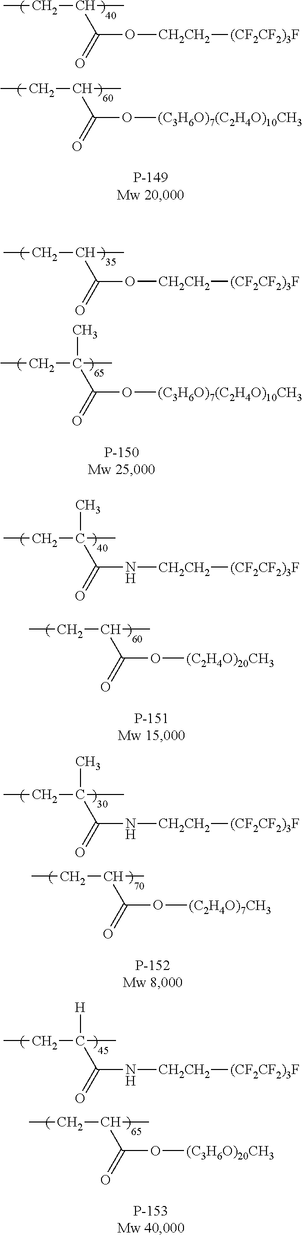

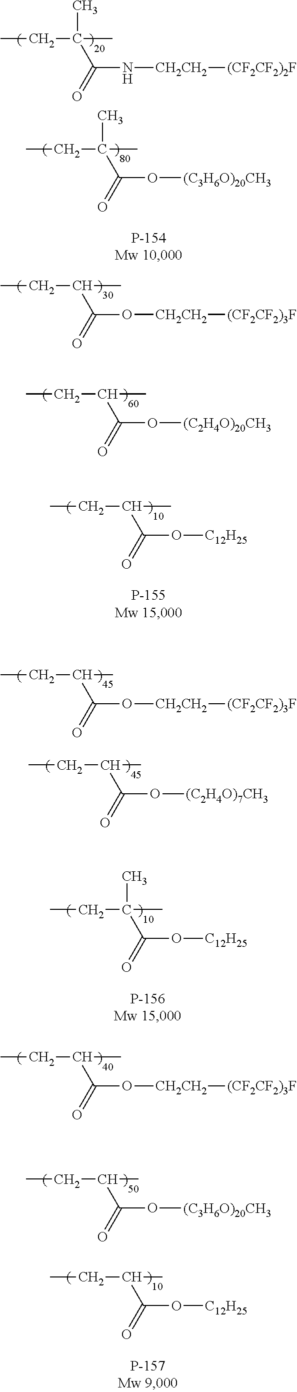

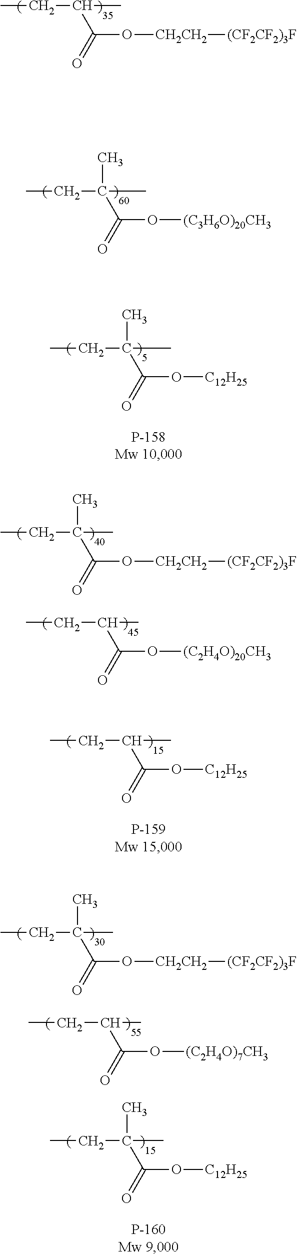

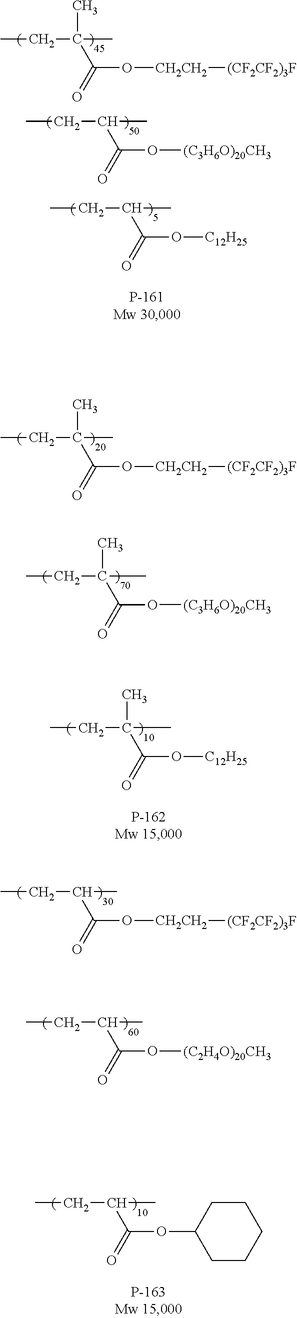

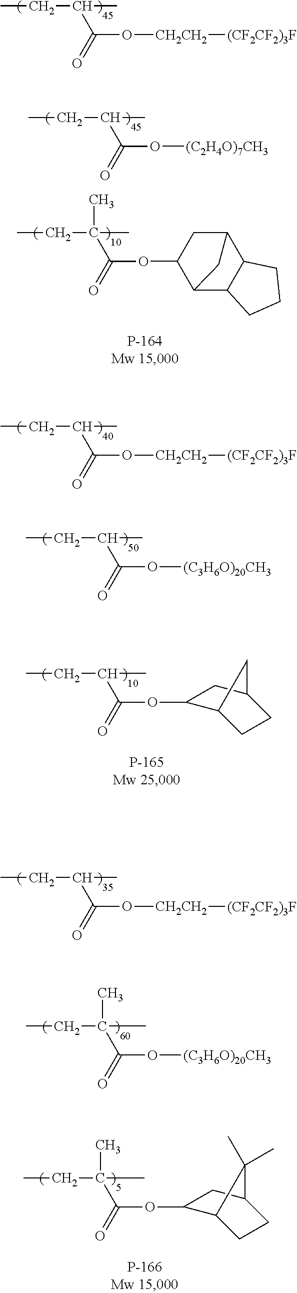

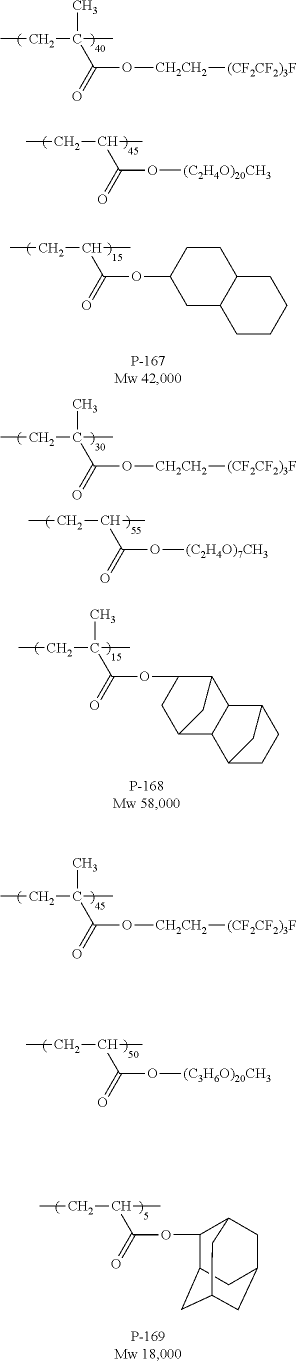

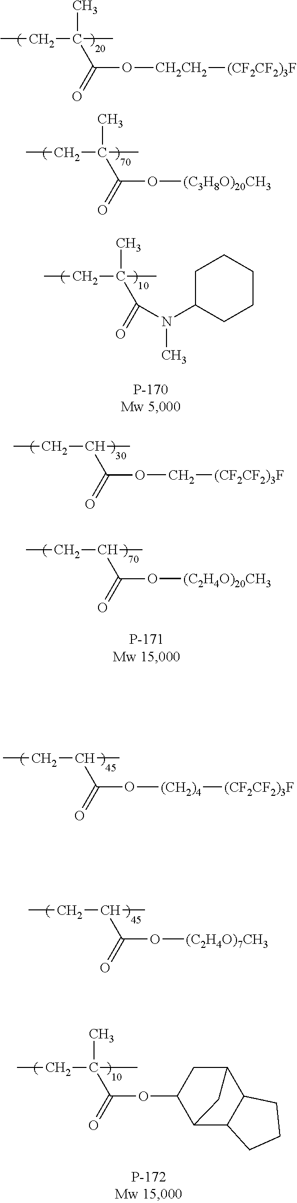

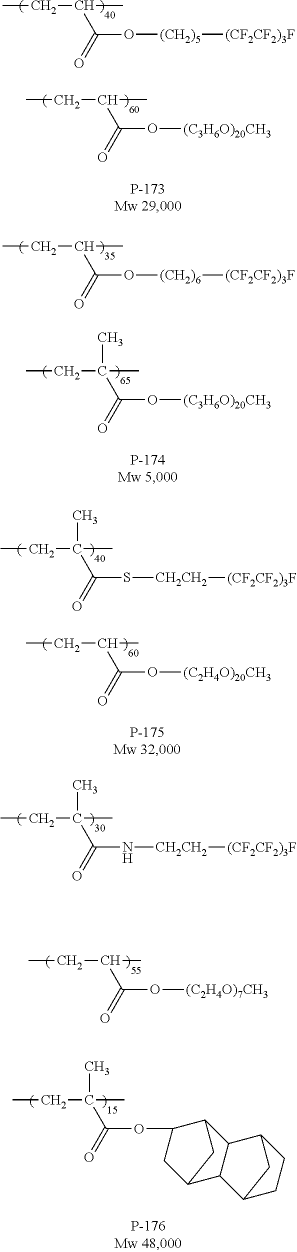

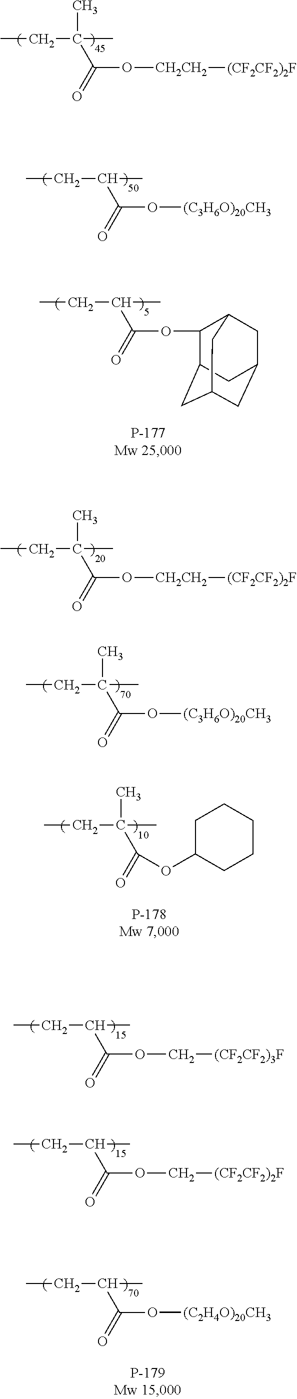

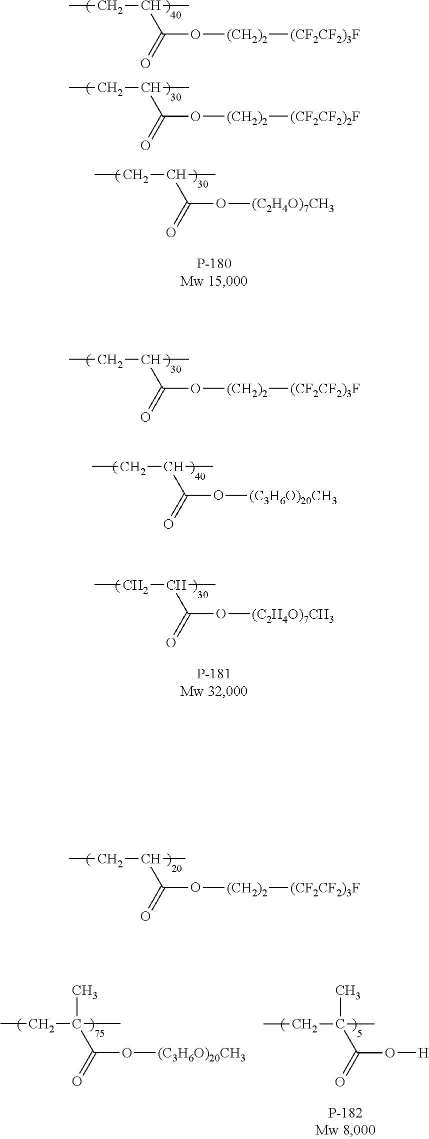

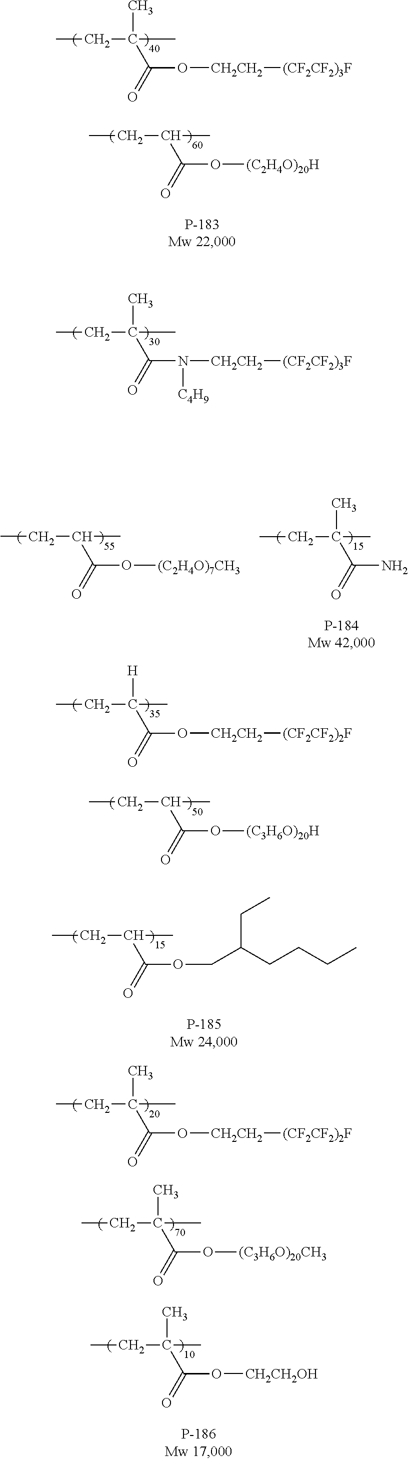

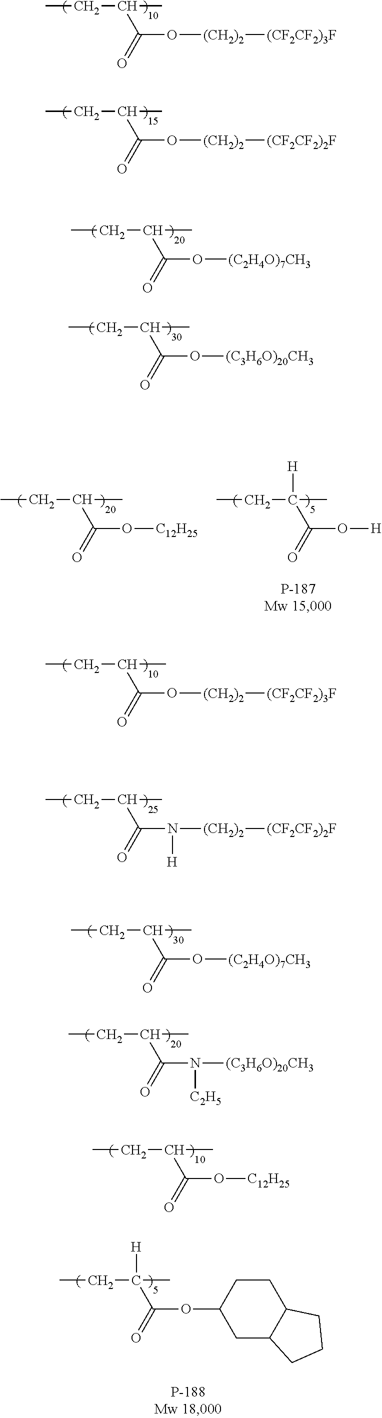

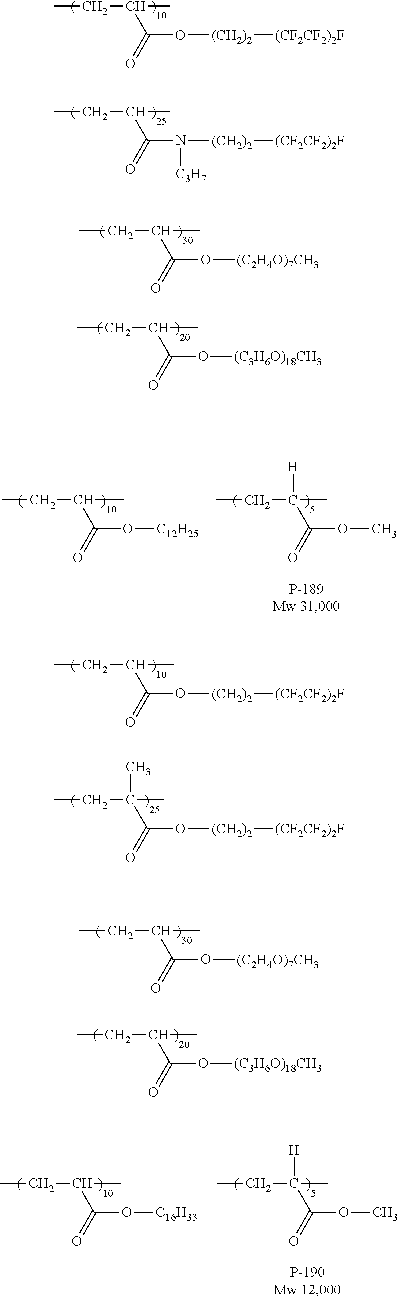

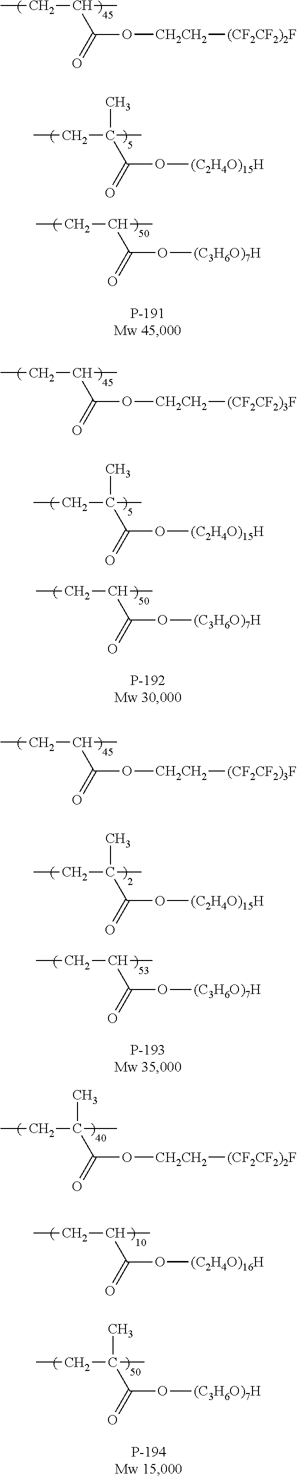

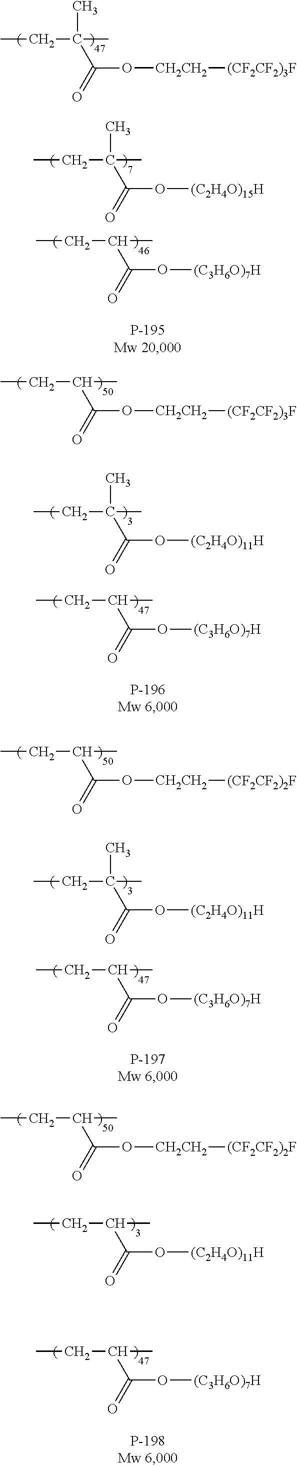

In the present invention, the leveling agent is preferably distributed in a sufficiently large amount in the surface of the hardcoat layer. However, in the case of stacking an antireflection layer on the hardcoat layer, if the leveling agent contained in the hardcoat layer remains in the interface between the hardcoat layer and the antireflection layer, this deteriorates the adherence and seriously impairs the scratch resistance. Therefore, it is important that when an antireflection layer is stacked, the leveling agent is swiftly extracted by the antireflection layer and does not remain in the interface. The fluorine-containing polymer (1) where the terminal of the fluoroaliphatic group is a hydrogen atom hardly repels the coating solution of the overlying layer and is swiftly extracted by the overlying layer and scarcely allowed to remain in the interface between the antireflection layer and the hardcoat layer, as compared with the fluorine-containing polymer (2) where the terminal is a fluorine atom, and for this reason, the fluorine-containing polymer (1) is more preferred.

The content of the (a) leveling agent in the hardcoat layer-forming composition of the present invention must be set to an amount large enough to impart adequate leveling property and improve the coating unevenness and at the same time, sufficiently small to cause no remaining in the interface between the hardcoat layer and another layer. For this reason, the content is preferably from 0.0005 to 2.5 mass %, more preferably from 0.005 to 0.5 mass %, based on the entire solid content in the hardcoat layer-forming composition.

### [(b) Carbonic Acid Ester Solvent]

The (b) carbonic acid ester solvent contained in the hardcoat layer-forming composition of the present invention is described below.

The above-described (a) leveling agent is a fluorine-containing polymer and therefore, exhibits hydrophobicity. In the hardcoat layer-forming composition of the present invention, (b) a carbonic acid ester solvent exhibiting hydrophilicity is used as a solvent, whereby the hydrophobic (a) leveling agent can be unevenly distributed to the surface of the hardcoat layer. Furthermore, use of a carbonic acid ester solvent is expected to allow decreasing the amount of the leveling agent added.

The (b) carbonic acid ester solvent is preferably represented by the following formula (IV) or (V):

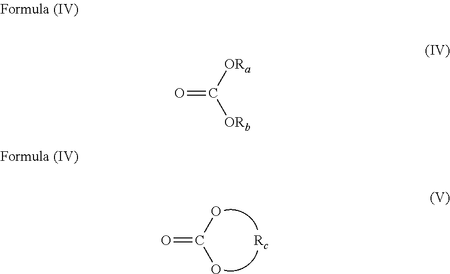

In the formulae, each of Ra and Rb independently represents an alkyl group, and Rc represents an alkylene group.

Formulae (IV) and (V) are described below.

In the formulae, each of Ra and Rb is independently, preferably an alkyl group having a carbon number of 1 to 3, and Rc is preferably an alkylene group having a carbon number of 2 or 3.

The alkyl group having a carbon number of 1 to 3 includes a methyl group, an ethyl group, an n-propyl group and an isopropyl group. Specific examples of the solvent of formula (1) include dimethyl carbonate, diethyl carbonate, di-n-propyl carbonate, diisopropyl carbonate, and an asymmetric carbonate such as methyl ethyl carbonate, methyl n-propyl carbonate and ethyl n-propyl carbonate.

The alkylene group having a carbon number of 2 or 3 includes an ethylene group and an isopropylene group. Specific examples of the solvent of formula (2) include ethylene carbonate and propylene carbonate.

The carbonate-based solvent represented by formula (IV) or (V) is a solvent capable of swelling/dissolving a cellulose acylate film in a short time and not only improves the adherence between the hardcoat layer and the cellulose acylate film but also in the case of coating the composition on a TAC (cellulose triacetate) film, for example, by a wire bar coating method or a die coating method, yields good leveling. In particular, a TAC film produced by a single-layer casting method tends to be poor in the smoothness of the film surface as compared with that produced by a multilayer co-casting method, and streaky coating unevenness or the like attributable to the planarity failure of the TAC film produced at the time of wet-coating an antiglare layer is readily generated, but when a solvent having a boiling point of 80° C. or more, preferably 85° C. or more is used, the streaky coating unevenness or the like attributable to the planarity failure is likely to be improved and this is advantage in terms of coating aptitude.

The boiling point of the carbonate-based solvent represented by formula (N) or (V) is preferably 85° C. or more and from the standpoint of enhancing the chemical resistance, is preferably 90 to 140° C.

Among the carbonate-based solvents represented by formula (IV) or (V), dimethyl carbonate and diethyl carbonate are preferred, and dimethyl carbonate is more preferred.

As for the solvent, by taking into consideration the drying property at the coating, more enhanced leveling and the like, an organic solvent except for a carbonic acid ester solvent can be used within the range causing no reduction in the adherence and leveling at the coating.

Examples of such an organic solvent include dibutyl ether, dimethoxymethane, dimethoxyethane, diethoxyethane, propylene oxide, 1,4-dioxane, 1,3-dioxolane, 1,3,5-trioxane, tetrahydrofuran, anisole, phenetole, acetone, methyl ethyl ketone(MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexane alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether (PGME), ethyl carbitol, butyl carbitol, hexane, heptane, octane, cyclohexane, methylcyclohexane, ethylcyclohexane, benzene, toluene and xylene. One of these solvents may be used alone, or two or more thereof may be used in combination.

The solvent is preferably used so that the hardcoat layer-forming composition of the present invention can have a solid content concentration of 1 to 70 mass %, more preferably from 20 to 70 mass %, and most preferably from 30 to 65 mass %. The content of the (b) carbonic acid ester solvent must be not less than the amount capable of controlling the leveling agent to sufficiently achieve its superficial distribution and also, from the standpoint of adjusting the solubility of other materials contained in the hardcoat layer for the coating solution, the content is preferably 10 mass % or more, more preferably from 10 to 70 mass %, still more preferably from 15 to 60 mass %.

### [(c) Compound Having an Unsaturated Double Bond]

The (c) compound having an unsaturated double bond contained in the hardcoat layer-forming composition of the present invention is described below.

The (c) compound having an unsaturated double bond can function as a binder and is preferably a polyfunctional monomer having two or more polymerizable unsaturated groups. The polyfunctional monomer having two or more polymerizable unsaturated groups can function as a curing agent, and its use enables enhancing the strength or scratch resistance of the coating film. The number of polymerizable unsaturated groups is more preferably 3 or more.

The (c) compound having an unsaturated double bond includes a compound having a polymerizable functional group such as (meth)acryloyl group, vinyl group, styryl group and allyl group, with (meth)acryloyl group and —C(O)OCH═CH₂ being preferred. In particular, the following compounds each containing three or more (meth)acryloyl groups within one molecule may be preferably used.

Specific examples of the compound having a polymerizable unsaturated bond include (meth)acrylic acid diesters of alkylene glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy (meth)acrylates, urethane (meth)acrylates and polyester (meth)acrylates.

Above all, esters of polyhydric alcohol and (meth)acrylic acid are preferred. Examples thereof include 1,4-butanediol di(meth)acrylate, 1,6-hexanediol di(meth)acrylate, neopentyl glycol di(meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and caprolactone-modified tris(acryloxyethyl)isocyanurate.

As the (meth)acryloyl group-containing polyfunctional acrylate-based compounds, a commercially available compound may also be used, and examples thereof include KAYARAD DPHA and KAYARAD PET-30 produced by Nippon Kayaku Co., Ltd.

The non-fluorine-containing polyfunctional monomer is described in paragraphs [0114] to [0122] of JP-A-2009-98658, and the same applies to the present invention.

The content of the (c) compound having an unsaturated double bond in the hardcoat layer-forming composition of the present invention is, in order to give a sufficiently high polymerization ratio and impart hardness and the like, preferably from 70 to 99 mass %, more preferably from 80 to 99 mass %, based on the entire solid content in the hardcoat layer-forming composition.

### [(d) Photopolymerization Initiator]

The (d) photopolymerization initiator contained in the hardcoat layer-forming composition of the present invention is described below.

Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borates, active esters, active halogens, an inorganic complex, and coumarins. Specific examples, preferred embodiments and commercial products of the photopolymerization initiator are described in paragraphs [0133] to [0151] of JP-A-2009-098658, and these can be suitably used also in the present invention.

Various examples are described also in Saishin UV Koka Gijutsu (Latest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

The content of the (d) photopolymerization initiator in the hardcoat layer-forming composition of the present invention is, for setting it to an amount sufficiently large to polymerize a polymerizable compound contained in the hardcoat layer-forming composition and at the same time, small enough to prevent an excessive increase of initiation sites, preferably from 0.5 to 8 mass %, more preferably from 1 to 5 mass %, based on the entire solid content in the hardcoat layer-forming composition.

In the hardcoat layer-forming composition of the present invention, components other than those described above may also be added. Particularly, it is preferred that the composition contains (e) a silica fine particle, because the silica fine particle is hydrophilic and therefore, enables enhancing the superficial distribution of the leveling agent and more improving the surface unevenness and scratch resistance. In addition, this particle has an effect of controlling the refractive index and an effect of suppressing the curing shrinkage due to a crosslinking reaction.

### [(e) Silica Fine Particle]

The size (primary particle diameter) of the silica fine particle is from 15 nm to less than 100 nm, preferably from 20 to 80 nm, and most preferably from 25 to 60 nm. The average particle diameter of the fine particle can be determined from an electron micrograph. If the particle diameter of the inorganic fine particle is excessively small, the effect of enhancing the superficial distribution of the leveling agent is not obtained, whereas if it is too large, fine irregularities are produced on the hardcoat layer surface and the appearance such as denseness of black or the integrated reflectivity may be deteriorated. The silica fine particle may be crystalline or amorphous and may be a monodisperse particle or may be even an aggregate particle as long as the predetermined particle diameter is satisfied. The shape is most preferably spherical, but there is no problem even when the particle has a shape that is not spherical, for example, an indefinite shape. Also, two or more kinds of silica fine particles differing in the average particle size may be used in combination.

The silica fine particle which can be used in the present invention may be subjected to a surface treatment so as to enhance the dispersibility in the coating solution or increase the film strength, and specific examples and preferred examples of the surface treatment method are the same as those described in paragraphs [0119] to of JP-A-2007-298974.

Specific preferred examples of the silica fine particle include MiBK-ST, MiBK-SD (both silica sol having an average particle diameter of 15 nm, produced by Nissan Chemical Industries, Ltd.) and MEK-ST-L (silica sol having an average particle diameter of 50 nm, produced by Nissan Chemical Industries, Ltd.).

### [Electrically Conductive Compound]

The hardcoat layer of the optical film of the present invention may contain an electrically conductive compound so as to impart antistatic property. In particular, when an electrically conductive compound having hydrophilicity is used, the superficial distribution of the leveling agent can be enhanced and the surface unevenness and scratch resistance can be more improved. In order to impart hydrophilicity to the electrically conductive compound, a hydrophilic group may be introduced into the electrically conductive compound, and from the standpoint of developing high electrical conductivity and being relatively inexpensive, the hydrophilic group preferably contains a cationic group, more preferably a quaternary ammonium salt group.

The electrically conductive compound for use in the present invention is not particularly limited but includes an ionically conductive compound and an electronically conductive compound. The ionically conductive compound includes, for example, cationic, anionic, nonionic and amphoteric conductive compounds. The electronically conductive compound includes an electronically conductive compound which is an unconjugated or conjugated polymer where aromatic carbon rings or aromatic heterocyclic rings are connected through a single bond or a divalent or higher valent linking group. Among these, a compound having a quaternary ammonium salt group (cationic compound) is preferred because this compound has high antistatic performance, is relatively inexpensive and is unevenly distributed in the substrate-side region.

The compound having a quaternary ammonium salt group may be either a low molecular type or a polymer type, but a polymer-type cationic antistatic agent is more preferably used, because the antistatic property is prevented from fluctuating due to bleed-out or the like. The polymer-type cationic compound having a quaternary ammonium salt group may be appropriately selected from known compounds but in view of uneven distribution to the substrate-side region, a polymer having at least one unit out of structural units represented by the following formulae (1) to (III) is preferred.

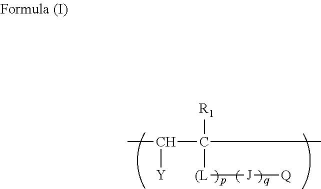

In formula (I), R₁ represents a hydrogen atom, an alkyl group, a halogen atom or —CH₂COO⁻M⁺, Y represents a hydrogen atom or —COO⁻M⁺, M⁺ represents a proton or a cation, L represents —CONH—, —COO—, —CO— or —O—, J represents an alkylene group or an arylene group, and Q represents a group selected from Group A shown below.

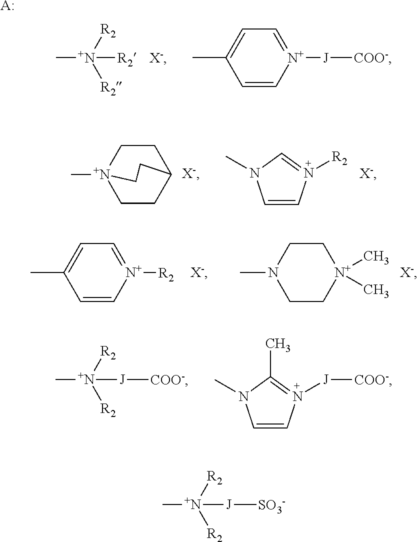

In the formulae, each of R₂, R₂′ and R₂″ independently represents an alkyl group, J represents an alkylene group or an arylene group, X⁻ represents an anion, and each of p and q independently represents 0 or 1.

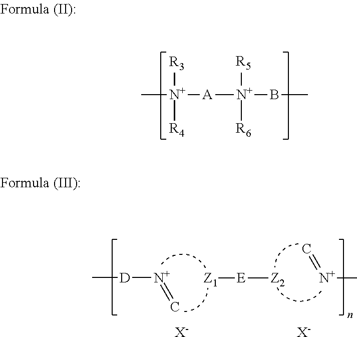

In formulae (II) and (III), each of R₃, R₄, R₅ and R₆ independently represents an alkyl group, each of the pair R₃ and R₄ and the pair R₅ and R₆ may combine together to from a nitrogen-containing heterocyclic ring, each of A, B and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—, E represents a single bond, an alkylene group, an arylene group, an alkenylene group, an arylenealkylene group, —R₉COOR₁₀OCOR₁₁—, —R₁₂OCR₁₃COOR₁₄—, —R₁₅—(OR₁₆)ₘ—, —R₁₂CONHR₁₈NHCOR₁₉—, —R₂₀OCONHR₂₁NHCOR₂₂—, —R₂₃NHCONHR₂₄NHCONHR₂₅— or —NHCOR₂₆CONH—, each of R₇, R₈, R₉, R₁₁, R₁₂, R₁₄, R₁₅, R₁₆, R₁₇, R₁₉, R₂₀, R₂₂, R₂₃, R₂₅ and R₂₆ represents an alkylene group, each of R₁₀, R₁₃, R₁₈, R₂₁ and R₂₄ independently represents a linking group selected from an alkylene group, an alkenylene group, an arylene group, an arylenealkylene group and alkylenearylene group, m represents a positive integer of 1 to 4, X⁻ represents an anion, each of Z₁ and Z₂ represents a nonmetallic atom group necessary for forming a 5- or 6-membered ring together with the —N═C— group and may combine with E in the form of a quaternary salt ≡N⁺[X]—, and n represents an integer of 5 to 300.

The groups in formulae (1) to (III) are described below.

The halogen atom includes a chlorine atom and a bromine atom and is preferably a chlorine atom. The alkyl group is preferably a branched or linear alkyl group having a carbon number of 1 to 4, more preferably a methyl group, an ethyl group or a propyl group. The alkylene group is preferably an alkylene group having a carbon number of 1 to 12, more preferably a methylene group, an ethylene group or a propylene group, still more preferably an ethylene group. The arylene group is preferably an arylene group having a carbon number of 6 to 15, more preferably a phenylene group, a diphenylene group, a phenylmethylene group, a phenyldimethylene group or a naphthylene group, still more preferably a phenylmethylene group. These groups may have a substituent. The alkenylene group is preferably an alkylene group having a carbon number of 2 to 10, the arylenealkylene group is preferably an arylenealkylene group having a carbon number of 6 to 12, and these groups may have a substituent. Examples of the substituent which may be substituted on each group include a methyl group, an ethyl group and a propyl group.

In formula (1), R₁ is preferably a hydrogen atom.

Y is preferably a hydrogen atom.

J is preferably a phenylmethylene group.

Q is preferably a group represented by the following formula (VI) selected from Group A, wherein each of R₂, R₂′ and R₂″ is a methyl group.

X⁻ includes, for example, a halogen ion, a sulfonate anion and a carboxylate anion and is preferably a halogen ion, more preferably chloride ion. Each of p and q is preferably 0 or 1, more preferably p=0 and q=1.

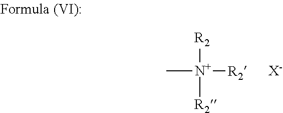

In formulae (II) and (III), each of R₃, R₄, R₅ and R₆ is preferably a substituted or unsubstituted alkyl group having a carbon number of 1 to 4, more preferably a methyl group or an ethyl group, still more preferably a methyl group. Each of A, B and D independently represents preferably a substituted or unsubstituted alkylene group having a carbon number of 2 to 10, an arylene group, an alkenylene group or an arylenealkylene group and is preferably a phenyldimethylene group.

X⁻ includes, for example, a halogen ion, a sulfonate anion and a carboxylate anion and is preferably a halogen ion, more preferably chloride ion.

E preferably represents a single bond, an alkylene group, an arylene group, an alkenylene group or an arylenealkylene group. Examples of the 5- or 6-membered ring formed by Z₁ or Z₂ together with the —N═C— group include a diazoniabicyclooctane ring.

Specific examples of the compound having a unit with a structure represented by formulae (I) to (III) are illustrated below, but the present invention is not limited thereto. Out of suffixes (m, x, y, r and actual numerical values) in specific examples, m indicates the number of repeating units in each unit, and x, y and r indicate the molar ratio of respective units.

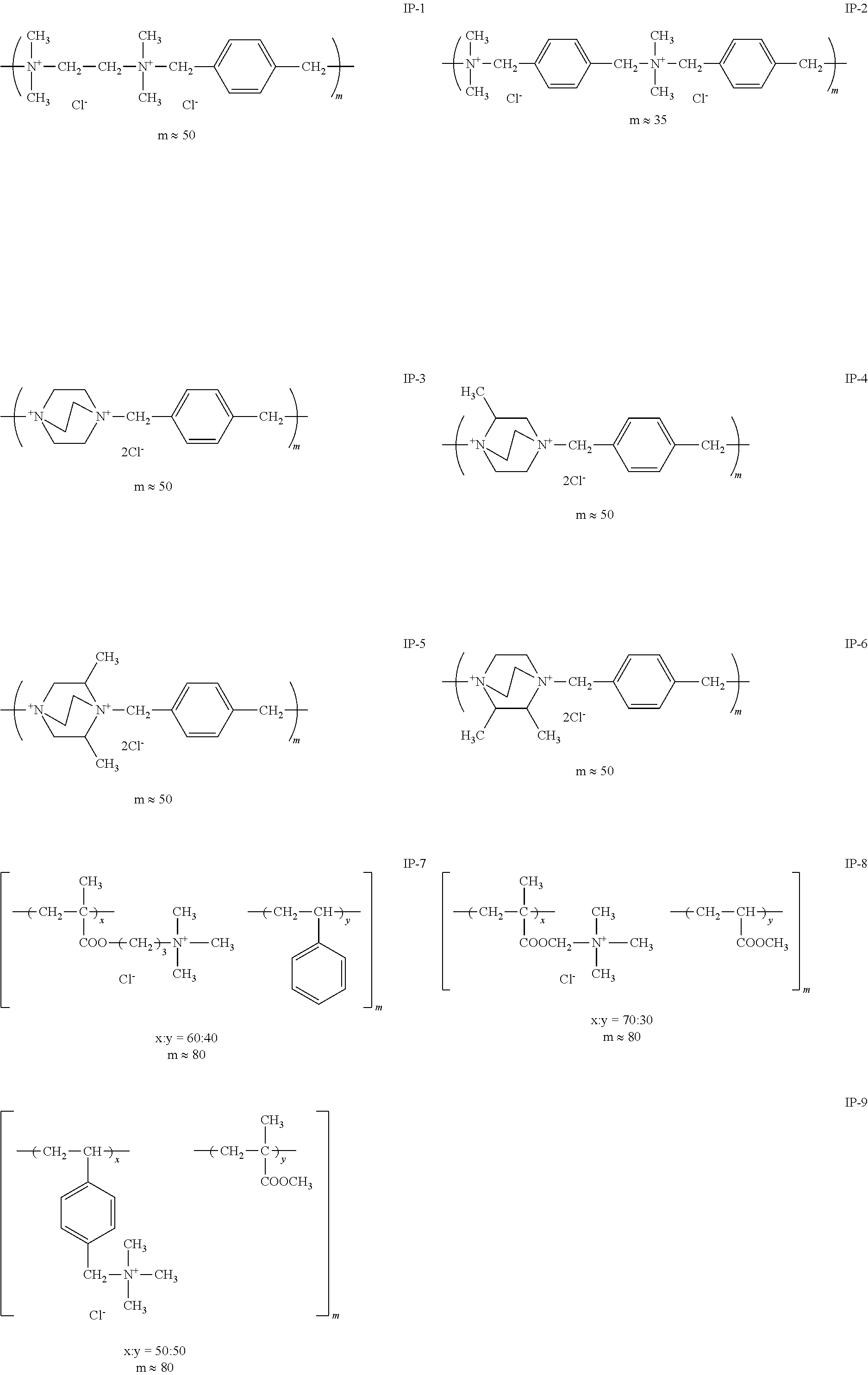

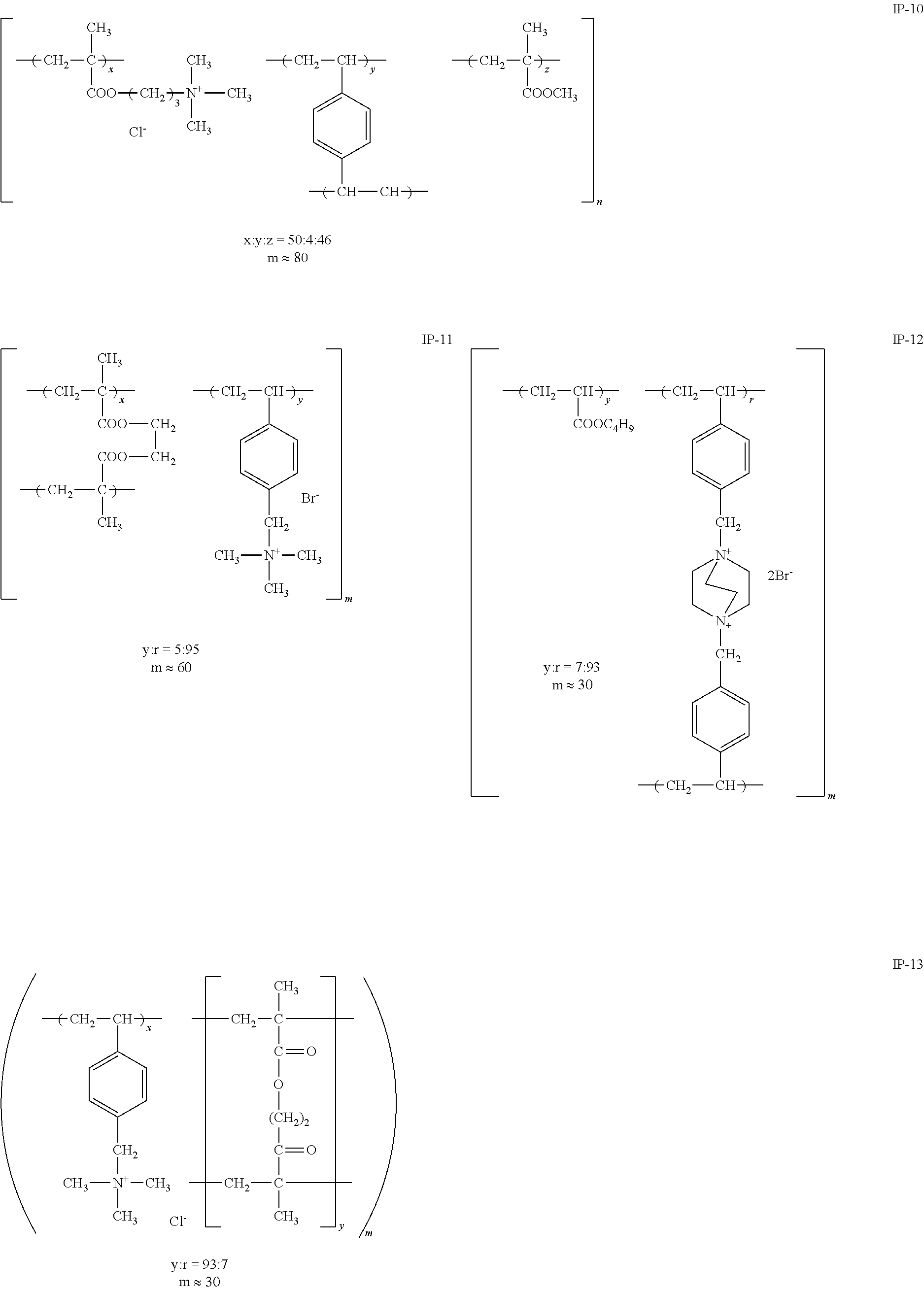

One of these electrically conductive compounds illustrated above may be used alone, or two or more kinds of compounds may be used in combination. The antistatic compound having a polymerizable group in the molecule of the antistatic agent can increase also the scratch resistance (film strength) of the antistatic layer and therefore, is preferred.

The electronically conductive compound is preferably an unconjugated or conjugated polymer where aromatic carbon rings or aromatic heterocyclic rings are connected through a single bond or a divalent or higher valent linking group. Examples of the aromatic carbon ring in the unconjugated or conjugated polymer include a benzene ring, and the ring may further form a condensed ring. Examples of the heterocyclic ring in the unconjugated or conjugated polymer include a pyridine ring, a pyrazine ring, a pyrimidine ring, a pyridazine ring, a triazine ring, an oxazole ring, a thiazole ring, an imidazole ring, an oxadiazole ring, thiadiazole ring, a triazole ring, a tetrazole ring, a furan ring, a thiophene ring, a pyrrole ring, an indole ring, a carbaiole ring, a benzimidazole ring and an imidazopyridine ring. Each of there rings may further form a condensed ring and may have a substituent.

The divalent or higher valent linking group in the unconjugated or conjugated polymer includes a linking group formed by a carbon atom, a silicon atom, a nitrogen atom, a boron atom, an oxygen atom, a sulfur atom, a metal, a metal ion or the like and is preferably a group formed by a carbon atom, a nitrogen atom, a silicon atom, a boron atom, an oxygen atom, a sulfur atom or a combination thereof. Examples of the group formed by the combination include substituted or unsubstituted methylene, carbonyl, imino, sulfonyl, sulfinyl, ester, amide and silyl groups.

Specific examples of the electronically conductive compound include substituted or unsubstituted electrically conductive polyaniline, polyparaphenylene, polyparaphenylenevinylene, polythiophene, polyfuran, polypyrrole, polyselenophene, polyisothianaphthene, polyphenylene sulfide, polyacetylene, polypyridylvinylene and polyazine, and derivatives thereof. One of these compounds may be used alone, or two or more thereof may be used in combination according to the purpose.

As long as the desired electrical conductivity is achieved, a mixture with another polymer having no electrical conductivity may also be used, and a copolymer of a monomer capable of constituting an electrically conductive polymer and another monomer having no electrical conductivity may also be used.

The electronically conductive compound is preferably a conjugated polymer. Examples of the conjugated polymer include polyacetylene, polydiacetylene, poly(paraphenylene), polyfluorene, polyazulene, poly(paraphenylene sulfide), polypyrrole, polythiophene, polyisothianaphthene, polyaniline, poly(paraphenylenevinylene), poly(2,5-thienylenevinylene), a multichain conjugated polymer (e.g., polyperinaphthalene), a metal phthalocyanine-based polymer, other conjugated polymers (e.g., poly(paraxylylene), poly[α-(5,5′-bithiophenediyl)benzylidene]), and derivatives thereof.

Poly(paraphenylene), polypyrrole, polythiophene, polyaniline, poly(paraphenylenevinylene) and poly(2,5-thienylenevinylene) are preferred, polythiophene, polyaniline, polypyrrole and derivatives thereof are more preferred, and at least either polythiophene or a derivative thereof is still more preferred.

Specific examples of the electronically conductive compound are illustrated below, but the present invention is not limited thereto. In addition, compounds described, for example, in International Publication No. 98/01909 may also be used.

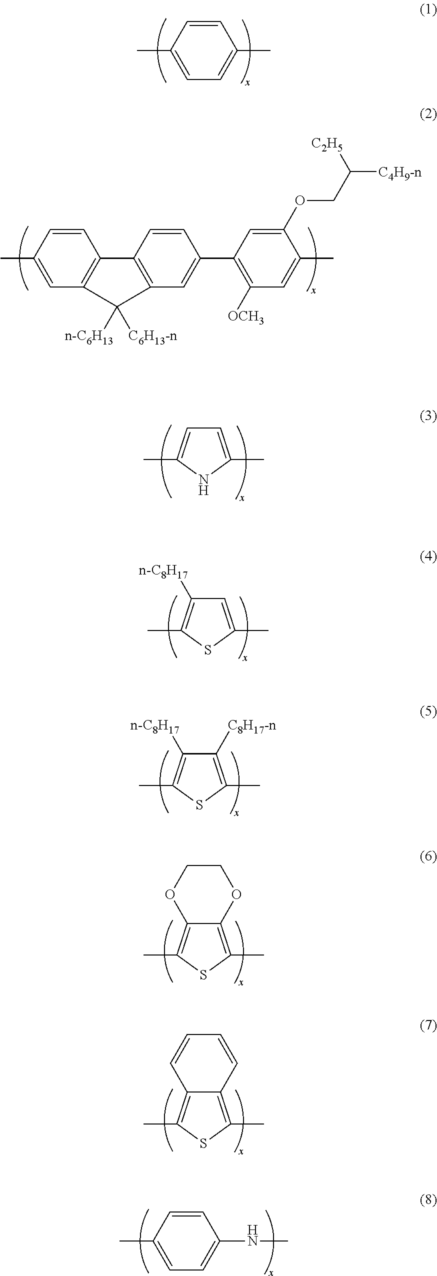

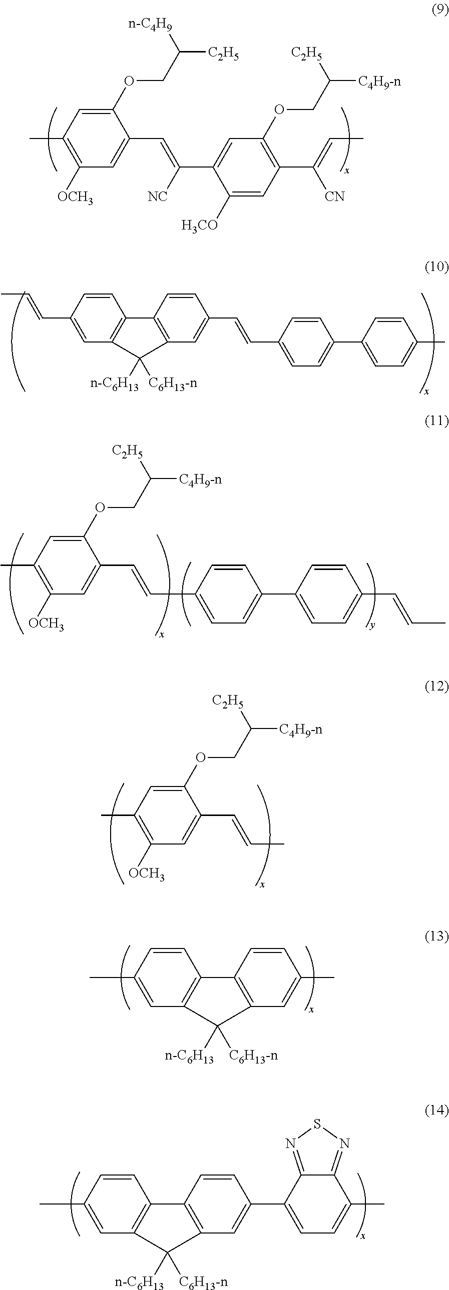

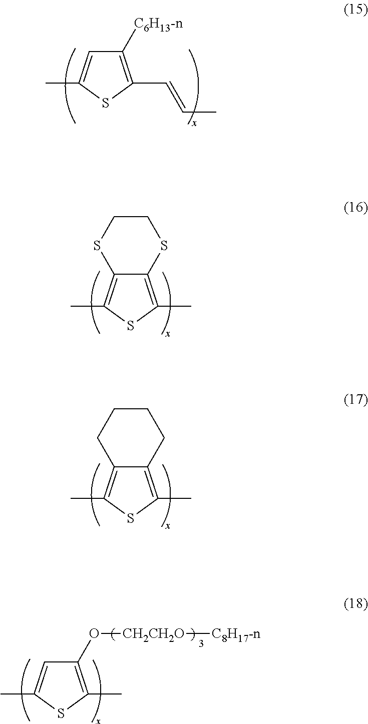

The mass average molecular weight of the electronically conductive compound for use in the present invention is preferably from 1,000 to 1,000,000, more preferably from 10,000 to 500,000, still more preferably from 10,000 to 100,000. The mass average molecular weight as used herein is a mass average molecular weight in terms of polystyrene as measured by gel permeation chromatography.

The electronically conductive compound for use in the present invention is preferably soluble in an organic solvent in view of coatability and imparting affinity for other components. The term “soluble” as used herein means that the compound is dissolved in a single molecule state or in a state of a plurality of single molecules being associated or is dispersed in a state of particles having a particle diameter of 300 nm or less.

The electronically conductive compound generally dissolves in a solvent mainly composed of water and therefore, the compound has hydrophilicity, but in order to solubilize the electronically conductive compound in an organic solvent, for example, a compound (e.g., solubilization aid) capable of increasing the affinity for the organic solvent or a dispersant in the organic solvent is added to the composition containing the electronically conductive compound. Alternatively, a hydrophobed polyanion dopant is used, whereby the compound can be solubilized in an organic solvent. By such a method, the electronically conductive compound can be made soluble also in the organic solvent used in the present invention, but the compound still has hydrophilicity and therefore, when the method of the present invention is applied, the electrically conductive compound can be unevenly distributed.

In the case of using the compound having a quaternary ammonium salt group as the electrically conductive compound, the nitrogen or sulfur atomic weight on the antistatic layer surface side as measured by elemental analysis (ESCA) is preferably from 0.5 to 5 mol %. Within this range, good antistatic property is easily obtained. The atomic weight is more preferably from 0.5 to 3.5 mol %, still more preferably from 0.5 to 2.5 mol %.

The hardcoat layer of the present invention may further contain other additives. Examples of the additive which can be further contained include, for the purpose of suppressing decomposition of the polymer, an ultraviolet absorber, a phosphorous acid ester, a hydroxamic acid, hydroxyamine, imidazole, hydroquinone and phthalic acid; for the purpose of increasing the film strength, an inorganic fine particle, a polymer fine particle and a silane coupling agent; for the purpose of decreasing the refractive index to increase the transparency, a fluorine-based compound (particularly, a fluorine-containing surfactant); and for the purpose of imparting internal scattering, a matting particle.

### [Optical Film]

The optical film of the present invention has a hardcoat layer formed using the above-described hardcoat layer-forming composition on a transparent substrate.

The optical film of the present invention has a hardcoat layer on a transparent substrate and, if desired, one functional layer required may be provided or a plurality of functional layers required may be provided. For example, an antireflection layer (a layer having an adjusted refractive index, such as low refractive index layer, medium refractive index layer and high refractive index layer) or an antiglare layer may be provided.

Specific examples of the layer configuration for the optical film of the present invention are shown below.

Transparent substrate/hardcoat layer

Transparent substrate/hardcoat layer/low refractive index layer

Transparent substrate/hardcoat layer/high refractive index layer/low refractive index layer

Transparent substrate/hardcoat layer/medium refractive index layer/high refractive index layer/low refractive index layer

Transparent substrate/hardcoat layer/antiglare layer

The optical film of the present invention has a hardcoat layer formed of the hardcoat layer-forming composition on a transparent substrate and in the hardcoat layer, the (a) leveling agent is present by being unevenly distributed to the hardcoat layer surface side (the interface side opposite the transparent substrate). Thanks to the presence of the (a) leveling agent in the hardcoat layer surface side, the surface state of the hardcoat layer can be improved. Also, in the case of stacking another layer on the hardcoat layer, the (a) leveling agent present on the hardcoat layer surface side is swiftly extracted by the another layer and scarcely remains in the hardcoat layer/another layer interface, so that the adherence of the hardcoat layer to the another layer can also be enhanced.

The expression “the (a) leveling layer is present by being unevenly distributed to the hardcoat layer surface side (the interface side opposite the transparent substrate)” as used in the present invention indicates that the fluoroaliphatic group of the leveling agent is adsorbed to the outermost surface of the hardcoat layer, and the degree of uneven distribution can be estimated by preparing a hardcoat layer using the composition while varying the amount of the leveling agent added, and measuring the surface free energy on the hardcoat layer surface. When the amount of the leveling agent added is increased, the surface free energy is decreased and saturated with time, and it can be presumed that as the amount added of the leveling agent required until reaching the saturation value is smaller, the uneven distribution is better. When a carbonic acid ester solvent is used, the leveling agent exhibits excellent uneven distribution as compared with other solvents and therefore, the amount added of the leveling agent required until the surface free energy reaches the saturation value can be reduced. Incidentally, the surface free energy of the hardcoat layer can be calculated using the Owens equation described in D. K. Owens and R. C. Wendt, J. Appl. Phys. Sci., 13, 1741-1747 (1969) after measuring the contact angle of the hardcoat layer surface for a plurality of kinds of standard solutions. As the standard solution, water and methylene iodide are preferably used.

In the present specification, the fact “in the case of stacking another layer on the hardcoat layer, the (a) leveling agent present on the hardcoat layer surface side is swiftly extracted by the another layer” can be estimated by dipping an optical film in which only a hardcoat layer is formed, in a solvent used in the coating solution for formation of the adjacent antireflection layer and after removing the eluted material, analyzing the surface by X-ray photoelectric analyzer (ESCA) to measure the amount of fluorine atom. More specifically, the value of F/C which is a ratio of the amount of fluorine atom to the amount of carbon atom can be used, and as the F/C is smaller, the leveling agent can be expected to less remain in the hardcoat layer-another layer interface when another layer is stacked on the hardcoat layer.

### [Transparent Substrate]

For the optical film of the present invention, various transparent substrates (support) can be used, but a substrate containing a cellulose-based polymer is preferred, and it is more preferred to use a cellulose acylate film.

The cellulose acylate film is not particularly limited, but in the case of disposing it in a display, a cellulose triacetate film can be directly used as a protective film for protecting a polarizing layer of a polarizing plate and therefore, a cellulose triacetate film is preferred in view of productivity and cost.

The thickness of the cellulose acylate film is usually on the order of 25 to 1,000 μm but is preferably from 40 to 200 μm where good handleability and required substrate strength are obtained.

In the present invention, a cellulose acetate having an acetylation degree of 59.0 to 61.5% is preferably used for the cellulose acylate film. The acetylation degree means the amount of acetic acid bonded per unit mass of cellulose. The acetylation degree is determined according to the measurement and calculation of acetylation degree described in ASTM: D-817-91 (Test Method of Cellulose Acetate, etc.). The viscosity average polymerization degree (DP) of the cellulose acylate is preferably 250 or more, more preferably 290 or more.

Also, in the cellulose acylate for use in the present invention, the Mw/Mn (Mw is the mass average molecular weight and Mn is the number average molecular weight) value by gel permeation chromatography is preferably close to 1.0, in other words, the molecular weight distribution is preferably narrow. Specifically, the Mw/Mn value is preferably from 1.0 to 1.7, more preferably from 1.3 to 1.65, and most preferably from 1.4 to 1.6.

In general, the hydroxyl groups at the 2-, 3- and 6-positions of the cellulose acylate are not distributed equally, each 1/3 of the entire substitution degree, but the substitution degree of 6-position hydroxyl group tends to be small. In the present invention, the substitution degree of 6-position hydroxyl group of the cellulose acylate is preferably large as compared with the 2- or 3-position.

The hydroxyl group at the 6-position is preferably substituted with an acyl group in a ratio of 32% or more, more preferably 33% or more, still more preferably 34% or more, based on the entire substitution degree. Furthermore, the substitution degree for the 6-position acyl group of cellulose acylate is preferably 0.88 or more. The 6-position hydroxyl group may be substituted, in addition to the acetyl group, with an acyl group having a carbon number of 3 or more, such as propionyl group, butyroyl group, valeroyl group, benzoyl group and acryloyl group. The substitution degree at each position can be determined by NMR.

In the present invention, a cellulose acetate obtained by methods described in Examples of JP-A-11-5851, that is, Synthesis Example 1 in paragraphs 0043 and 0044, Synthesis Example 2 in paragraphs 0048 and 0049, and Synthesis Example 3 in paragraph 0051 and 0052, can be used as the cellulose acylate.

### [Physical Properties of Hardcoat Layer]

In view of the optical design for obtaining an antireflection performance, the refractive index of the hardcoat layer in the present invention is preferably from 1.48 to 1.65, more preferably from 1.48 to 1.60, and most preferably from 1.48 to 1.55.

From the standpoint of imparting sufficient durability and impact resistance to the film, the thickness of the hardcoat layer is from 0.5 to 20 μm, preferably from 1 to 10 μm, more preferably 1 to 5 μm.

The strength of the hardcoat layer is preferably H or more, more preferably 2H or more, and most preferably 3H or more, in the pencil hardness test. Furthermore, in the Taber test according to JIS K5400, the abrasion loss of the specimen between before and after test is preferably smaller.

### [Antireflection Layer]

### (Low Refractive Index Layer)

The optical film of the present invention preferably has a low refractive index layer on the hardcoat layer directly or through another layer. In this case, the optical film of the present invention can function as an antireflection film.

In the case of providing the low refractive index layer directly on the hardcoat layer, the low refractive layer is preferably a thin-film layer having a thickness of 200 nm or less. Furthermore, the low refractive index may be formed to, in terms of optical layer thickness, a thickness of about ¼ of the designed wavelength. However, in the case of one-layer thin-film interference type of effecting antireflection by one layer of the low refractive index layer, which is a simplest configuration, there is no practical low refractive index material satisfying a reflectance of 0.5% or less and having a neutral tint and high scratch resistance, chemical resistance and weather resistance. Therefore, when more reduction in reflection is required, this may be responded to by fabricating a multilayer thin-film interference-type antireflection film of preventing reflection by optical interference of multiple layers, such as two-layer thin-film interference type of forming a high refractive index layer between the hardcoat layer and the low refractive index layer or three-layer thin-film interference type of forming a medium refractive index layer and a high refractive index layer in order between the hardcoat layer and the low refractive index layer.

In this case, the refractive index of the low refractive index layer is preferably from 1.30 to 1.51, more preferably from 1.30 to 1.46, still more preferably from 1.32 to 1.38. The refractive index in this range is preferred, because the reflectance can be reduced and the film strength can be maintained. As for the method of forming the low refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating using a composition for the low refractive index layer is preferably employed.

The low refractive index layer is not particularly limited as long as it is a layer having a refractive index in the range above, but as for the constituent components, known components can be used and specifically, a composition containing a fluorine-containing curable resin and an inorganic fine particle described in JP-A-2007-298974, and a hollow silica fine particle-containing low refractive index coating described in JP-A-2002-317152, JP-A-2003-202406 and JP-A-2003-292831 may be suitably used.

### (High Refractive Index Layer and Medium Refractive Index Layer)

The refractive index of the high refractive index layer is preferably from 1.65 to 2.20, more preferably from 1.70 to 1.80. The refractive index of the medium refractive index layer is adjusted to have a value between the refractive index of the low refractive index layer and the refractive index of the high refractive index layer. The refractive index of the medium refractive index layer is preferably from 1.55 to 1.65, more preferably from 1.58 to 1.63.

As for the method of forming the high refractive index layer and the medium refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating is preferred.

The medium refractive index layer and high refractive index layer are not particularly limited as long as they are a layer having a refractive index in the range above, but as for the constituent components, known components can be used and these are specifically described in paragraphs [0074] to [0094] of JP-A-2008-262187.

### (Antiglare Layer)

In the present invention, separately from the above-described antistatic layer, an antiglare layer may be formed so that antiglare property due to surface scattering and preferably hardcoat property for enhancing the hardness and scratch resistance of the film can be imparted to the film.

The antiglare layer is described in paragraphs [0178] to [0189] of JP-A-2009-98658 and the same applies to the present invention.

A particularly preferred embodiment of the optical film of the present invention is an optical film having a hardcoat layer and an antireflection layer on a cellulose acylate film substrate, wherein a region allowing the substrate component and the hardcoat layer component to be mixed is present in the interface of the cellulose acylate film substrate with the hardcoat layer, the antireflection layer contains a leveling agent that is the fluorine-containing polymer (1), and the leveling agent is not present in the interface between the hardcoat layer and the antireflection layer.

Here, the hardcoat layer indicates the entire portion containing the hardcoat layer component, and the substrate indicates the portion not containing the hardcoat layer component.

In the optical film of the present invention, a region allowing the substrate component and the hardcoat layer component to be mixed is present. Thanks to the mixing of respective components, the adherence between the substrate and the hardcoat layer is enhanced. The thickness of the region allowing the substrate component and the hardcoat layer component to be mixed is preferably from 5 to 99%, more preferably from 15 to 98%, and most preferably from 30 to 95%, based on the thickness of the entire hardcoat layer. If the thickness of the region allowing for mixing is less than 5%, the adherence between the substrate and the hardcoat layer is insufficient, whereas if it is 100%, the substrate component is exposed to the outermost surface of the hardcoat layer and this inhibits the adherence to the antireflection layer.

When the film is sliced with a microtome and the cross-section is analyzed by time-of-flight secondary ion mass spectrometry (TOF-SIMS), the region allowing for mixing can be determined as a portion where both the substrate component and the hardcoat layer component are detected. The film thickness of this region can also be measured using the cross-sectional information of TOF-SIMS.

The abundance of the leveling agent remaining in the interface between the hardcoat layer and the antireflection layer can be examined as the amount of the leveling agent remaining in the range from the surface to 5 nm of the hardcoat layer. An optical film after forming only a hardcoat layer is dipped in a solvent used in the coating solution for antireflection layer formation and after removing the eluted material, the surface is analyzed by X-ray photoelectric analyzer (ESCA) to measure the amount of fluorine atom, whereby the abundance can be estimated. When the uneven distribution of the leveling agent in the hardcoat layer is successful, the leveling agent is swiftly extracted by the solvent and the fluorine atom is not detected, whereas if the uneven distribution is unsuccessful, fluorine atom is detected on the surface due to difficulty of extraction and also bleed-out from the inside after dipping.

With regard to the amount of the leveling agent, the value obtained by dividing the amount of fluorine atom by the amount of carbon atom, which is detected by the method above, is preferably 0.5 or less, more preferably 0.2 or less. By satisfying this condition, bonding of the hardcoat layer to the antireflection layer can be intensified to enhance the scratch resistance.

When the leveling agent is not present in the interface between the hardcoat layer and the antireflection layer, this indicates that the value obtained by dividing the amount of fluorine atom detected by the method above by the amount of carbon atom (F/C) is 0.2 or less.

### (Production Method of Optical Film)

The optical film of the present invention can be formed by the following method, but the production method is not limited to this method.

First, a composition for hardcoat layer formation is prepared. Next, the composition is coated on a transparent support by a dip coating method, an air knife coating method, a curtain coating method, a roller coating method, a wire bar coating method, a gravure coating method, a die coating method or the like and heated/dried. A microgravure coating method, a wire bar coating method and a die coating method (see, U.S. Pat. No. 2,681,294 and JP-A-2006-122889) are preferred, and a die coating method is more preferred.

After coating, the coating is dried and the layer formed of the composition for hardcoat layer formation is cured by irradiating light, whereby a hardcoat layer is formed. If desired, it is also possible to previously provide another layer on the transparent substrate and form the hardcoat layer thereon. In this way, the optical film of the present invention is obtained. As described above, another layer may also be provided, if desired. In the production method of the optical film of the present invention, a plurality of layers may be coated simultaneously or may be coated in sequence.

A particularly preferred embodiment of the method for producing an optical film of the present invention is a method for producing an optical film having a hardcoat layer and an antireflection layer on a cellulose acylate film substrate, comprising coating and curing the hardcoat layer-forming composition on the substrate to form a hardcoat layer, and further coating and curing a curable composition containing the following (0, (g) and (h) on the hardcoat layer to form an antireflection film:

(f) a compound having an unsaturated double bond,

(g) a hollow silica fine particle, and

(h) a photopolymerization initiator.

### (f) Compound Having an Unsaturated Double Bond

In the present invention, a compound having an unsaturated double bond can be caused to function as a binder of the antireflection layer. The compound having an unsaturated double bond is not particularly limited but in view of reducing the refractive index, a fluorine-containing compound is preferably used. The fluorine-containing compound may be a polymer or a low molecular compound.

### (Fluorine-Containing Polymer Having a Polymerizable Unsaturated Group)

The fluorine-containing polymer having a polymerizable unsaturated group is preferably obtained by polymerizing at least one kind of a fluorine-containing vinyl monomer.

Examples of the fluorine-containing vinyl monomer include fluoroolefins (e.g., fluoroethylene, vinylidene fluoride, tetrafluoroethylene, hexafluoropropylene), partially or completely fluorinated alkyl ester derivatives of (meth)acrylic acid (e.g., Viscoat 6FM (trade name, produced by Osaka Organic Chemical Industry Ltd.), R-2020 (trade name, produced by Daikin Industries), and completely or partially fluorinated vinyl ethers. Among these, perfluoroolefins are preferred and in view of refractive index, solubility, transparency, availability and the like, hexafluoropropylene is more preferred. When the compositional ratio of the fluorine-containing vinyl monomer is increased, the refractive index can be reduced, but the film strength is impaired. In the present invention, the fluorine-containing vinyl monomer is preferably introduced so that the fluorine content of the copolymer becomes from 20 to 60 mass %, more preferably from 25 to 55 mass %, still more preferably from 30 to 50 mass %.

In order to impart crosslinking reactivity with the fluorine-containing vinyl monomer, a copolymer with a unit indicated by the following (A1), (B1) or (C1) can be preferably used.

### (A 1):

A constituent unit obtained by polymerizing a monomer previously having a self-crosslinkable functional group in the molecule, such as glycidyl (meth)acrylate and glycidyl vinyl ether.

### (B1):

A constituent unit obtained by polymerizing a monomer having a carboxyl group, a hydroxyl group, an amino group, a sulfo group or the like (for example, (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid).

### (C1):

A constituent unit obtained by allowing a compound having a group capable of reacting with the functional group of (A1) or (B1) into the molecule and separately having a crosslinkable functional group to react with the constituting unit of (A1) or (B1) (for example, a constituent unit which can be synthesized by a method of causing an acrylic acid chloride to act on a hydroxyl group, or the like method).

In the constituent unit of (C1), the crosslinkable functional group is preferably a photopolymerizable group. Examples of the photopolymerizable group include a (meth)acryloyl group, an alkenyl group, a cinnamoyl group, a cinnamylideneacetyl group, a benzalacetophenone group, a styrylpyridine group, an α-phenylmaleimide group, a phenylazide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group. Not only one of these groups but also two or more thereof may be used. Among these, a (meth)acryloyl group and a cinnamoyl group are preferred, and a (meth)acryloyl group is more preferred.

Specific examples of the method for preparing the photopolymerizable group-containing copolymer include, but are not limited to, the following four methods.
A method of performing esterification by reacting a (meth)acrylic acid chloride with a crosslinkable functional group-containing copolymer containing a hydroxyl group.
A method of performing urethanation by reacting an isocyanate group-containing (meth)acrylic acid ester with a crosslinkable functional group-containing copolymer containing a hydroxyl group.
A method of performing esterification by reacting a (meth)acrylic acid with a crosslinkable functional group-containing copolymer containing an epoxy group.
A method of performing esterification by reacting an epoxy group-containing (meth)acrylic acid ester with a crosslinkable functional group-containing copolymer containing a carboxyl group.

The amount of the photopolymerizable group introduced can be arbitrarily controlled and from the standpoint of, for example, enhancing the stability of coating film surface state, reducing the surface state failure when an inorganic particle is present together, or increasing the film strength, it is also preferred to allow a carboxyl group, a hydroxyl group or the like to remain in a given amount.

In the copolymer useful for the present invention, in addition to the repeating unit derived from the fluorine-containing vinyl monomer and the repeating unit having a (meth)acryloyl group in the side chain, other vinyl monomers may be appropriately copolymerized from various viewpoints such as adherence to substrate, Tg (contributing to film hardness) of polymer, solubility in solvent, transparency, slipperiness and antidust/antifouling property. A plurality of these vinyl monomers may be combined according to the purposes, and these monomers are preferably introduced in a total amount of 0 to 65 mol %, more preferably from 0 to 40 mol %, still more preferably from 0 to 30 mol %, based on the copolymer.

The vinyl monomer unit which can be used in combination is not particularly limited, and examples thereof include olefins (e.g., ethylene, propylene, isoprene, vinyl chloride, vinylidene chloride), acrylic acid esters (e.g., methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethylstyrene, p-methoxystyrene), vinyl ethers (e.g., methyl vinyl ether, ethyl vinyl ether, cyclohexyl vinyl ether, hydroxyethyl vinyl ether, hydroxybutyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethylacrylamide, N-tert-butylacrylamide, N-cyclohexylacrylamide), methacrylamides (e.g., N,N-dimethylmethacrylamide), and acrylonitrile.

The fluorine-containing polymer particularly useful in the present invention is a random copolymer of perfluoroolefin with vinyl ethers or vinyl esters. In particular, the fluorine-containing polymer preferably has a group capable of undergoing a crosslinking reaction by itself (for example, a radical reactive group such as (meth)acryloyl group, or a ring-opening polymerizable group such as epoxy group and oxetanyl group). The crosslinking reactive group-containing polymerization unit preferably occupies from 5 to 70 mol %, more preferably from 30 to 60 mol %, in all polymerization units of the polymer. Preferred examples of the polymer include those described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462.

For the purpose of imparting the antifouling property and scratch resistance, a polysiloxane structure may be introduced into the fluorine-containing polymer of the present invention. The method for introducing the polysiloxane structure is not limited, but preferred examples thereof include a method of introducing a polysiloxane block copolymerization component by using a silicone macroazo initiator described in JP-A-6-93100, JP-A-11-189621, JP-A-11-228631 and JP-A-2000-313709; and a method of introducing a polysiloxane graft copolymerization component by using a silicone macromer described in JP-A-2-251555 and JP-A-2-308806. Particularly preferred compounds include the polymers in Examples 1, 2, and 3 of JP-A-11-189621, and Copolymers A-2 and A-3 of JP-A-2-251555. The content of the polysiloxane component in the polymer is preferably from 0.5 to 10 mass %, more preferably from 1 to 5 mass %.

The molecular weight of the fluorine-containing copolymer having a polymerizable unsaturated group is, in terms of the mass average molecular weight, preferably from 5,000 to less than 500,000, more preferably from 10,000 or less than 500,000, still more preferably from 15,000 to less than 200,000, and most preferably from 15,000 to less than 100,000. When the mass average molecular weight is 5,000 or more, this is preferred because the coating property is excellent and repellence or unevenness (in-plane variability in the film thickness of the coated film) is less likely to occur. Furthermore, when the mass average molecular weight is less than 500,000, excellent solubility in the solvent is advantageously ensured.

In addition, when polymers differing in the average molecular weight are used in combination as the fluorine-containing copolymer having a polymerizable unsaturated group, the surface state of coated film or the scratch resistance can also be improved.

### (Polyfunctional Monomer Having a Polymerizable Unsaturated Group)

In the present invention, the compound having a polymerizable double bond contained in the composition for antireflection layer is not particularly specified, but the composition preferably contains a polyfunctional monomer having three or more polymerizable double bonds. The polyfunctional monomer having three or more polymerizable double bonds can function as a curing agent. When the fluorine-containing copolymer having a polymerizable unsaturated group and the polyfunctional monomer having three or more polymerizable double bonds are used in combination, the scratch resistance or the scratch resistance after chemical treatment can be enhanced.

The polyfunctional monomer having three or more polymerizable double bonds may or may not contain fluorine.

The non-fluorine-containing polyfunctional monomer for use in the present invention is described. The monomer includes compounds having a polymerizable double bond, such as (meth)acryloyl group, vinyl group, styryl group and allyl group, and among these, a (meth)acryloyl group is preferred. In particular, the following compounds each containing three or more (meth)acryloyl groups within one molecule may be preferably used.

Specific examples of the compound having a polymerizable double bond include (meth)acrylic acid diesters of alkylene glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy (meth)acrylates, urethane (meth)acrylates and polyester (meth)acrylates.

Above all, esters of polyhydric alcohol and (meth)acrylic acid are preferred. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and caprolactone-modified tris(acryloxyethyl)isocyanurate.

As the (meth)acryloyl group-containing polyfunctional acrylate-based compounds, a commercially available compound may also be used, and examples thereof include KAYARAD DPHA and KAYARAD PET-30 produced by Nippon Kayaku Co., Ltd.

The non-fluorine-containing polyfunctional monomer is described in paragraphs [0114] to [0122] of JP-A-2009-98658, and, the same applies to the present invention.

### (g) Inorganic Fine Particle

In the present invention, from the standpoint of reducing the refractive index and improving the scratch resistance, an inorganic fine particle is used in the low refractive index layer. The inorganic fine particle is not particularly limited as long as it has an average particle size of 5 to 120 nm, but in view of reduction in the refractive index, an inorganic low refractive index particle is preferred.

In order to reduce the refractive index, a fine particle having a porous or hollow structure is preferably used. In particular, a silica fine particle having a hollow structure is preferred. The void percentage of such a particle is preferably from 10 to 80%, more preferably from 20 to 60%, and most preferably from 30 to 60%. When the void percentage of the hollow fine particle is in the range above, this is preferred from the standpoint of reducing the refractive index and maintaining the durability of the particle.

In the case where the porous or hollow particle is silica, the refractive index of the fine particle is preferably from 1.10 to 1.40, more preferably from 1.15 to 1.35, and most preferably from 1.15 to 1.30. The refractive index as used herein indicates the refractive index of the particle as a whole and does not indicate the refractive index of only silica outer shell forming the silica particle.

Two or more kinds of hollow silica particles differing in the average particle size may also be used in combination. The average particle diameter of the hollow silica can be determined from an electron micrograph.

In the present invention, the specific surface area of the hollow silica is preferably from 20 to 300 m²/g, more preferably from 30 to 120 m²/g, and most preferably from 40 to 90 m²/g. The surface area can be determined by a BET method using nitrogen.

In the present invention, a void-free silica particle may be used in combination with the hollow silica. The particle size of the void-free silica is preferably from 30 to 150 nm, more preferably from 35 to 100 nm, and most preferably from 40 to 80 nm.

### [Preparation Method of Hollow Fine Particle]

A preferable production method of the hollow fine particle is described below. A first step is formation of a core particle which can be removed by an after-treatment, a second step is formation of a shell layer, a third step is dissolution of the core particle, and if desired, a fourth step is formation of an additional shell phase. Specifically, the hollow particle can be produced, for example, in accordance with the production method of a hollow silica fine particle described in JP-A-2001-233611.

### (Coated Particle)

By increasing the shell thickness, the adsorption site on the particle surface and in turn, the amount of adsorbed water can be decreased and this is preferred. Furthermore, when the shell is formed of an electrically conductive component, electrical conductivity can also be advantageously imparted. In particular, a combination of a silica-based porous or hollow particle used as the core particle and ZnO₂, Y₂O₃, Sb₂O₅, ATO, ITO or SnO₂ used as the shell is preferred. The coated particle is described in paragraphs [0033] to [0040] of JP-A-2008-242314, and these can be suitably used also in the present invention.

### [Method for Surface Treatment of Inorganic Fine Particle]

Furthermore, in the present invention, the inorganic fine particle can be used after surface-treating it with a silane coupling agent or the like by a conventional method.

Particularly, in order to improve the dispersibility in the binder for low refractive index layer formation, the surface of the inorganic fine particle is preferably treated with a hydrolysate of an organosilane compound and/or a partial condensate thereof, and it is more preferred to use either one or both of an acid catalyst and a metal chelate compound in the treatment.

The method for treating the surface of the inorganic fine particle is described in paragraphs [0046] to [0076] of JP-A-2008-242314, and the organosilane compounds, siloxane compounds, solvents for surface treatment, catalysts for surface treatment, metal chelate compounds and the like described in this document can be suitably used also in the present invention.

### (h) Photopolymerization Initiator

The composition for low refractive index layer in the present invention preferably contains a photopolymerization initiator. Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins. The photopolymerization initiator is described also in paragraphs [0141] to [0159] of JP-A-2008-134585, and these can be suitably used similarly in the present invention.

Various examples are also described in Saishin UV Koka Gijutsu (Latest UV Curing Technologies), Technical Information Institute Co., Ltd., page 159 (1991), and Kiyomi Kato, Shigaisen Koka System (Ultraviolet Curing System), Sogo Gijutsu Center, pp. 65-148 (1989), and these are useful in the present invention.

Preferred examples of the commercially available photoradical polymerization initiator of photo-cleavage type include “Irgacure 651”, “Irgacure 184”, “Irgacure 819”, “Irgacure 907”, “Irgacure 1870” (a 7/3 mixed initiator of CGI-403/Irg 184), “Irgacure 500”, “Irgacure 369”, “Irgacure 1173”, “Irgacure 2959”, “Irgacure 4265”, “Irgacure 4263”, “Irgacure 127” and “OXE01”, produced by Ciba Specialty Chemicals Corp.; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC” and “KAYACURE MCA”, produced by Nippon Kayaku Co., Ltd.; “Esacure (KIP100F, KB1, EB3, BP, X33, KT046, KT37, KIP150, TZT)”, produced by Sartomer Company, Inc.; and a combination thereof.

The photopolymerization initiator is preferably used in an amount of 0.1 to 15 parts by mass, more preferably from 1 to 10 parts by mass, per 100 parts by mass of the organic component having an unsaturated double bond.

In addition to the photopolymerization initiator, a photosensitizer may be used. Specific examples of the photosensitizer include n-butylamine, triethylamine, tri-n-butylphosphine, Michler's ketone and thioxanthone. Furthermore, one or more auxiliary agents such as azide compound, thiourea compound and mercapto compound may be used in combination.

Examples of the commercially available photosensitizer include “KAYACURE (DMBI, EPA)” produced by Nippon Kayaku Co., Ltd.

### [Polarizing Plate Protective Film]

In the case of using the optical film as a surface protective film of a polarizing film (polarizing plate protective film), the adhesion to the polarizing film mainly composed of a polyvinyl alcohol can be improved by performing a so-called saponification treatment of hydrophilizing the surface of the transparent support opposite the side having the thin film layer, that is, the surface on the side laminated with the polarizing film.

It is also preferred that out of two protective films of a polarizer, the film other than the optical film is an optically compensatory film having an optically compensatory layer containing an optically anisotropic layer. The optically compensatory film (retardation film) can improve the viewing angle characteristics on a liquid crystal display screen.

A known optically compensatory film may be used but from the standpoint of enlarging the viewing angle, the optically compensatory film described in JPA-2001-100042 is preferred.

The saponification treatment is described below. The saponification treatment is a treatment of dipping the optical film in a heated aqueous alkali solution for a fixed time and after water washing, subjecting the film to acid washing for neutralization. The treatment conditions are not limited as long as the transparent support surface on the side laminated with the polarizing film is hydrophilized, and the concentration of processing agent, the temperature of processing solution, and the processing time are appropriately determined, but due to the need to ensure the productivity, the treatment conditions are usually determined to finish the treatment in 3 minutes. As general conditions, the alkali concentration is from 3 to 25 mass %, the treatment temperature is from 30 to 70° C., and the treatment time is from 15 seconds to 5 minutes. The alkali species used for the alkali treatment is suitably sodium hydroxide or potassium hydroxide, the acid used for acid washing is suitably a sulfuric acid, and water used for water washing is suitably ion-exchanged water or pure water.

The antistatic layer of the optical film of the present invention can keep its good antistatic performance even when exposed to an aqueous alkali solution by such a saponification treatment.

In the case of using the optical film as a surface protective film of a polarizing film (polarizing plate protective film), the cellulose acylate film is preferably a cellulose triacetate film.

### [Polarizing Plate]

The polarizing plate of the present invention is described below.

The polarizing plate of the present invention is a polarizing plate having a polarizing film and two protective films for protecting both surfaces of the polarizing film, wherein at least one of the protective films is the optical film or antireflection film of the present invention.

The polarizing film includes an iodine-based polarizing film, a dye-based polarizing film using a dichroic dye, and a polyene-based polarizing film. The iodine-based polarizing film and the dye-based polarizing film can be generally produced using a polyvinyl alcohol-based film.

A configuration where the cellulose acylate film of the optical film adheres to a polarizing film, if desired, through an adhesive layer or the like composed of a polyvinyl alcohol and a protective film is also provided on another side of the polarizing film. On the surface of the another protective film opposite the polarizing film, an adhesive layer may be provided.

By using the optical film of the present invention as a polarizing plate protective film, a polarizing plate excellent in the physical strength, antistatic property and durability can be fabricated.

The polarizing plate of the present invention may also have an optically compensating function. In this case, it is preferred that the optical film is used for the formation of only one surface protective film on either front side or back side out of two surface protective films and the surface protective film on the other side of the polarizing plate opposite the side having the optical film is an optically compensatory film.

By producing a polarizing plate where the optical film of the present invention is used for one polarizing plate protective film and an optically compensatory film having optical anisotropy is used for another polarizing film protective film, the bright-room contrast and up/down right/left viewing angle of a liquid crystal display device can be more improved.

### [Image Display Device]

The image display device of the present invention has the optical film, antireflection film or polarizing plate of the present invention on the outermost surface of the display.

The optical film, antireflection film and polarizing plate of the present invention can be suitably used for an image display device such as liquid crystal display device (LCD), plasma display panel (PDP), electroluminescence display device (ELD) and cathode ray tube display device (CRT).

In particular, the optical film, antireflection film and polarizing plate can be advantageously used in an image display device such as liquid crystal display device and is more preferably used for the outermost surface layer on the backlight side of the liquid crystal cell in a transmissive or transflective liquid crystal display device.

In general, a liquid crystal display device has a liquid crystal cell and two polarizing plates disposed on both sides thereof, and the liquid crystal cell carries a liquid crystal between two electrode substrates. Furthermore, in some cases, one optically anisotropic layer is disposed between the liquid crystal cell and one polarizing plate, or two optically anisotropic layers are provided, that is, one is provided between the liquid crystal cell and one polarizing plate and another is provided between the crystal cell and another polarizing plate.

The liquid crystal cell is preferably of TN mode, VA mode, OCB mode, IPS mode or ECB mode.

### Examples

The present invention is described in greater detail below by referring to Examples, but the present invention should not be construed as being limited thereto. Unless otherwise indicated, the “parts” and “%” are on a mass basis.

### [Production of Antireflection Film]

As described below, a coating solution for each layer formation was prepared, and respective layers were formed to produce Antireflection Film Samples 1 to 27.

### (Preparation of Hardcoat Layer Coating Solution)

### (Synthesis of Fluoroaliphatic Group-Containing Polymer P-77)

Fluoroaliphatic Group-Containing Polymer (P-77) illustrated above was synthesized as follows.

In a reaction vessel equipped with a stirrer and a reflux condenser, 31.98 parts by mass of 1H,1H,7H-dodecafluoroheptyl acrylate, 7.95 parts by mass of BLEMMER AP-400 (produced by NOF Corp.), 1.1 parts by mass of dimethyl 2,2′-azobisisobutyrate and 30 parts by mass of 2-butanone were added and heated at 78° C. for 6 hours in a nitrogen atmosphere, thereby completing the reaction. The mass average molecular weight was 34,000.

Fluoroaliphatic Group-Containing Polymers (P-74), (P-75), (P-191), (P-194), (P-62) and (P-62) illustrated above were synthesized in a similar manner by changing the mass average molecular weight to 1,500, 3,100, 5,500 and 83,000, respectively. Incidentally, the molecular weight was adjusted by controlling the reaction time and the temperature.

### (Preparation of Hardcoat Layer Coating Solution A-1)

The following composition was charged into a mixing tank and stirred to obtain Hardcoat Layer Coating Solution A-1.

300 Parts by mass of ethyl acetate was added with 700 parts by mass of methyl isobutyl ketone, 970 parts by mass of a mixture of pentaerythritol triacrylate and pentaerythritol tetraacrylate (PET30, produced by Nippon Kayaku Co., Ltd.), 30 parts by mass of a photopolymerization initiator (Irgacure 184, produced by Ciba Specialty Chemicals) and 0.5 parts by mass of Fluoroaliphatic Group-Containing Polymer P-75 (molecular weight: 9,000), and these were stirred. The mixture was filtered through a polypropylene-made filter having a pore size of 0.4 μm to prepare Hardcoat Layer Coating Solution A-1.

Hardcoat Layer Coating Solutions A-2 to A-26 having a solid content concentration of 50 mass % were prepared by a similar method to that for the preparation of Hardcoat Layer Coating Solution A-1 by mixing respective components as shown in Table 1 below and dissolving the mixture in the solvent to give the ratio shown in Table 1.

TABLE 1
Composition for Hardcoat Layer

| | | | | Leveling agent | | | | | | | |
|---|---|---|---|---|---|---|---|---|---|---|---|
| | PET 30 | Irg. 184 | MIBK-ST | | Mass Average | Fluorine | | Solvent 1 | | Solvent 2 | |
| Name of Composition | Content | Content | Content | Kind | Molecular Weight | Content | Content | Kind | Content | Kind | Content |
| Hardcoat Layer | 96.95% | 3% | 0% | P-75 | 9000 | 0.53% | 0.05% | ethyl acetate | 30% | MIBK | 70% |
| Coating Solution A-1 | | | | | | | | | | | |
| Hardcoat Layer | 96.95% | 3% | 0% | P-75 | 9000 | 0.53% | 0.05% | dimethyl carbonate | 30% | MIBK | 70% |
| Coating Solution A-2 | | | | | | | | | | | |
| Hardcoat Layer | 96.95% | 3% | 0% | P-75 | 9000 | 0.53% | 0.05% | diethyl carbonate | 30% | MIBK | 70% |
| Coating Solution A-3 | | | | | | | | | | | |
| Hardcoat Layer | 96.95% | 3% | 0% | P-75 | 9000 | 0.53% | 0.05% | ethanol | 30% | MIBK | 70% |
| Coating Solution A-4 | | | | | | | | | | | |
| Hardcoat Layer | 96.95% | 3% | 0% | P-75 | 9000 | 0.53% | 0.05% | MEK/PGME | 30% | MIBK | 70% |
| Coating Solution A-5 | | | | | | | | | | | |
| Hardcoat Layer | 96.95% | 3% | 0% | P-75 | 9000 | 0.53% | 0.05% | MEK | 30% | MIBK | 70% |
| Coating Solution A-6 | | | | | | | | | | | |
| Hardcoat Layer | 96.95% | 3% | 0% | P-75 | 9000 | 0.53% | 0.05% | toluene | 30% | MIBK | 70% |
| Coating Solution A-7 | | | | | | | | | | | |
| Hardcoat Layer | 96.95% | 3% | 0% | P-75 | 9000 | 0.53% | 0.05% | MIBK | 30% | MIBK | 70% |
| Coating Solution A-8 | | | | | | | | | | | |
| Hardcoat Layer | 96.90% | 3% | 0% | P-75 | 9000 | 0.53% | 0.1% | ethyl acetate | 30% | MIBK | 70% |
| Coating Solution A-9 | | | | | | | | | | | |
| Hardcoat Layer | 96.90% | 3% | 0% | P-75 | 9000 | 0.53% | 0.1% | dimethyl carbonate | 30% | MIBK | 70% |
| Coating Solution A-10 | | | | | | | | | | | |
| Hardcoat Layer | 96.90% | 3% | 0% | P-75 | 9000 | 0.53% | 0.1% | dimethyl carbonate | 30% | MIBK | 70% |
| Coating Solution A-11 | | | | | | | | | | | |
| Hardcoat Layer | 96.90% | 3% | 0% | P-75 | 9000 | 0.53% | 0.1% | MIBK | 30% | MIBK | 70% |
| Coating Solution A-12 | | | | | | | | | | | |
| Hardcoat Layer | 97.00% | 3% | 0% | | | | 0.00% | dimethyl carbonate | 30% | MIBK | 70% |
| Coating Solution A-13 | | | | | | | | | | | |
| Hardcoat Layer | 97.00% | 3% | 0% | | | | 0.00% | dimethyl carbonate | 60% | MIBK | 40% |
| Coating Solution A-14 | | | | | | | | | | | |
| Hardcoat Layer | 97.00% | 3% | 0% | | | | 0.00% | dimethyl carbonate | 15% | MIBK | 85% |
| Coating Solution A-15 | | | | | | | | | | | |
| Hardcoat Layer | 97.00% | 3% | 0% | | | | 0.00% | dimethyl carbonate | 5% | MIBK | 95% |
| Coating Solution A-16 | | | | | | | | | | | |
| Hardcoat Layer | 96.95% | 3% | 0% | P-62 | 1500 | 0.71% | 0.05% | dimethyl carbonate | 30% | MIBK | 70% |
| Coating Solution A-17 | | | | | | | | | | | |
| Hardcoat Layer | 96.95% | 3% | 0% | P-62 | 3100 | 0.71% | 0.05% | dimethyl carbonate | 30% | MIBK | 70% |
| Coating Solution A-18 | | | | | | | | | | | |
| Hardcoat Layer | 96.95% | 3% | 0% | P-62 | 5500 | 0.71% | 0.05% | dimethyl carbonate | 30% | MIBK | 70% |
| Coating Solution A-19 | | | | | | | | | | | |
| Hardcoat Layer | 96.95% | 3% | 0% | P-62 | 9000 | 0.71% | 0.05% | dimethyl carbonate | 30% | MIBK | 70% |
| Coating Solution A-20 | | | | | | | | | | | |
| Hardcoat Layer | 96.95% | 3% | 0% | P-194 | 15000 | 0.38% | 0.05% | dimethyl carbonate | 30% | MIBK | 70% |
| Coating Solution A-21 | | | | | | | | | | | |
| Hardcoat Layer | 96.95% | 3% | 0% | P-74 | 21000 | 0.62% | 0.05% | dimethyl carbonate | 30% | MIBK | 70% |
| Coating Solution A-22 | | | | | | | | | | | |
| Hardcoat Layer | 96.95% | 3% | 0% | P-77 | 34000 | 0.56% | 0.05% | dimethyl carbonate | 30% | MIBK | 70% |
| Coating Solution A-23 | | | | | | | | | | | |
| Hardcoat Layer | 96.95% | 3% | 0% | P-191 | 45000 | 0.41% | 0.05% | dimethyl carbonate | 30% | MIBK | 70% |
| Coating Solution A-24 | | | | | | | | | | | |
| Hardcoat Layer | 96.95% | 3% | 0% | P-62 | 83000 | 0.53% | 0.05% | dimethyl carbonate | 30% | MIBK | 70% |
| Coating Solution A-25 | | | | | | | | | | | |
| Hardcoat Layer | 81.95% | 3% | 15% | P-75 | 9000 | 0.53% | 0.05% | dimethyl carbonate | 30% | MIBK | 70% |
| Coating Solution A-26 | | | | | | | | | | | |

*1: The numerical value for the content of each component except for the solvent is expressed by the ratio (mass %) of the solid content of each component based on the solid content of all components in the coating solution.
*2: The numerical value for the content of each solvent is expressed by the ratio (mass %) of each solvent based on the mass of all solvents.

The compounds used are as follows.

Silica sol (MIBK-ST, solid content: 30 mass %, produced by Nissan Chemical Industries, Ltd.)

Photopolymerization initiator Irgacure 184 (Irg.184, produced by Ciba Specialty Chemicals)

Reactive silicone (X22-164C, produced by Shin-Etsu Chemical Co., Ltd.)

### (Preparation of Hardcoat Layer Coating Solution B-1)

325.7 Parts by mass of Solvent Dispersion A of electrically conductive compound and 869.5 parts by mass of DPHA (KAYARAD DPHA (a mixture of dipentaerythritol pentaacrylate and dipentaerythritol hexaacrylate) were mixed with 300 parts by mass of dimethyl carbonate (produced by Tokyo Chemical Industry Co., Ltd.), 474.3 parts by mass of methyl isobutyl ketone and 30 parts by mass of a photopolymerization initiator (Irgacure 184, produced by Ciba Japan K.K.), and the mixture was stirred and then filtered through a polypropylene-made filter having a pore size of 1.0 μm to prepare Hardcoat Layer Coating Solution B-1.

Dispersion A: A liquid dispersion of IP-9 illustrated above (solid content: 30.7 mass %, solvent: propylene glycol monomethyl ether and isopropyl alcohol in a mass ratio of 30:70)

### (Preparation of Low Refractive Index Layer Coating Solution)

### (Synthesis of Perfluoroolefin Copolymer (1))

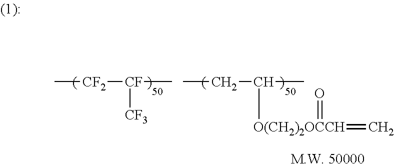

In the structural formula above, 50:50 indicates the molar ratio.

Into a stainless steel-made autoclave with a stirrer having an inner volume of 100 ml, 40 ml of ethyl acetate, 14.7 g of hydroxyethyl vinyl ether and 0.55 g of dilauroyl peroxide were charged, and the inside of the system was degassed and displaced with nitrogen gas. Furthermore, 25 g of hexafluoropropylene (HFP) was introduced into the autoclave, and the temperature was raised to 65° C. The pressure when the temperature in the autoclave reached 65° C. was 0.53 MPa (5.4 kg/cm²). The reaction was continued for 8 hours while keeping this temperature and when the pressure reached 0.31 MPa (3.2 kg/cm²), the heating was stopped and the system was allowed to cool. At the time when the inner temperature dropped to room temperature, the unreacted monomer was expelled, and the autoclave was opened to take out the reaction solution. The obtained reaction solution was poured in a large excess of hexane and after removing the solvent by decantation, the precipitated polymer was collected. This polymer was dissolved in a small amount of ethyl acetate, and the residual monomer was completely removed by performing reprecipitation twice from hexane. After drying, 28 g of a polymer was obtained. Subsequently, 20 g of this polymer was dissolved in 100 ml of N,N-dimethylacetamide, and 11.4 g of acrylic acid chloride was added dropwise thereto under ice cooling, followed by stirring at room temperature for 10 hours. Thereafter, ethyl acetate was added to the reaction solution, and the resulting solution was washed with water. The organic layer was extracted and then concentrated, and the obtained polymer was reprecipitated from hexane to obtain 19 g of Perfluoroolefin Copolymer (1). The refractive index and mass average molecular weight of the obtained polymer were 1,422 and 50,000, respectively.

### (Preparation of Hollow Silica Particle Liquid Dispersion A)

500 Parts by mass of a fine particle sol of hollow silica particle (isopropyl alcohol silica sol, CS60-IPA, produced by Catalysts & Chemicals Ind. Co., Ltd., average particle diameter: 60 nm, thickness of shell: 10 nm, silica concentration: 20 mass %, refractive index of silica particle: 1.31) was added and mixed with 30 parts by mass of acryloyloxypropyltrimethoxysilane and 1.51 parts by mass of diisopropoxyaluminum ethyl acetate, and 9 parts by mass of ion-exchanged water was added thereto. After allowing the reaction to proceed at 60° C. for 8 hours, the reaction solution was cooled to room temperature, and 1.8 parts by mass of acetylacetone was added to obtain a liquid dispersion. Thereafter, solvent replacement by reduced-pressure distillation was performed under a pressure of 30 Torr while adding cyclohexanone to keep the silica content almost constant, and finally the concentration was adjusted to obtain Liquid Dispersion A having a solid content concentration of 18.2 mass %. The amount of IPA remaining in the obtained Liquid Dispersion A was analyzed by gas chromatography and found to be 0.5 mass % or less.

### (Preparation of Coating Solution A for Low Refractive Index Layer)

21.0 Parts by mass of Perfluoroolefin Copolymer (I), 2.5 parts by mass of reactive silicone (X22-164C, produced by Shin-Etsu Chemical Co., Ltd.), 1.5 parts by mass of Irgacure 127 (produced by Ciba Specialty Chemicals) and 137.4 parts by mass of Hollow Silica Particle Liquid Dispersion A were added to methyl ethyl ketone to made 1,000 parts by mass and after stirring, the mixture was filtered through a polypropylene-made filter having a pore size of 5 μm to prepare Low Refractive Index Layer Coating Solution A.

### (Production of Hardcoat Layer A-1)

Hardcoat Layer Coating Solution A-1 was coated on a 80 μm-thick triacetyl cellulose film (TD80UF, produced by Fujifilm Corp., refractive index: 1.48) as a transparent support by using a gravure coater and dried at 100° C. Thereafter, the coated layer was cured by irradiating an ultraviolet ray at an illuminance of 400 mW/cm² and an irradiation dose of 150 mJ/cm² with use of an air-cooled metal halide lamp (manufactured by Eye Graphics Co., Ltd.) of 160 W/cm while purging the system with nitrogen to give an atmosphere having an oxygen concentration of 1.0 vol % or less, whereby Hardcoat Layer A-1 having a thickness of 12 μm was formed.

### (Production of Low Refractive Index Layer)

Low Refractive Index Layer Coating Solution A was coated on Hardcoat Layer A-1 by using a gravure coater to form a low refractive index layer having a thickness of 94 nm. This is designated as Antireflection Film Sample No. 1. The drying conditions of the low refractive index layer were 90° C. and 30 seconds, and the ultraviolet curing conditions were such that an air-cooled metal halide lamp (manufactured by Eye Graphics Co., Ltd.) of 240 W/cm was used at an illuminance of 600 mW/cm² and an irradiation dose of 600 mJ/cm² while purging the system with nitrogen to give an atmosphere having an oxygen concentration of 0.1 vol % or less.

In the same manner, Hardcoat Layers A-2 to A-26 were produced using Hardcoat Layer Coating Solutions A-2 to A-26, respectively, and Hardcoat Layer B-1 was produced using Hardcoat Layer Coating Solution B-1. Low Refractive Index Layer A was formed thereto to a thickness of 94 nm, whereby Antireflection Film Sample Nos. 2 to 27 were produced. Incidentally, the refractive index of the hardcoat layer and low refractive index layer was measured by Multi-Wavelength Abbe Refractometer DR-M2 (manufactured by ATAGO K.K.) after applying the coating solution for each layer on a glass plate to a thickness of about 4 μm. The refractive index measured using a filter, “Interference Filter 546(e) nm for DR-M2, M4, Parts No. RE-3523”, was employed as the refractive index at a wavelength of 550 nm. The Refractive indices of the hardcoat layers A-1 to A-27 were 1.52. The Refractive indices of the low reflective index layer is 1.35.

The thickness of the low refractive index layer was calculated using a reflection spectral film thickness meter “FE-3000” (manufactured by Otsuka Denshi Co., Ltd.). At the calculation, the refractive index of each layer was adjusted using the value derived by the Abbe Refractometer above.

### (Calculation of Surface Free Energy of Hardcoat Layer)

The surface free energy on the hardcoat layer surface in the stage before stacking the low refractive index layer of each sample was calculated according to the Owens equation described above by measuring the contact angles of water and methylene chloride.

### (Amount of Leveling Agent Remaining in Hardcoat Layer-Low Refractive Index Layer Interface)

An optical film in the stage before stacking the low refractive index layer of each sample, in which only the hardcoat layer was formed, was dipped in methyl ethyl ketone for 5 minutes and after removing the eluted material, the surface was analyzed by an X-ray photoelectric analyzer (ESCA) to measure the value of F/C which is a ratio of the amount of fluorine atom to the amount of carbon atom. This value is defined as the amount of the leveling agent remaining in the hardcoat layer-low refractive index layer interface.

TABLE 2

| Hardcoat Layer | Surface Free Energy | |
|---|---|---|
| Sample No. | mN/m | F/C |
| 2 | 30 | 0.2 |
| 3 | 30 | 0.2 |
| 8 | 38 | 2.2 |
| 10 | 30 | 0.3 |
| 11 | 30 | 0.4 |
| 12 | 30 | 2.8 |
| 13 | 40 | 0.0 |

As seen from Table 2, in the case of using a carbonic acid ester solvent, the surface free energy was the same between when the amount added of the fluorine-containing leveling agent (A) was 0.05% and when 0.1%, and this reveals that the surface energy was saturated by the addition in an amount of 0.05% (Sample Nos. 2 and 3). On the other hand, in the case of not using a carbonic acid ester solvent, the surface free energy was apparently not saturated by the addition in an amount of 0.05%. From these results, it is presumed that thanks to use of a carbonic acid ester solvent, the amount added necessary for the surface free energy to reach the saturated value is decreased and the superficial distribution of the fluorine-containing leveling agent is enhanced. Also, in the case of using a carbonic acid ester solvent, the F/C value was small compared with the case of not using the solvent and the leveling agent did not remain in the hardcoat layer-low refractive index layer interface, which reveals that the leveling agent was swiftly extracted by the solvent of the coating solution for low refractive index layer formation.

### (Evaluation of Antireflective Film)

Various characteristics of the antireflective film were evaluated by the following methods. The results are shown in Table 3.

### (1) Specular Reflectance

The antireflection property was evaluated by mounting an adapter ARV-474 on a spectrophotometer V-550 (manufactured by JASCO Corp.), measuring the specular reflectance for the outgoing angle of 5° at an incident angle of 5° in the wavelength region of 380 to 780 nm, and calculating the average reflectance at 450 to 650 nm.

### (2) Observation of Interface Between Substrate and Hardcoat Layer

The film was sliced with a microtome, and the cross-section was analyzed by time-of-flight secondary ion mass spectrometry (TOF-SIMS), whereby the interface state was observed. A portion where both the substrate component and the hardcoat layer component were designated as a region allowing for mixing of substrate and hardcoat layer components. The film thickness of this region was also measured using the cross-sectional information of TOF-SIMS, and the ratio of the thickness of the region allowing for mixing of substrate component and hardcoat layer component to the thickness of the entire hardcoat layer was calculated.

### (3) Coated Surface Unevenness

Light was passed through the film with the coated surface side up by irradiating a fluorescent lamp from the back surface side, and the occurrence frequency of point defect such as eye hole and particle and surface unevenness such as coating unevenness and drying unevenness was examined exclusively in 10 m² by surface inspection with an eye. The value obtained was divided by 10 and the number of surface unevennesses per 1 m² was calculated and judged according to the following criteria.

AA: The number of surface unevennesses was 0.

A: The number of surface unevennesses was from 1 to less than 3, and the surface was slightly uneven but this was not perceived.

AB: The number of surface unevennesses was from 3 to less than 5, and the surface was slightly uneven but this was substantially not perceived.

B: The number of surface unevennesses was from 5 to less than 10, and the surface unevenness was conspicuous.

C: The number of surface unevennesses was 10 or more, and the surface unevenness was seriously conspicuous.

### (4) Adherence Evaluation

The evaluation was performed by a cross-cut peeling test described in JIS-K-5400. That is, 100 squares in a grid were formed at intervals of 1 mm on the sample surface, and an adherence test with a cellophane tape (produced by Nichiban Co., Ltd.) was performed. A new cellophane tape was adhered and then peeled off, and the adherence was rated according to the following criteria.

AA: Peeling of squares in the grid did not occur.

A: The ratio of unpeeled squares in the grid was 90% or more, and there was no problem though the tape was slightly peeled.

AB: The ratio of unpeeled squares in the grid was from 70% to less than 90%, and there was almost no problem though the tape was slightly peeled.

B: The ratio of unpeeled squares in the grid was from 50% to less than 70%, and the tape was somewhat peeled to cause a problem.

C: The ratio of unpeeled squares in the grid was less than 50%, and there was a serious problem.

### (5) Evaluation of Steel Wool Scratch Resistance

A rubbing test of the low refractive index layer surface of the antireflection film was performed using a rubbing tester under the following conditions, and the result was used as an index of scratch resistance.

Environmental conditions of evaluation: 25° C., 60% RH

Rubbing material: A steel wool (Grade No. 0000, manufactured by Nippon Steel Wool Co., Ltd.) was wound around a rubbing tip (1 cm×1 cm) of a tester coming into contact with the sample and fixed by a band to resist movement.

Moving distance (one way): 13 cm

Rubbing speed: 13 cm/sec

Load: 500 g/cm² or 1 kg/cm².

Contact area of tip: 1 cm×1 cm

Number of rubbings: 10 reciprocations

An oily black ink was painted on the back side of the rubbed sample, and the abrasion in the rubbed portion was observed with an eye by the reflected light and evaluated.

A: Scratches were not observed at all despite very careful inspection.

B: Weak scratches were observed upon very careful inspection but caused no problem.

C: Weak scratches were observed upon careful inspection but caused no problem.

D: Scratches of medium degree were observed, and these scratches were conspicuous.

E: Scratches were observed at a glance and very conspicuous.

### (6) Evaluation of Dust Attachment

The transparent support side of the antireflective film was laminated on the CRT surface, and the device was used for 24 hours in a room having from 100 to 2,000,000 dusts and tissue paper scraps of 0.5 μm or more per 1 ft³ (cubic feet). The number of dusts and tissue paper scrapes attached per 100 cm² of the antireflective film was measured, and the sample was rated A when the average value of the results was less than 20, and rated B when 20 or more.

### (7) Measurement of Surface Resistance Value

With respect to Sample Nos. 2 and 27, the sample was allowed to stand under the conditions of 25° C. and 60% RH for 2 hours and then, the surface resistance value (SR) was measured by a circular electrode method under the same conditions expected the in 100 volts for 2 hours. The surface resistance value is shown by its common logarithm (logSR).

TABLE 3

| | Performance | | | | | | | |
|---|---|---|---|---|---|---|---|---|
| Sample | Average | Ratio of | | Surface | Steel Wool(500 g) | Steel Wool(1000 g) | Dust | |
| No. | Reflectance | Mixed Region | Adherence | Unevenness | Resistance | Resistance | Attachment | Remarks |
| 1 | 1.10% | 20% | A | B | B | D | B | Comparative |
| | | | | | | | | Example |
| 2 | 1.10% | 50% | A | A | B | B | B | Invention |
| 3 | 1.10% | 8% | B | A | B | B | B | Invention |
| 4 | 1.10% | 0% | C | C | C | D | B | Comparative |
| | | | | | | | | Example |
| 5 | 1.10% | 20% | A | C | C | D | B | Comparative |
| | | | | | | | | Example |
| 6 | 1.10% | 20% | A | C | C | D | B | Comparative |
| | | | | | | | | Example |
| 7 | 1.10% | 0% | C | C | C | D | B | Comparative |
| | | | | | | | | Example |
| 8 | 1.10% | 0% | C | C | C | D | B | Comparative |
| | | | | | | | | Example |
| 9 | 1.10% | 20% | A | A | C | E | B | Comparative |
| | | | | | | | | Example |
| 10 | 1.10% | 50% | A | A | B | B | B | Invention |
| 11 | 1.10% | 8% | B | A | B | B | B | Invention |
| 12 | 1.10% | 0% | C | A | D | E | B | Comparative |
| | | | | | | | | Example |
| 13 | 1.10% | 50% | A | C | A | A | B | Comparative |
| | | | | | | | | Example |
| 14 | 1.10% | 70% | AA | C | B | B | B | Comparative |
| | | | | | | | | Example |
| 15 | 1.10% | 30% | AB | C | B | B | B | Comparative |
| | | | | | | | | Example |
| 16 | 1.10% | 10% | B | C | C | C | B | Comparative |
| | | | | | | | | Example |
| 17 | 1.10% | 50% | A | C | B | B | B | Invention |
| 18 | 1.10% | 50% | A | B | B | B | B | Invention |
| 19 | 1.10% | 50% | A | AB | B | B | B | Invention |
| 20 | 1.10% | 50% | A | A | B | B | B | Invention |
| 21 | 1.10% | 50% | A | B(eye hole- | C | C | B | Invention |
| | | | | like failire) | | | | |
| 22 | | 50% | A | A | A | A | B | Invention |
| 23 | 1.10% | 50% | A | A | C | C | B | Invention |
| 24 | 1.10% | 50% | A | B(eye hole- | C | C | B | Invention |
| | | | | like failire) | | | | |
| 25 | 1.10% | 50% | A | B(eye hole- | D | D | B | Invention |
| | | | | like failire) | | | | |
| 26 | 1.28% | 50% | A | A | A | A | B | Invention |
| 27 | 1.10% | 50% | A | A | A | A | A | Invention |

As seen in Table 3, when the hardcoat layer-forming composition of the present invention was used, an antireflection film improved in the surface unevenness and satisfying both adherence and steel wool scratch resistance could be obtained. Particularly, in Sample Nos. 2 and 3 using a carbonic acid ester solvent, the steel wool resistance under a load of 500 g was excellent compared with Sample Nos. 4 to 8 using a solvent other than the carbonic acid ester. Furthermore, in the test under a load of 1 kg, in Sample Nos. 4 to 8, scratching was significantly worsened as compared with under a load of 500 g, whereas in Sample Nos. 2 and 3, scratching was on the same level as under 500 g and not worsened, and this reveals that the good scratch resistance level could be maintained. In Sample Nos. 21 and 24, a slightly strong eye hole-like failure was observed, but the adherence and steel wool scratch resistance were excellent. In other samples, such an eye hole was not observed. Also, in Sample No. 2, logSR was 14.0, whereas in Sample No. 27, it was reduced to 9.4 and the rating of dust attachment was also rank A, revealing that good antidust property could be additionally imparted.

Coating Solutions for Hardcoat Layers A-27 to A-29 having a solid content concentration of 50 mass % were prepared in the same manner as in Solution for Hardcoat Layer A-1, except for using each of materials disclosed in following Table 4 in places of P-75 as leveling agent. Antireflection films A-28 to 30 were prepared in the same manner as in Antireflection film A-1 except for using each of Solutions for Hardcoat Layers

TABLE 4

| | Composition for Hardcoat Layer | | Performance | | | | |
|---|---|---|---|---|---|---|---|
| Sample | | Leveling Agent | | Surface | Steel Wool, | Steel Wool, | |
| No. | Composition Name | Kind | Adherence | Unevenness | 500 g | 1 kg | Remarks |
| 28 | Coating Solution A-27 for Hardcoat Layer | X22-164-C | A | A | E | E | Comparative Example |
| 29 | Coating Solution A-28 for Hardcoat Layer | F-555 | A | A | E | E | Comparative Example |
| 30 | Coating Solution A-29 for Hardcoat Layer | NS-1602 | A | A | E | E | Comparative Example |

MegafacF-555: 30% MiBK solution of nonionic fluorinated polymer (produced by DIC corp)
UnidyneNS-1602: 30% IPA solution of nonionic fluorinated polymer (produced by daikin corp)

As seen in Table 4, when a compound having a structure different from that of the present invention was used as the leveling agent, although the adherence and surface unevenness were good, the steel wool scratch resistance was very bad, and it is understood that the scratch resistance could not be improved. (Saponification Treatment of Optical Film)

Sample No. 2 was subjected to the following treatment. An aqu 1.5 mol/L sodium hydroxide solution was prepared and kept at 55° C. An aqueous 0.01 mol/L dilute sulfuric acid solution was prepared and kept at 35° C. The produced optical film was dipped in the aqueous sodium hydroxide solution above for 2 minutes and then dipped in water, thereby thoroughly washing away the aqueous sodium hydroxide solution. Subsequently, the sample was dipped in the aqueous dilute sulfuric acid solution above for one minute and then dipped in water, thereby thoroughly washing away the aqueous dilute sulfuric acid solution. Finally, the sample was thoroughly dried at 120° C.

In this way, a saponified optical film was produced.

### (Production of Polarizing Plate)

A 80 μm-thick triacetyl cellulose film (TAC-TD80U, produced by Fujifilm Corp.) which had been dipped in an aqueous 1.5 mol/L NaOH solution at 55° C. for 2 minutes, neutralized and then washed with water, and the optical film subjected to the saponification treatment were adhered to and thereby caused to protect both surfaces of a polarizer prepared by adsorbing iodine to polyvinyl alcohol and stretching it, whereby a polarizing plate (Sample No. 31) was produced.

### (Preparation of Circular Polarizing Plate)

A λ/4 plate was laminated to the surface of the polarizing plate sample on the side opposite the low refractive index layer by using a pressure-sensitive adhesive to produce a circular polarizing plate (Sample No. 32), and Sample No. 24 was laminated to the surface of an organic EL display with a pressure-sensitive adhesive by arranging the optical functional layer to face outward. A good display performance could be obtained without scratching or surface unevenness.

Sample No. 31 was used as a polarizing plate on the surface of each of a reflective liquid crystal display and a transflective liquid crystal display by arranging the low refractive index layer to face outward, as a result, a good display performance could be obtained without scratching or surface unevenness.

1. A composition for a hardcoat layer comprising the following (a), (b), (c) and (d):
(a) at least one leveling agent selected from a following fluorine-containing polymer represented by the following formula (1) and a fluorine-containing polymer represented by the following formula (2), wherein the fluorine-containing polymer represented by the following formula (1) contains a polymerization unit derived from fluoroaliphatic group-containing monomer represented by a following formula (1) in a ratio of more than 50 mass % based on all polymerization units of the polymer (1). 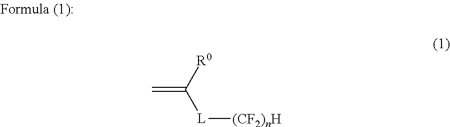
wherein R⁰ represents a hydrogen atom, a halogen atom or a methyl group, L represents a divalent linking group, and n represents an integer of 1 to 18, and the fluorine-containing polymer represented by the following formula (2) contains a polymerization unit derived from a fluoroaliphatic group-containing monomer represented by the following formula (2) and a polymerization unit derived from at least one selected from a poly(oxyalkylene) acrylate and a poly(oxyalkylene) methacrylate: 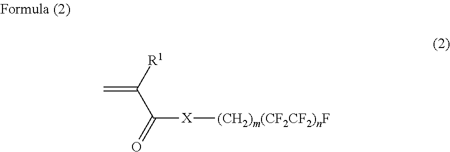
wherein R¹ represents a hydrogen atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4;
(b) a carbonic acid ester solvent;
(c) a compound having an unsaturated double bond; and
(d) a photopolymerization initiator.

2. The composition for a hardcoat layer as claimed in claim 1, wherein the (a) leveling agent is the fluorine-containing polymer represented by the following formula (1).

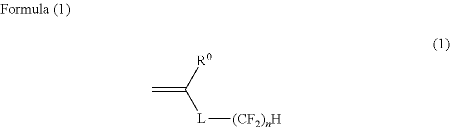

3. The composition for a hardcoat layer as claimed in claim 1, which contains the (b) in a content of 10 mass % or more based on the entire solvent.

4. The composition for a hardcoat layer as claimed in claim 1, which further comprises (e) a silica fine particle.

5. A hardcoat film comprising;
a transparent substrate;
hardcoat layer formed from the composition for a hardcoat layer, comprising the following (a), (b), (c) and (d):
(a) at least one leveling agent selected from a following fluorine-containing polymer represented by the following formula (1) and a fluorine-containing polymer represented by the following formula (2), wherein the fluorine-containing polymer represented by the following formula (1) contains a polymerization unit derived from fluoroaliphatic group-containing monomer represented by a following formula (1) in a ratio of more than 50 mass % based on all polymerization units of the polymer (1), 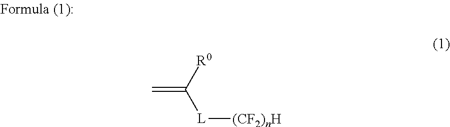
wherein R⁰ represents a hydrogen atom, a halogen atom or a methyl group, L represents a divalent linking group, and n represents an integer of 1 to 18, and the fluorine-containing polymer represented by the following formula (2) contains a polymerization unit derived from a fluoroaliphatic group-containing monomer represented by the following formula (2) and a polymerization unit derived from at least one selected from a poly(oxyalkylene) acrylate and a poly(oxyalkylene) methacrylate: 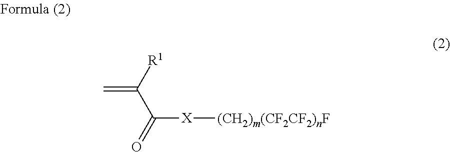
wherein R¹ represents a hydrogen atom or a methy group, X represents and oxygen atom, a sulfur atom or —N(R₂)—, m represents and integer of 1 to 6, n represents an integer of 1 to 3, and R₂ represents a hydrogen atom or an alkyl group having a carbon number of 1 to 4;
(b) a carbonic acid ester solvent;
(c) a compound having an unsaturated double bond; and
(d) a photopolymerization initiator.

6. An optical film comprising:
a transparent substrate;
a hardcoat layer formed of the composition for a hardcoat layer comprising a composition for a hardcoat layer comprising the following (a), (b), (c) and (d):
(a) at least one leveling agent selected from a following fluorine-containing polymer represented by the following formula (1) and fluorine-containing polymer represented by the following (2), wherein the fluorine-containing polymer represented by the following (1) contains a polymerization unit derived from fluoroaliphatic group-containing monomer represented b a following formula (1) in a ratio of more than 50 mass % based on all polymerization units of the polymer (1), 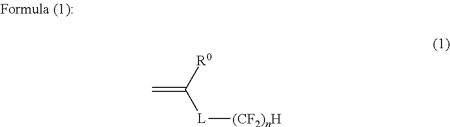
wherein R⁰ represents a hydrogen atom, a halogen atom or a methyl group, L represents a divalent linking group, and n represents an integer of 1 to 18, and the fluorine-containing polymer represented by the following formula (2) contains a polymerization unit derived from a fluoroaliphatic group-containing monomer represented by the following formula (2) and a polymerization unit derived from at least one selected from a poly(oxyalkylene) acrylate and a poly(oxyalkylene) methacrylate: 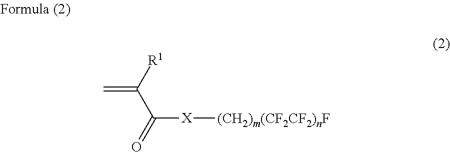
wherein R¹ represents a atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4;
(b) a carbonic acid ester solvent;
(c) a compound having an unsaturated double bond; and
(d) a photopolymerization initiator on the transparent substrate; and
an antireflection layer on the hardcoat layer.

7. The optical film as claimed in claim 6, wherein the transparent substrate is a cellulose acylate film.

8. An optical film comprising:
a cellulose acylate film substrate;
a hardcoat layer; and
an antireflection layer over the cellulose acylate film substrate;
a region allowing a substrate component and a hardcoat layer component to be mixed in a interface of the cellulose acylate film substrate with the hardcoat layer; and
an antireflection layer comprising a leveling agent that is the following fluorine-containing polymer represented by the following formula (1).

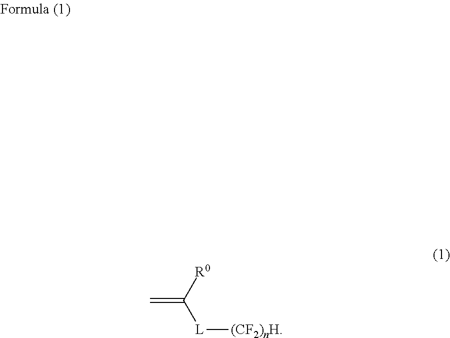

9. A polarizing plate comprising the optical film, the optical film comprising:
a transparent substrate;
a hardcoat layer formed of the composition for a hardcoat layer,
the composition for the hardcoat layer comprising the following (a), (b), (c) and (d);
(a) at least one leveling agent selected from a following fluorine-containing polymer represented by the following formula (1) and a fluorine-containing polymer represented by the following formula (2), wherein the fluorine-containing polymer represented by the following formula (1) contains a polymerization unit derived from fluoroaliphatic group-containing monomer represented by a following formula (1) in a ratio of more than 50 mass % based on all polymerization units of the polymer (1), 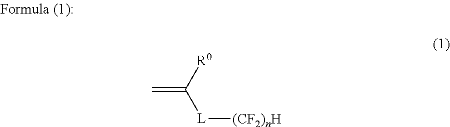
wherein R⁰ represents a hydrogen atom a halogen atom or a methyl group, L represents a divalent linking group, and n represents an integer of 1 to 18, and the fluorine-containing polymer represented by the following formula (2) contains a polymerization unit derived from a fluoroaliphatic group-containing monomer represented by the following formula (2) and a polymerization unit derived from at least one selected from a poly(oxyalkylene) acrylate and a poly(oxyalkylene) methacrylate: 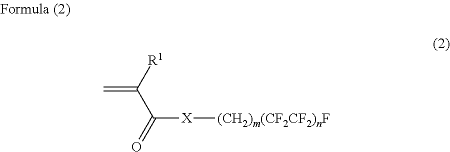
wherein R¹ represents a hydrogen atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4;
(b) a carbonic acid ester solvent;
(c) a compound having an unsaturated double bond; and
(d) a photopolymerization initiator.

10. An image display device comprising the optical film, the optical film comprising:
a transparent substrate;
a hardcoat layer formed of the composition for a hardcoat layer,
the composition for the hardcoat layer comprising the following (a), (b), (c) and (d):
(a) at least one leveling agent selected from a following fluorine-containing polymer represented by the following formula (1) and a fluorine-containing polymer represented by the following formula (2), wherein the fluorine-containing polymer represented by the following formula (1) contains a polymerization unit derived from fluoroaliphatic group-containing monomer represented by a following formula (1) in a ratio of more than 50 mass % based on all polymerization units of the polymer (1), 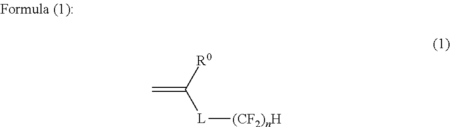
wherein R⁰ represents a hydrogen atom, a halogen atom or a methyl group, L represents a divalent linking group, and n represents an integer of 1 to 18, and the fluorine-containing polymer represented by the following formula (2) contains a polymerization unit derived from a fluoroaliphatic group-containing monomer represented by the following formula (2) and a polymerization unit derived from at least one selected from a poly(oxyalkylene) acrylate and a poly(oxyalkylene) methacrylate: 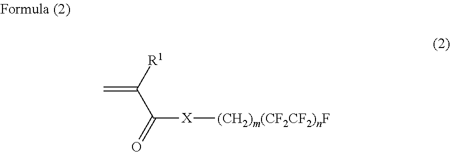
wherein R¹ represents a hydrogen atom or methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4:
(b) a carbonic acid ester solvent;
(c) a compound having an unsaturated double bond; and
(d) a photopolymerization initiator.

11. A method for producing an optical film including a cellulose acylate film substrate, a hardcoat layer on the cellulose acylate film substrate, and an antireflection layer on the cellulose acylate film substrate, the method comprising,
coating a composition and curing the composition for a hardcoat layer, comprising the following (a), (b), (c) and (d);
(a) at least one leveling agent selected from a following fluorine-containing polymer represented by the following formula (1) and a fluorine-containing polymer represented by the following formula (2), wherein the fluorine-containing polymer represented by the following formula (1) contains a polymerization unit derived from fluoroaliphatic group-containing monomer represented by a following formula (1) in a ratio of more than 50 mass % based on all polymerization units of the polymer (1), 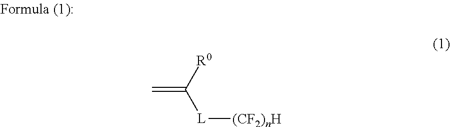
wherein R⁰ represents a hydrogen atom, a halogen atom or a methyl group, L represents a divalent linking group, and n represents an integer of 1 to 18 and the fluorine-containing polymer represented by the following formula (2) contains a polymerization unit derived from a fluoroaliphatic-containing monomer represented by the following formula (2) and a polymerization unit derived from at least on selected from a poly(oxyalkylene) acrylate and a poly(oxyalkylene) methacrylate: 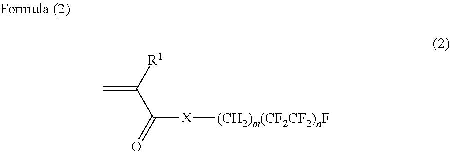
wherein R¹ represents a hydrogen atom or a methyl group, X represents an oxygen atom, a sulfur atom or —N(R₂)—, m represents an integer of 1 to 6, n represents an integer of 1 to 3, and R₂ represents a hydrogen atom or an alkyl group having a carbon number of 1 to 4;
(b) a carbonic acid ester solvent
(c) a compound having an unsaturated double bond; and
(d) a photopolymerization initiator;
on the cellulose acylate film substrate to form a hardcoat layer, and
coating and curing a curable composition comprising the following (f), (g) and (h) on the hardcoat layer to form an antireflection film:
(f) a compound having an unsaturated double bond,
(g) a hollow silica fine particle, and
(h) a photopolymerization initiator.
